(19) United States
(12) Patent Application Publication
(10) Pub. No.: US 2012/0124478 A1
(43) Pub. Date: May 17, 2012

(54) Metadata Browser

(75) Inventors: Tony Richard King, Cambridgeshire (GB); David Cole, Cambridgeshire (GB)

(73) Assignee: IPV LIMITED, Cambridgeshire (GB)

(21) Appl. No.: 13/264,502

(22) PCT Filed: Apr. 15, 2010
(86) PCT No.: PCT/GB10/50623

§ 371 Date: Feb. 1, 2012

(30) Foreign Application Priority Data
Apr. 15, 2009 (GB) 0906409.8

(51) Int. Cl. G06F 3/048

(52) U.S. Cl. 715/738

(57) ABSTRACT

A metadata browse system supports the capture of metadata from multiple sources and formats, its conversion to a standard format, the linking of concepts from disconnected namespaces, discovery of hidden information, and the display of this data.

### TECHNICAL FIELD

This invention relates to processing metadata and interacting with it in order to extract value. The interaction may be through human or machine agency, or a combination of the two, and occurs over a local or wide-area digital communications network.

### BACKGROUND ART

Metadata is information that describes an asset, which may itself be machine-readable data, or a physical entity. This asset can be the main resource of a business and its processing the primary business activity. In television production, for example, the main asset is the audio-visual material and the metadata would consist of name, format, timing, etc, information. In a health care situation, the main asset is the patient and the metadata would describe the patient's contact details, symptoms, diagnosis, medication, etc. In the financial world, the main asset is the clients' money and its disposition, and the metadata may consist of information about stocks and shares.

All the assets within a business typically will be interrelated; a television highlights program reuses parts of other television programs; different patients could show the same symptoms and may be related geographically; performance of two different financial sectors may be related to political events in one particular area. It can be the case that the metadata, and the metadata relationships, are a valuable asset in their own right. If the subject of a television program has gained significance since the program was made then it may become very important to be able to find that program quickly, and the most efficient way to do this is to search using metadata.

Conventionally such searches are carried out on media databases using query languages or other text-related search tools. These kinds of searches allow a user to locate items that are tagged with specific query terms. In addition, linking across several tag categories may be possible too. For example, if the assets are music tracks, then the metadata for a specific track could include the artist name, track name, genre and number of times played by a client device. Then, a user could search his database library of perhaps several thousand music tracks by artist—to generate a list of all tracks by that artist, or could do a cross-category search, such as most played tracks in the jazz genre. However, these systems are limited to locating and then displaying/exposing relationships between items that are inherent to the schema used to define the searchable fields in the database: for example, if the only genre categories used in the database are jazz, pop and classical, then you cannot search effectively for or display folk music.

More sophisticated systems tag a track with metadata that codes for various musical parameters—this enables track recommendation to be performed—for example, if the user is playing a music track with one set of musical parameters, then the system can automatically recommend tracks that have some of the same or similar musical parameters, allowing the user to discover tracks that he might not otherwise have even heard of. However, even these quite sophisticated systems are still necessarily limited to locating and then displaying relationships between items that are inherent to the schema used; the user can only browse for musical structures that have been pre-defined by the system designer.

A useful format for representing metadata is the Resource Description Framework (RDF); this is a major element of W3C's semantic web activity. The semantic web will, in theory, enable you to ask a question of it like: “I want a cinema showing the film Iron Man 2 on a Thursday after 5 pm near a pizza restaurant and close to the Bakerloo line in London”. The query then aggregates results from cinema, restaurant and tube train databases to get an answer, or a list of candidate answers that the user checks, in the same way as he would the hits from a conventional search engine like the Google search engine. A major disadvantage with the semantic web as currently conceived however is that the user has to pose the question in a very constraining query language called SPARQL.

RDF represents information as ‘triples’, —simple sentence-like constructions comprising a subject, predicate and object. One example might be: “The sea” (subject) “has the colour of” (predicate) “the sky” (object).

The ‘objects’ of RDF triples can be the ‘subjects’ of other triples so a collection of RDF triples can link up to form a graph.

The ‘objects’ of RDF triples can also be real web resources (URLs) or abstract concepts (like “the sky”), which are represented as URIs.

The following are the attributes of a prior art ‘Metadata Browser’—i.e. a browsing system that allows a user to browse metadata that is represented using RDF, with outputs typically in a long linear list, as with a conventional search engine.

### Rdf Server, Triplestores and Virtual Triplestores

A mechanism must exist that serves RDF metadata for a graphical client to consume. The heart of such an RDF Server is a triplestore, or group of triplestores. A triplestore, conceptually, is a very simple database that stores RDF triples and supports queries upon those triples. Whereas a relational database imposes a rigid and predefined form on the data that it stores (the database schema) a triplestore has no such schema. One way to think of this is that in a relational database the structure defines the content whereas in a triplestore the content defines the structure. This gives a triplestore the ability to express the content of any type of data with any schema. The source of the data need not be a relational database; it may be XML, free text: any kind data from which a structure can be abstracted.

When one or more such sources of data are mined the resulting RDF metadata may be aggregated in a single triplestore which can then be queried and results obtained. Equivalently, the RDF may be stored in multiple triplestores, the same query made of each triplestore, and the results from the triplestores concatenated. The end results for the two cases are identical. The single triplestore system has the advantage of simplicity of management. Multiple triplestores have the advantages of performance (many small tables are faster than a single large table and can be processed in parallel) and flexibility (for example it is easier to keep the data up-to-date). The main advantage of multiple triplestores (or viewing the data as existing in a single distributed virtual triplestore) is that it enables wide-area queries to be made of triplestores implemented in various ways, stored on different machines and located in different geographical locations. A further advantage is that is allows the user to fine-tune the query with respect to the datasets that are used in the query.

### SUMMARY OF THE INVENTION

The invention is a method of browsing metadata derived from one or more datasets, in which a client device displays a graphical map including metadata resources and links between at least some of those resources, and a user can explore or browse that map by selecting a resource to initiate the querying of metadata to generate a revised map, including new metadata resources.

The metadata may be RDF format and styling information is then sent together with the RDF data, the styling information enabling the client device to generate the graphical map.

The invention is based on the insight that conventional metadata browsing systems provide at best a graphical representation of a completed search. With the present invention, the client device displays a space in which the user can explore new relationships, initiating new searches to explore deeper or further in specific sectors of the map. A further insight is that this kind of graphically rich browse approach is inherently hard with metadata, such as RDF format metadata, that has no graphical styling information. Accompanying metadata with styling information that can be used by the client device solves this problem. We expand on this in the sections below, which also explain other concepts important to a proper understanding of the invention.

### Rdf Styling

RDF, unlike HTML, has nothing that suggests how a graphical application should render the data—there is nothing that even approximates to a <b> (for bold) HTML tag, or any of the similar tags. Even with this basic mechanism in place, in order to make HTML and therefore web pages really palatable for the casual user, better presentation schemes had to come along in the form of style sheets, and tags that allowed the embedding of graphics, audio, video and scripts.

RDF handles much the same kind of data as HTML but has no built-in way of conveying styling information. RDF itself could be used but this would mean mixing pure data with data describing how that data should be presented so increasing the bulk of the data without increasing information content, and slowing query times. Worse, the types of resource that can be described by RDF are potentially (and intentionally) infinite, so to invent a scheme that can cope with styling resources that haven't been defined yet, is a hard problem. Finally, the scheme has to cope with a multiplicity of devices, each with its own capability as regards how information can be displayed, from a low-power mobile device, to a top-end graphics workstation.

In order that the scheme does not bulk out the actual data it has to operate on an RDF dataset but not be part of that dataset. It should allow a server to exercise limited control over the display of information transmitted to the browse client. Such a mechanism should address the following problems:

Without such a mechanism, the client has no idea of the meaning of the data with which it is presented. It cannot make any decision, based on the data alone, of how to embellish the display of that data without extra ‘meta-metadata’ being provided. It does, however, know about its own capabilities as regards processing and display.

Without such a mechanism, the server has no idea of how to tell the client to embellish data, nor of what kinds of embellishment are possible. It does, however, know to a certain extent what the data means, and in a general way, how it should be rendered.

The preferred implementation mechanism addresses all of these problems. It is especially effective in a web services or cloud implementation, where there is only loose coupling between server and client.

An implementation, called Teragator, generates a 2D or 3D graphical map or graph that includes links between items, like a tree structure or concept map; the user can visually browse the network of linked items, rapidly exploring new and unexpected connections and initiating new queries/interrogations to generate further new connections. This removes the need for the user to pose a tightly structured question (for example using SPARQL); instead, the user himself browses the links and nodes in the graphical network to discover items of relevance and interest and to initiate new queries (a ‘Teragate’ query). So Teragator does not merely generate a visual graph or map of a completed search, but instead generates a visual representation of a space that a user can explore, initiating new searches to discover new structures and relationships.

### Metadata Capture and Identity Resolution

The raw material for a Teragator Metadata Browser consists of independent data ‘feeds’. There may be a large number of such feeds, they may be physically, geographically and logically separate and use a variety of input formats. For example, there may be RSS news feeds and blogs on the internet, automated speech-to-text systems and logging systems operated by humans. The net effect of this is that real-life unique entities such as people, places and events may be referred to in many different ways. For example one feed may refer to a person using their full name whereas a second may just use the middle initials, so there is no straightforward way of relating one to the other.

An important requirement of a Teragator Metadata Browser is to be able seamlessly to navigate through a space consisting of linked ‘concepts’, without having to intervene in any way to match one name against another. The system, therefore, must be responsible for this matching process.

### Search And Browse

The user of a Teragator Metadata Browser typically is engaged in an unstructured search—they are looking for something of interest or importance, but for whatever reason cannot specify how to find that thing. It may be that he or she simply is looking for ideas for a new project. In this situation it is important that the system provides assistance to the user. One method is to utilise a traditional free text search technique to rank data according to the search terms and present the information according to this ranking.

The disadvantage of this is that it is easy for potentially useful information to be missed if the wrong search terms are entered. Even if the data is available the most valuable information may be contained in the relationships between entities, rather than in the entities themselves, and these may not be immediately apparent.

An alternative to the ‘Search’ paradigm is the ‘Browse’ paradigm. With browse, resources are organised into categories prior to the user making queries. When the queries are made the user can make use of the fact that items are categorised to make the queries more efficient. This also means that the user can examine the categories in an unstructured fashion without having a particular goal, or having an ill-defined goal, and find resources of interest through serendipity. A disadvantage of this is that the categories may not be those that the user would choose, or expect.

### Ontologies

Ontologies are a way of formally describing a system. At their simplest they can be regarded as a taxonomy that defines everything as a subclass of something else, i.e., there exists a “is a type of” relation between resources; for example, Cambridge is a type of City which is a type of Place. More complex ontologies, however, can use property attributes in conjunction with rules to describe systems in much greater detail and with much greater accuracy. For example an ontology may categorise golfers as follows:

Top Golfer is type of Professional Golfer is type of Golfer.

A ‘handicap’ property may be defined that may be applied to any ‘Golfer’ together with a rule that in effect says: “if handicap is less than some value then this Golfer is in the ‘Top Golfer’ class. The hierarchy can therefore be dynamic and reflect changes in the real world that the ontology models.

In Teragator, we use an ontology to mine resources from different databases, which results in the discovered resources having completely unambiguous names, even though those resources may be referred to slightly differently in the various databases. This means that the aggregation step is purely a matter of glueing the RDF datasets together—there is no extra work.

### Feature Extraction

Graph theory provides many methods of deriving characteristics of a graph from its structure; three such are the ‘degree’, ‘connectivity’, and ‘distance’ metrics. The degree of a vertex is the number of other vertices to which it is directly connected. The connectivity is the total number of vertices to which it is directly and indirectly connected. The distance of a vertex is the length of the path between it and another vertex.

These metrics can be used to highlight interesting or unexpected relationships.

### Graphical Presentation

From the point of view of a Metadata Browser the relationships between data is as important as the type and value of the data itself. Where the data represents something fairly complex, for example a person, there can be a very large number of such relationships; for example, family, acquaintances, business partners, customers, financial resources, favourite music, and so on. A Teragator Metadata Browser must present all this data in a way that is comprehensible to a human user. One way of doing this is to make use of the human cognitive system and its ability to understand spatial grouping. If the data is rendered graphically on a two dimensional display in a virtual three-dimensional space then the data relationships can be modelled using the language of spatial grouping. For example; ‘people’ data items can be closely grouped: the closer the relationship (e.g. family) the closer the data items. Other, more distantly related, physical entities like business partners could be shown at a slight distance Relations that are different in kind, but important to the individual in question, for example abstract concepts like ‘favourite types of music’ may be shown close, but rendered differently, for example using a different colour palette.

### Path Traversal

As a user of a Teragator Metadata Browser navigates the metadata space they continuously are making choices about where to go next, based on their current position, and what data is visible from this point. These choices reflect the user's preferred method of working. By recording past paths through a graph the system can infer for a user, or group of user, the most likely future paths, and can arrange the presentation of data accordingly.

To do this, another graph is maintained that overlays the navigated graph, and records, for each vertex, and for each edge leaving that vertex, the probability that the user will traverse that edge.

### Feature Highlighting

As described in a previous section, the Metadata Browser processes the graph in order to extract extra metadata (meta-metadata) that can be used to assist a user perform an unstructured search. The purpose of this new metadata is to expose to the presentation system unexpected or unusual relationships, clustering, and anything that is statistically significant.

### BRIEF DESCRIPTION OF THE DRAWINGS

FIG. 1 outlines the basic problem that the “Identity” service aspect of the invention solves.

FIG. 2 introduces an “Identity Service”, the purpose of which is to resolve these differences.

FIG. 3 shows the Wall Street feed using the Identity Service to resolve the URI.

FIG. 4 shows the News Media Feed using the Identity Service to resolve the URI.

FIG. 5 shows the Enquiry service using the universal names to connect concepts that otherwise would remain hidden,

FIG. 6 shows the connections between the elements that, together, make up the story.

FIG. 7 shows the entries in the Identity Service database at the end of the step shown in FIG. 5.

FIG. 8 outlines the meanings of the ‘degree’, ‘connectivity’, and ‘distance’ metrics.

FIG. 9 shows how these metrics may be used, irrespective of the precise meaning of the data, to make inferences about that data.

FIG. 10 shows how the graph is presented to the user, and how it may be used in the context of a professional broadcast workflow in which a user browses for, locates, and edits together media clips into a finished item.

FIG. 11 shows a subtree of the graph being displayed with icons (a picture of a reel of film) that represent physical media.

FIG. 12 shows one method of conveying path traversal information to the user.

FIG. 13 shows one method of conveying feature extraction information to the user.

FIG. 14 shows how RDF, which is a way of representing resources and their relationships as a graph, can be represented in a file as RDF/XML.

FIG. 15 is a diagram of a system comprising a communication medium to which are attached the various aspects of the Media Browser.

FIG. 16 is an example of how raw data from a feed is transformed into an RDF representation.

FIGS. 17-20 are screen shots from a client device running Teragator; the screenshots illustrate the operation of the ontology-based querying.

FIG. 21 is a screen shot from a client device running Teragator; the screenshots illustrate the operation of ontology based resource mining.

FIG. 22-26 illustrate RDF styling.

FIGS. 27-31 illustrate Teragator applications.

FIGS. 32-39 illustrate a Teragator social networking application

FIGS. 40-55 illustrate the Teragator user interface.

### DETAILED DESCRIPTION

An implementation of the invention is called Teragator. Teragator is a method and apparatus for processing data where the data is transmitted to processing elements over a communication medium. The processing elements may be software, hardware, or a combination of the two. Typically the data originates from feeds which can be sources of video or audio media, or information services, or database services, or any other type of source of information. The data may be live, in the sense that it is created immediately prior to being processed, such as is the case with the video feed from a news event, or it may be long-lived data from an archive.

In one aspect of the present invention a digital processing system creates a second set of data from the first set of data that indicates the nature of the content of the first set of data. This second set of data is called metadata. The metadata is used to help human or machine agents to locate wanted parts of the first set of data.

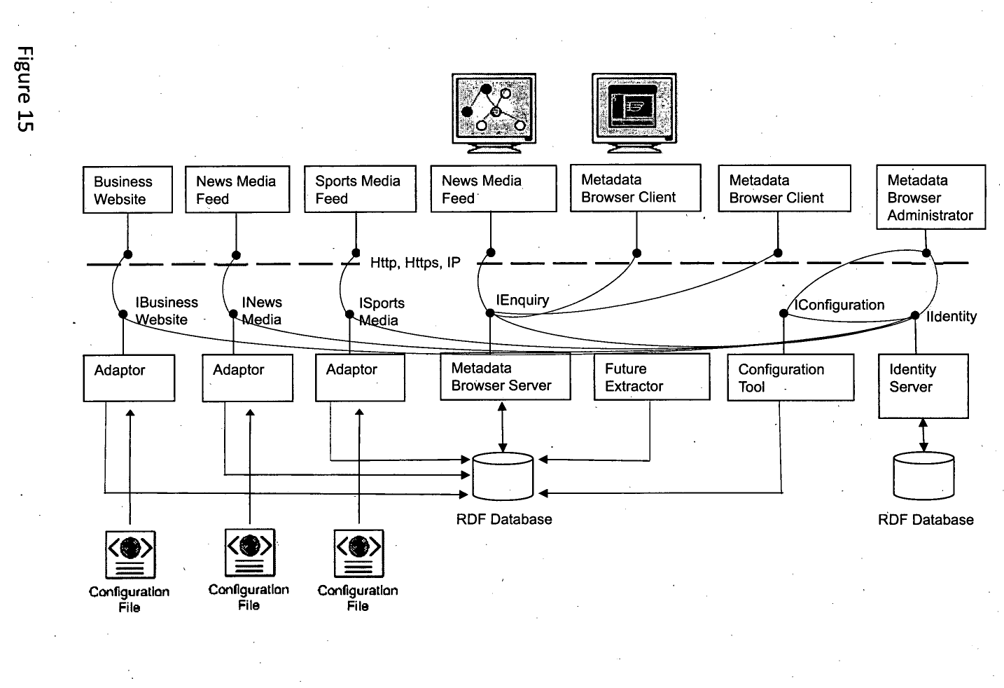

In one embodiment of this aspect of the present invention a Metadata Browser server provides a storage facility for metadata and an interface by which means clients on the communication network can access the stored metadata. FIG. 15 shows a block diagram of the elements of a Metadata Browser. It can be seen that the Metadata Browser server communicates with a number of other processing elements. One such element is the processing element responsible for the extraction of metadata from data and its transmission the Metadata Browser.

In one embodiment of this aspect of the present invention the metadata that is passed from the Metadata Browser server to the client has extra styling information added that suggests to the client how the metadata should be rendered. This styling information is not stored alongside the metadata and so does not add bulk or cause query performance to deteriorate. A client publishes its particular capabilities as regards rendering and presentation as a publically accessible electronic document. A server that wishes to pass metadata to that client for display retrieves this document, reads the capabilities of the client, matches the presentation requirements at the server with the presentation capabilities at the client, and sends the appropriate styling information. This styling information consists of a set of commands, one for each presentation effect that is required, where each command consists of: (1) a regular expression that the client applies to the textual value of the RDF triples that has the effect of selecting a subset of triples and (2) a capability that is selected from the list of capabilities that the client has published that is applied to this subset.

In one embodiment of this aspect of the present invention this extraction is performed by a processing element called an Adaptor which may be implemented in software or hardware or a combination of the two. There can be multiple Adaptors, each specialised for the purpose of extracting metadata from a particular source format, forming it into one standard metadata format, and passing it to the Metadata Browser Server. It may be the case that the information content of the source is already metadata that describes some other data in which case the Adaptor just converts this metadata into the standard format.

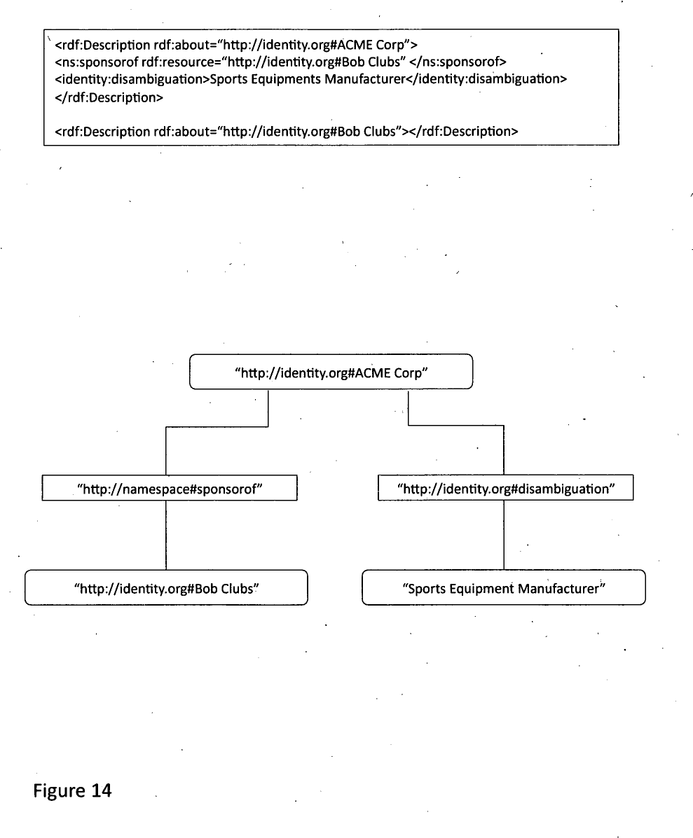

In the preferred embodiment of this aspect of the invention the standard format is the Resource Description Framework (RDF). FIG. 14 shows how RDF, which is a way of representing resources and their relationships as a graph, can be represented in a file as RDF/XML.

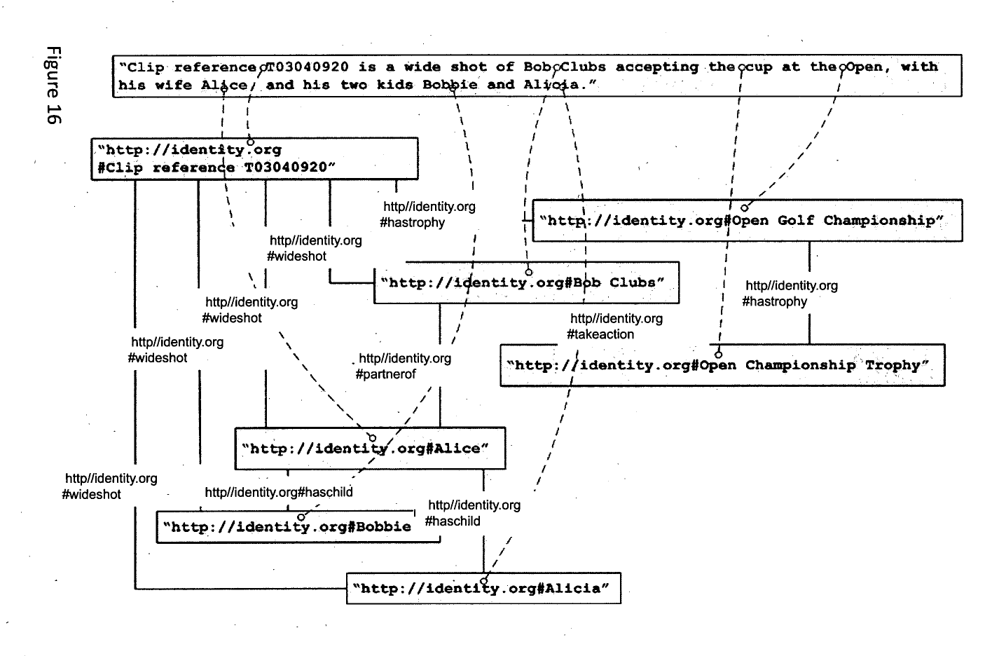

In one embodiment of this aspect of the present invention the Adaptor uses natural language processing to convert unstructured textual information into the standard metadata format. FIG. 16 gives an example of this process. A sentence in the form of a string of text is parsed to find nouns and proper names. As shown in FIG. 15 these are transmitted to an Identity Server in order to determine the URIs that represent these elements. These URIs are marked as potential subjects and objects in the RDF graph that represents the sentence. Similarly, the sentence is parsed to extract the verb phrases and noun phrases and these are transmitted to the Identity Server which returns URIs that are marked as potential predicates in the RDF graph that represents the sentence. The sentence is parsed once more to determine the relationships between the subjects, predicates and objects; the RDF graph that is produced is the end product of the Adaptor and is transmitted to the Metadata Server,

In another embodiment of this aspect of the present invention the Adaptor uses a prior art Automatic Speech-to-Text system to extract text from the soundtracks of media files.

In another embodiment of this aspect of the present invention the Adaptor uses a prior art video processing system to extract features including shot change, colour histogram, on-screen text, motion, objects, and any other feature that may automatically be recognised.

In another embodiment of this aspect of the present invention the Adaptor uses a human operator to manually enter metadata.

In another embodiment of this aspect of the present invention the Adaptor uses natural language processing to parse unstructured textual information and extract semantic content which is then represented using the standard metadata format. The semantic content that is extracted describes resources and the relationships between them. One example is simply to encode the fact that resources A, B and C have been discovered in a particular context (such as text annotation of a single media clip), which may be described in an informal RDF notation as:

<media annotation text> hasComposition {A, B, C}.

This is read as “the resources A, B and C are all to be found in this text annotation, and by implication, in the video clip the text describes”.

A more complex example is:

<media annotation text>hasComposition {(A, B, C), (B, D)}.

This is read as “the resources A, B and C are together in a scene followed by a scene where the resources B and D are together”. This introduces the two concepts of encoding groupings of resources, and of sequences of such groupings. An application of this is metadata describing a sporting event where the resources A and B may be players, the resource C may be a “Pass” and D may be “Goal”. The encoding in this case means: “player A passes to player B then player B scores a goal*.

This resource-relationship encoding is called a Composition in the present embodiment.

In another embodiment of this aspect of the present invention the Adaptor uses an ontology to assist the discovery of resources. Resources can be referred to in many different ways, such that no algorithm can discover, without prior knowledge, the intended meaning. One example is ‘New York’ being referred to as ‘The Big Apple’. An ontology is able to store the different names of resources and the data mining process can refer to these during the process of resource discovery.

In another embodiment of this aspect of the present invention the Adaptor uses a dictionary to disambiguate the text items discovered, and to match them to the correct resource. ‘The text item ‘The Big Apple’ can refer to ‘New York’ or a ‘Fruit’. Other text items found in the same context (such as text annotation of a single media clip) are examined to find the possible senses. If ‘Fruit-Related’ is a more common way of understanding the sense of the other text items in the context than ‘Place-Related’ then “The Big Apple” is taken to be an Apple (in the sense of fruit) resource; otherwise, it is taken to mean ‘New York’.

In one embodiment of this aspect of the present invention the source of data for an Adaptor is a Feed which includes, but is not limited to, web sites, XML feeds such as RSS, the output from automated speech or video recognition systems, or data generated by human operators working logging devices.

In one embodiment of this aspect of the present invention the Adaptor is a generic processing element which is specialised for a particular Feed by means of a configuration file.

In the preferred embodiment of this aspect of the invention the configuration file is itself an RDF graph that describes the mapping between source and target metadata elements, and which is stored as a RDF/XML file.

In the preferred embodiment of this aspect of the present invention the configuration file is generated by a configuration tool as shown in FIG. 15. This configuration tool allows a user of the Metadata Browser to create a new Adaptor for a Feed, without detailed knowledge of any other parts of the system.

In one embodiment of this aspect of the present invention an Identity Server provides the means by which unique names are generated to represent people, organisations, events, media items, and anything else that may be subject to a search, and also the means to resolve ambiguities which may exist when a unique entity (such as a person) is known by several different names. FIG. 15 shows the Identity Server in the context of the whole system. The Identity Server exposes an interface (IIdentity) which is used by clients to look up names. The clients of the Identity Server include the Metadata Browser Server and the Adaptors.

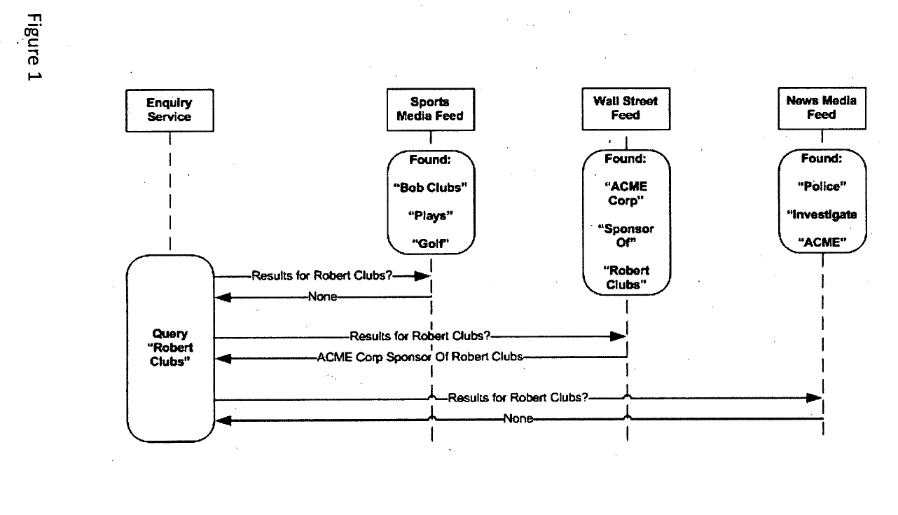

FIGS. 1 to 7 show the process of Identity resolution.

FIG. 1 shows the basic problem that the Identity Server aspect of the invention solves. An Enquiry Service has the responsibility of gathering information from remote feeds, finding items of interest, and using these items to put together media programs such as breaking news or sports highlights.

The Feeds are diverse sources of information; they may be web sites, XML feeds, the output from automated speech or video recognition systems, or data generated by human operators working logging devices. In the figure there are three hypothetical feeds:—a “Sports Media Feed” generates sports media clips and metadata that describes those clips; a “Wall Street Feed” is a website hosting a database that holds data concerning companies and their sponsorship deals; the “News Media Feed” generates news media clips and metadata that describes those clips.

A user of the Enquiry Service wishes to put together a media item about a hypothetical golf player called “Robert Clubs”. Using the name “Robert Clubs” as the search term produces few results as the Golfer in question is known by different names in the context of the different feeds.

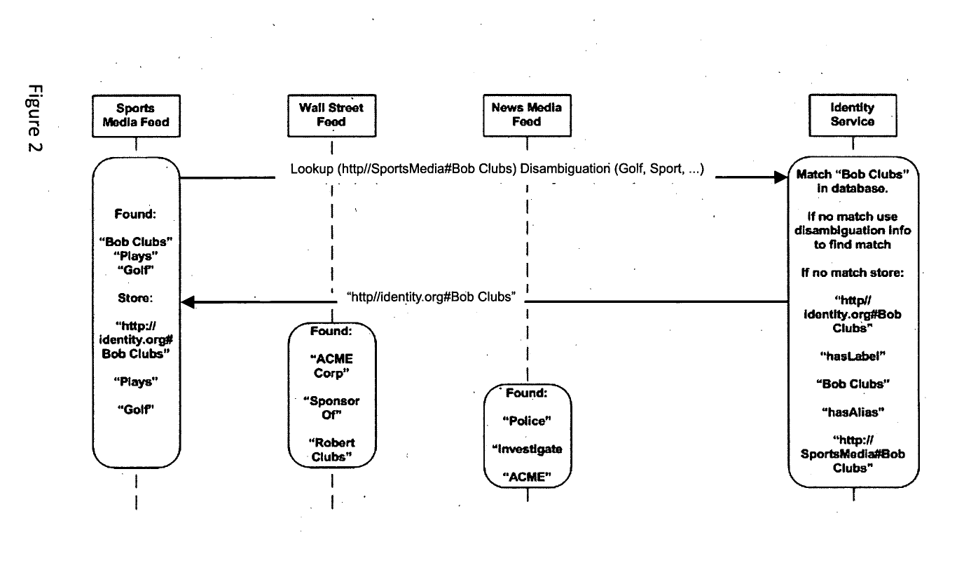

FIG. 2 introduces the Identity Service, the purpose of which is to resolve these differences.

The Sports Media Feed finds a clip of a player named “Bob Clubs” playing golf. This clip is indexed and RDF metadata added to the effect of “Bob Clubs” (subject) “Plays” (predicate) “Golf” (object). Now the Feed needs to ensure that the names that are entered into the RDF database are usable anywhere. It transmits a message to the Identity Service consisting of two parts: the first is a URI combining the namespace of the feed (http://SportsMedia) with a URI fragment (“Bob Clubs”) that is the given name in that namespace. The second is additional, disambiguating, information that the service can use. It is the responsibility of the Identity Service, either to infer the unique entity (the human being) that the name represents and return the name already allocated by the service, or to make a new identity, and return it. In this case it makes a new identity (http://identity.org#Bob Clubs) and returns it to the “Sports Media Feed” client.

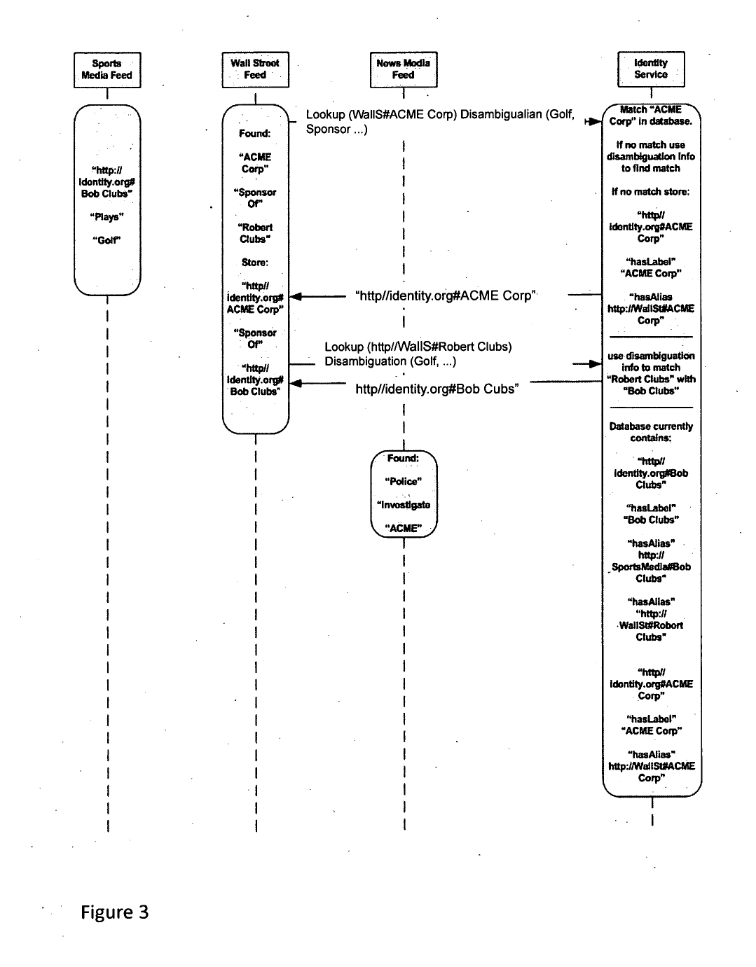

In FIG. 3 the Wall Street feed uses the Identity Service to resolve the URI allocated locally (http://WallSt/ACME Corp) to a new URI (http://identity.org#ACME Corp) and returns this to the “Wall Street Feed” client.

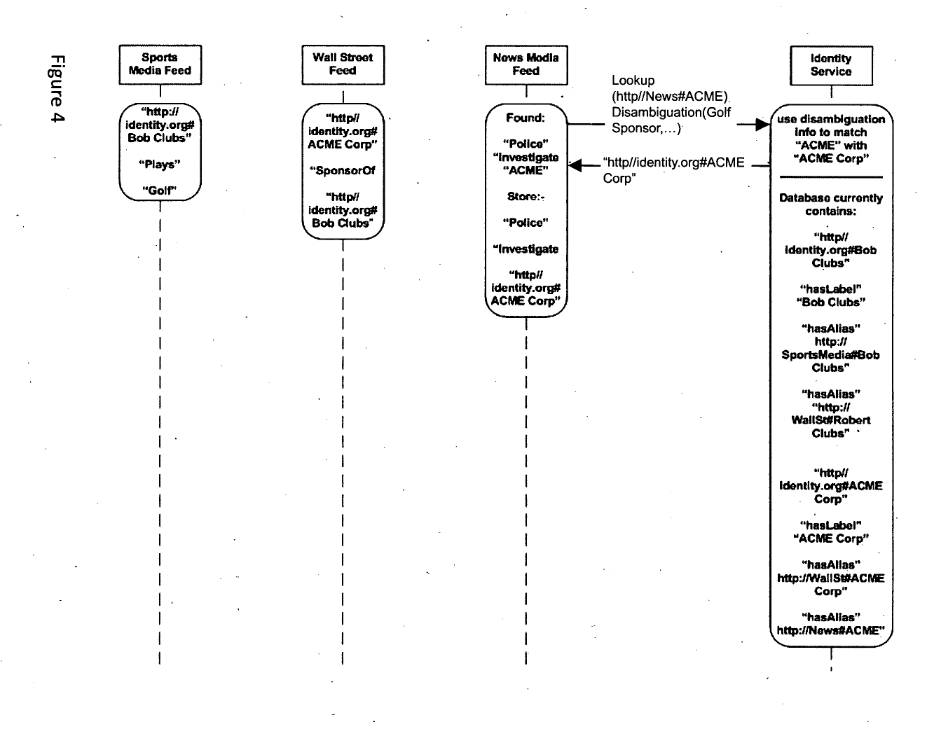

In FIG. 4 the News Media Feed uses the Identity Service to resolve the URI allocated locally (http://News/ACME) to the URI (http://identity.org#ACME Corp) and returns this to the “News Media Feed” client.

At this point all the parties agree about the names. “Bob Clubs” is known as http://identity.org#Bob Clubs and “ACME Corp” is known as http://WallSt/ACME Corp.

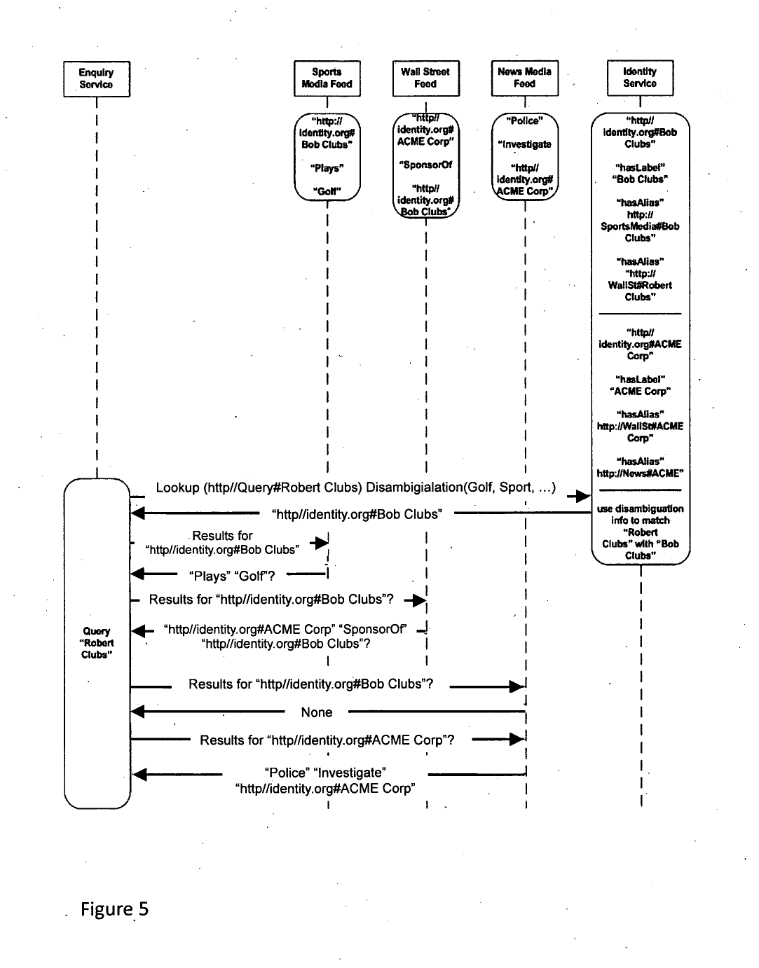

In FIG. 5 the Enquiry service uses the universal names to connect concepts that otherwise would remain hidden.

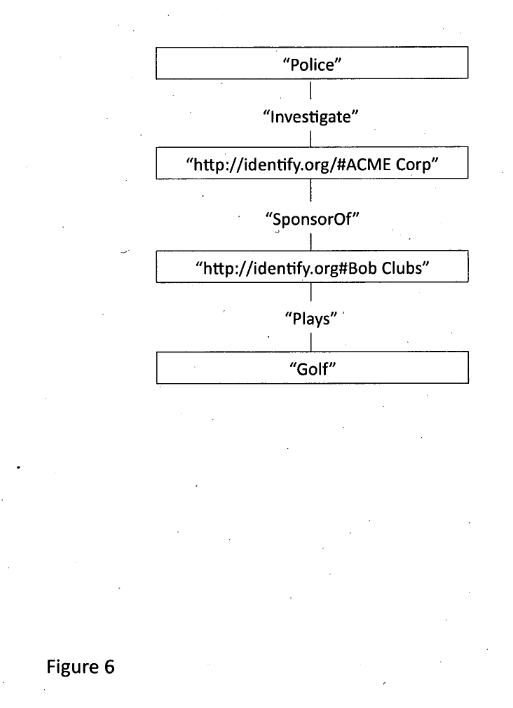

FIG. 6 shows the connections between the elements that, together, make up the story. It can be seen that Bob Clubs is sponsored by a company called ACME that is subject to police investigation.

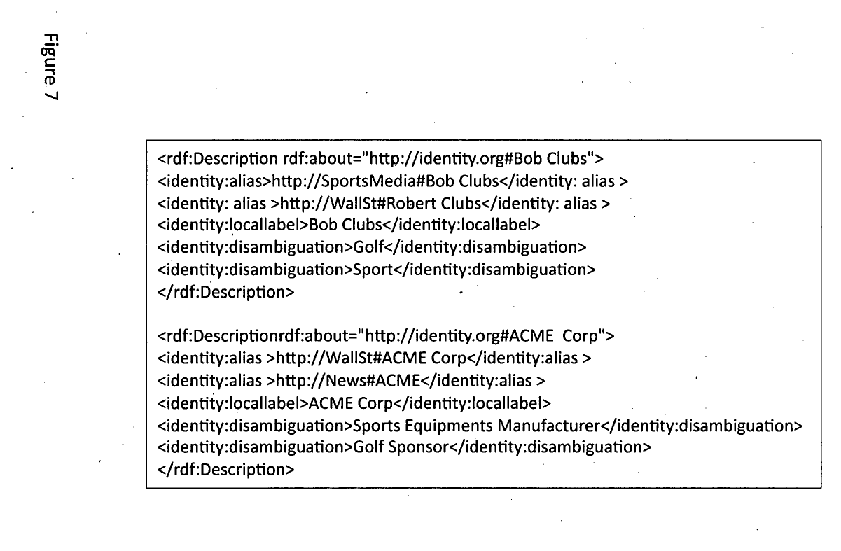

FIG. 7 shows the entries in the Identity Service database at the end of the step shown in FIG. 5. The data is stored as RDF/XML and consists of two basic pieces of information:—
(1) A unique entity exists and is known as “http://identity.org#Bob Clubs” and has two aliases; “http://SportsMedia#Bob Clubs” in the context of the “SportsMedia” feed, and “http://WallSt#Robert Clubs” in the context of the “Wall Street” feed.
(2) A unique entity exists and is known as “http://identity.org#ACME Corp” and has two aliases; “http://WallSt#ACME Corp” in the context of the “Wall Street” feed, and “http://News#ACME” in the context of the “News Media” feed.

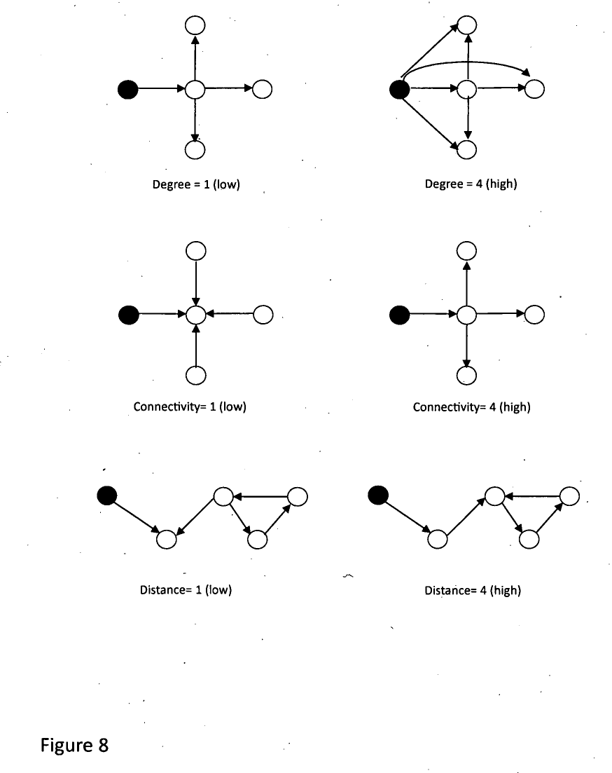

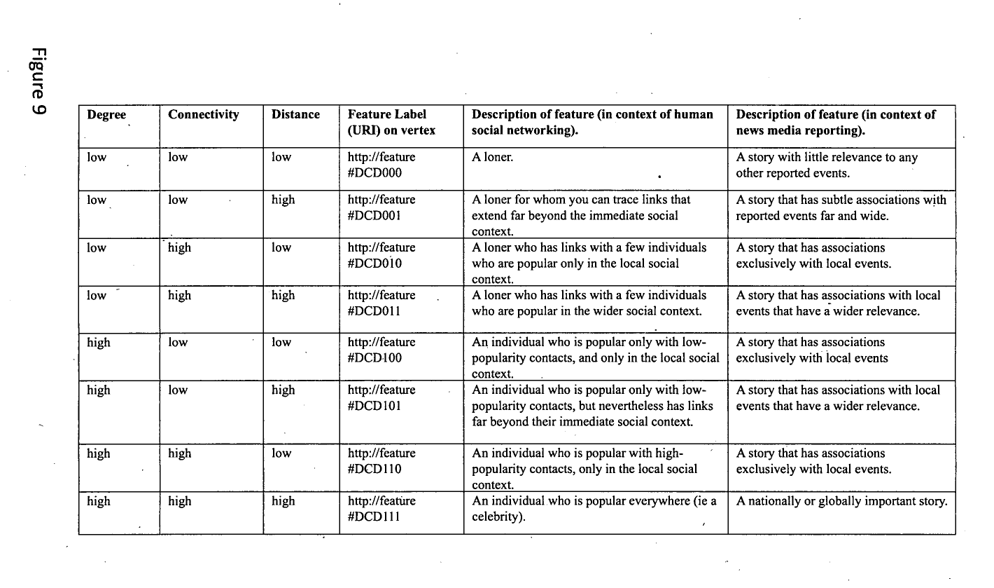

In one embodiment of this aspect of the present invention processing is applied to the graph to extract feature information that describes the patterns of relationships between the vertices of the graph. In the preferred embodiment of this aspect of the present invention the processing that is applied need have no knowledge of the meaning of the data that is stored in the graph. FIG. 15 shows such a Feature Extraction element connected to the RDF database of the Media Browser Server, and FIGS. 8 and 9 show an example of how the graph may be processed to extract information which can be used to help human or machine agents to locate wanted parts of the data.

FIG. 8 shows three properties of a graph which may be used to create feature information: ‘degree’, ‘connectivity’, and ‘distance’. The degree of a vertex is the number of other vertices to which it is directly connected. The connectivity is the total number of vertices to which it is directly and indirectly connected. The distance of a vertex is the length of the path between it and anther vertex. In this and in the following figures ‘distance’ metric means the maximum distance—the distance between a node and that furthest from it. The assumption is also introduced here that the numerical value associated with a metric is thresholded, with respect to the mean or by some other method, to result in a low' or ‘high’ value.

FIG. 9 shows how these metrics may be used, irrespective of the precise meaning of the data, to make inferences about that data. Applying the three metrics, each with two possible values, to a each vertex within a graph, results in eight possible unique labels that may be assigned to that vertex. The labels may be interpreted according to the kind of data that the vertex represents. Therefore, the processing that is applied to the graph needs no knowledge of the data in order to produce results that are applicable to that data.

The end product of the feature extraction is another graph that is served by the Metadata Browser Server to clients, and which is used to highlight unusual, or hard-to-find patterns.

In another aspect of the present invention a digital processing system presents a graphical representation of metadata.

In one embodiment of this aspect of the present invention a client software program system uses the IEnquiry Service endpoint of a Metadata Browser Server to request that parts, or all, of the graph information that is stored in the Metadata Browser, be transmitted across the communication medium to the client. FIG. 15 shows two such Metadata Browser clients, with different means of displaying the information from the graph, although there may be any number.

In one embodiment of this aspect of the invention the vertices of the graph are displayed as icons, and the arcs of the graph are displayed as lines connecting the icons, resulting in the presentation of the data as a mesh.

In one embodiment of this aspect of the invention the user can use a graphical input device such as a mouse, to move through the presentation of the graph in order to explore the data visually.

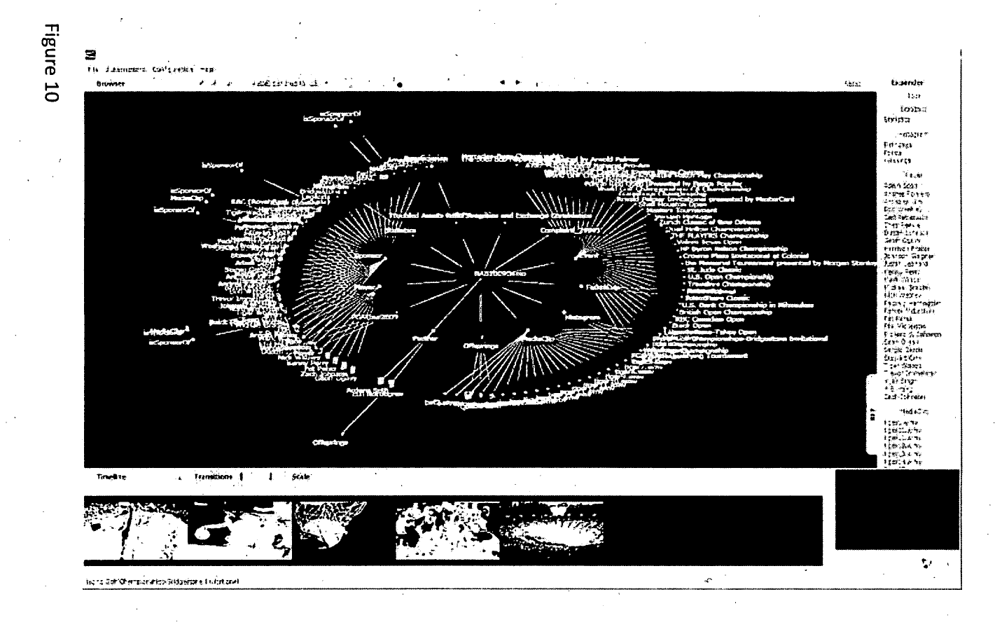

FIG. 10 shows an example of how the graph is presented to the user, and how it may be used in the context of a professional broadcast workflow in which a user browses for, locates, and edits together media clips into a finished item.

The main viewport shows a section of the graph rendered as a tree, where the root vertex of the tree is positioned at the centre and the descendant vertices are distributed radially, where the radius at which each is positioned corresponds to its level of hierarchy with respect to the root. The edge connecting two vertices is represented by a line which is labelled with the appropriate RDF predicate. At the right of this is a selectable list of all the individual vertices in the graph. Selecting an item in the list results in that item becoming the root of a subtree and that subtree being displayed. At the bottom is a conventional editing timeline where images representing sub clips may be placed. The left-to-right ordering of the images represents the order in which they are played, and the horizontal extent represents the length of the sub clip. On the right of the timeline is a media viewer.

Vertices in the graph may represent entities with or without associated media. Wherever a media item is available there is an edge connecting that entity with an icon that represents that media. If the icon is selected (for example by double clicking) the media clip is loaded into the media viewer. Alternatively the icon can be dragged to the viewer to play it, or dragged directly onto the timeline.

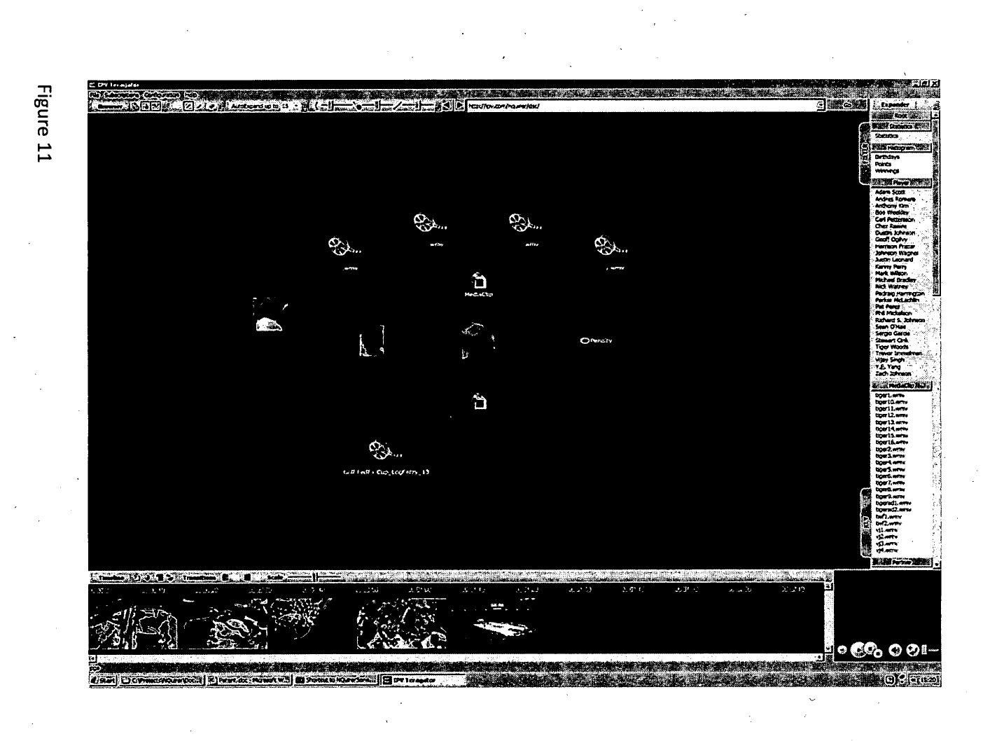

FIG. 11 shows a subtree of the graph being displayed with icons (a picture of a reel of film) that represent physical media.

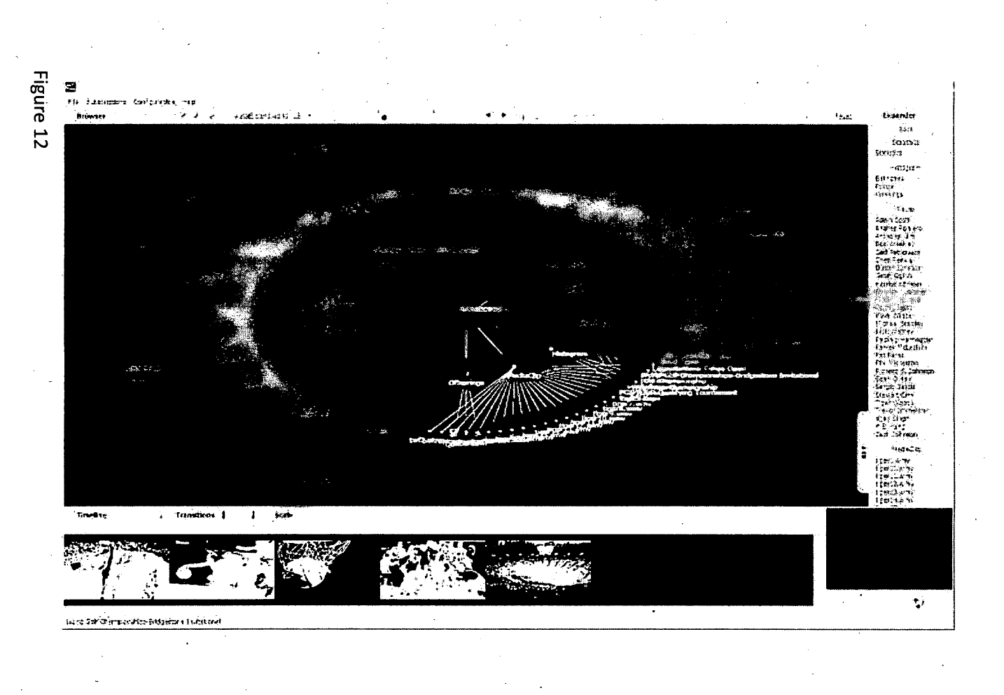

FIG. 12 shows one method of conveying path traversal information to the user. The graph is the same as that shown in FIG. 10 except that frequently-traversed paths are shown in full sharpness whereas those that are rarely used are softened. The less-used the path the softer the rendition, although the user can still see that the data exists, and can select it and from then on view it at full sharpness.

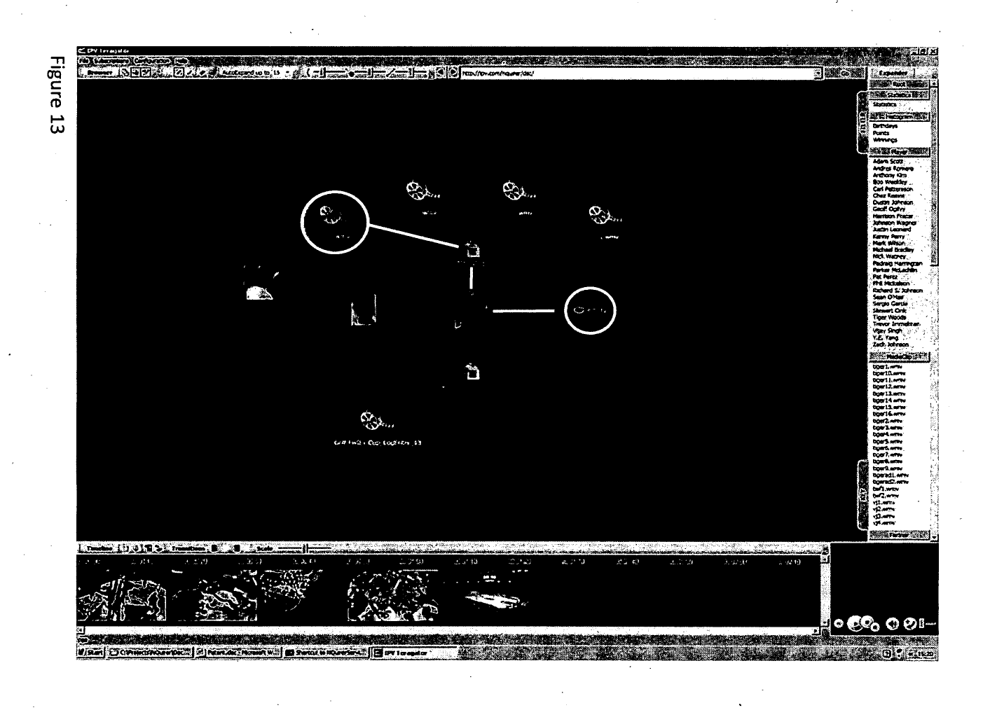

FIG. 13 shows one method of conveying feature extraction information to the user. The graph is the same as that shown in FIG. 11 except that a two vertices with interesting properties have been detected; the vertices have been picked out with circles and the path between them highlighted.

In another embodiment of this aspect of the invention the vertices of the graph are displayed as tables, and the arcs of the graph are displayed as hyperlinks which link between tables, as is found in a conventional web browser.

Further details are given in the following appendices:

Appendix 1—Ontology based querying (the ‘Teragate’ query)

### Appendix 2—Ontology Based Resource Mining And Display

### Appendix 3—Styling RDF

### Appendix 4—Teragator Applications

### Appendix 5—Using Teragator for Social Networking.

### Appendix 6—Teragator Triplestore Design

### Appendix 7—Teragator User Interface

### Appendix 1—Ontology Based Querying (the ‘Teragate’ Query)

This Appendix 1 describes the ‘Teragate’ query—a means of querying a dataset using terms that correspond to the textual values of ontology elements, i.e., the names either of classes or individuals according to the OWL ontology specification [3]. This is in contrast to free-text queries where the literal value of a search term is used in the query. So, for example, in a free text query the term ‘Places’ will return records containing the word ‘Place’ or ‘Places’ whereas a Teragate query will return records corresponding to members of a ‘Places’ class in the ontology, such as: England, United States, Australia, etc.

### Method—Dataset Processing

### Construct Resource Class Hierarchy

As resources are discovered a graph is built in the triplestore that represents the class hierarchy of an element in the ontology, for example, when text representing the company ‘IPV’ is mined it is inserted into the ontology as:
Teragator→Organisation→Company→InformationTechnologyCompany→IPV.

### Construct Composite Resources

During the metadata mining process, as ontology elements (IPV and Cambridge and Cricket) are discovered in a semantic relationship for the first time (they are connected in some way in the metadata, for example a text string contains all three terms in the same context), a new resource is created that represents the fact that IPV and Cambridge and Cricket are in some way linked, and evidence of this relationship is present in an asset.

In the visualisation this composite resource is called a composition and has the following properties:
Each composition links to one or more assets.
Each composition links to the participants (the resource nodes in the ontology that represent the individuals).

As more assets are found that have the same linkage (IPV, Cambridge, Cricket) they are added to the {IPV, Cambridge, Cricket} composite resource.

Every node in the ontology graph connects both to subcategories in the ontology, as described, and to all the compositions that relate to this ontology node. So, for example, the ‘Sports’ node in the ontology links to all the Sports-related clips, including {IPV, Cambridge, Cricket}, which in turn link to the physical assets, as will the ‘InformationTechnologyCompany’ node, and the nodes for IPV and Cricket themselves. Thus, at any node, we can navigate to the next level in a top-down or bottom-up fashion, by following subcategories or clips.

### Query Processing

### Derive Lists of Ontology Names of Descendent Subclasses of Query Terms

List<List<string>> descendentsOfParticipants = new List<List<string>>( );
foreach (string queryParticipant in queryParticipants)
{

List<string> descendents = new List<string>( );
OntologyElement oe = null;
if

(kv.Value.TheIndividualOnameToOntologyElementMap.ContainsKey
(queryParticipant))

{

oe =

kv.Value.TheIndividualOnameToOntologyElementMap[queryParticipant];

}
else if

(kv.Value.TheCategoryOnameToOntologyElementMap.ContainsKey
(queryParticipant))

{

oe =
kv.Value.TheCategoryOnameToOntologyElementMap
[queryParticipant];

}
if (null != oe)
{

oe.GetDescendents(descendents);
descendentsOfParticipants.Add(descendents);

}

}

Assume that a query containing the terms ‘Sport’ and ‘Organisation’ has been made, so in the above code the list queryParticipants equals {Sport, Organisation}. The code then finds all the descendants of these terms:

| 1st level | 2nd level | 3rd level | terminals |
|---|---|---|---|
| Organisation | Company | FoodAndDrinkCompany | Budweiser |
| | | InformationTechnologyCompany | Guinness |
| | | EnergyCompany | IPV |
| | | | Apple |
| | | | Texaco |
| Sport | | | Fishing |
| | | | Golf |
| | | | Cricket |

The terminals that are found in this process (individuals in the ontology that have no sub-classes) are: Budweiser, Guinness, IPV, Apple, Texaco, Fishing, Golf and Cricket.

### Parse Name of Composite Resources to Derive Ontology Names

IEnumerable<string> compositions

= theAdaptorConfiguration.TheGraph.SelectObjects

(null,
TeragatorNames.TheHasCompositionPredicate)
.Distinct( )
.Select<RdfComponent, string>(r =>
r.TheStringRepresentation);

The next step is to find those assets in which one or more of the names found in the above step appear in a related context as metadata. All the resources that represent compositions are selected from the triplestore. The participants of the composition are encoded into the textual value of the string of the RDF subject to make finding participants efficient. For the current example the resource's RDF subject is:

http://ipv.com/teragator/development/namespaces/identity#-Cambridge-Cricket-IPV”

The participants can be obtained by parsing the localname part of the URI (just by splitting on the ‘-’ character) to obtain: Cambridge, Cricket, IPV.

### Match Composite Resource Ontology Names Against Query Ontology Names

List<string> compositionHits = new List<string>( );
foreach (string composition in compositions)
{

List<string> compositionParticipants

= CoolUri.GetLocalName(composition)

.Split(“-”.ToCharArray( ),

StringSplitOptions.RemoveEmptyEntries).ToList( );

// if each of the lists in descendentsOfParticipants find a match in
// the compositionParticipants list then we want the current
composition
bool haveFoundComposition = false;
foreach (List<string> descendentsOfParticipant in

descendentsOfParticipants)

{

haveFoundComposition = false;
foreach (string compositionParticipant in
compositionParticipants)
{

if (descendentsOfParticipant.Contains
(compositionParticipant))
{

haveFoundComposition = true;

}

}
if (!haveFoundComposition)
{

break;

}

}
if (haveFoundComposition)
{

compositionHits.Add(composition);

}

}

Now the list of participants (compositionParticipants) is queried to find all those compositions that satisfy the requirement that their elements are subclasses of ‘Organisation’ and ‘Sport’. The result of this step is a list of all the composition resources that connect ‘Organisation’ and ‘Sport’, i.e.,
{Antarctica, Christmas, Golf, IPV}
{Cambridge, Cricket, IPV}

### Find Assets of Compositions

//
// now find the asset triples for the composition hits and write to result
graph
//
SchemaGraph resultGraph =
((TeragateQueryProcessContext)context).TheResultGraph;
foreach(UriRef compositionHitResource in compositionHits.Select(c =>
new UriRef(c)))
{

TripleList triples

= theAdaptorConfiguration.TheGraph.SelectTriple

(compositionHitResource,

TeragatorNames.TheHasAssetPredicate, null);

resultGraph.AddTriples(triples);
RdfTriple labelTriple

= theAdaptorConfiguration.TheGraph.SelectTriples
(compositionHitResource,

RdfNaming.GetNameAsUriRef(RdfNaming.rdfsLabel), null)

.First( );

resultGraph.AddTriple(labelTriple);

}

The final step is to return the assets whose metadata the compositions describe. In the current example both compositions, {Antarctica, Christmas, Golf, IPV} and {Cambridge, Cricket, IPV} are derived from a single asset “News Reel 3”. This is because the asset has timecode-delimited chunks of textual metadata as follows:—

00:01:02:03 IPV to sponsor golf tournament in antarctica next christmas
00:05:06:07 IPV Cambridge cricket team is sponsored by IPV
12:13:14:15 Bicycle is most popular way of getting to work for employees of cambridge firm IPV

The resource mining process chunks the text using timecodes (strings of the form aa:bb:cc:dd) and treats each as a separate asset. The two assets that satisfied the query are:

IPV to sponsor golf tournament in antarctica next christmas
Cambridge cricket team is sponsored by IPV

### EXAMPLES

### Broad Queries

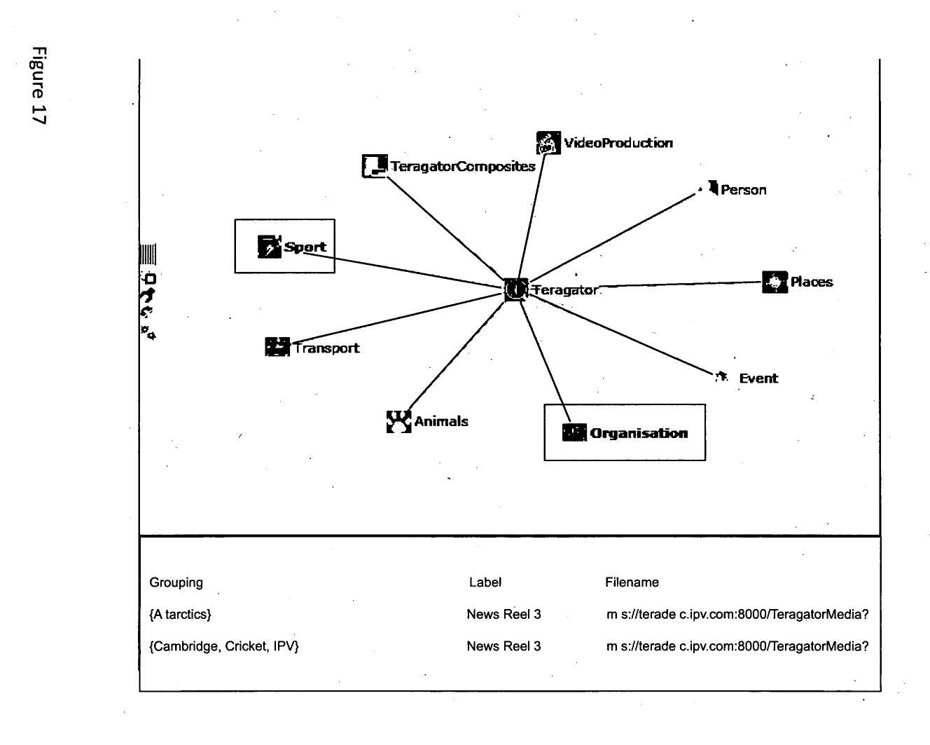

The Teragate query has the ability to provide precise answers to a fuzzy query. So, for example, if we know nothing more than that we want to find assets that somehow provide evidence of ‘Sport’ being linked to ‘Organisation’ then a Teragate query will find all such assets (subject to the accuracy of the data mining process). The FIG. 17 demonstrates two such assets being located—{Antarctica, Christmas, Golf, IPV} and {Cambridge, Cricket, IPV}.

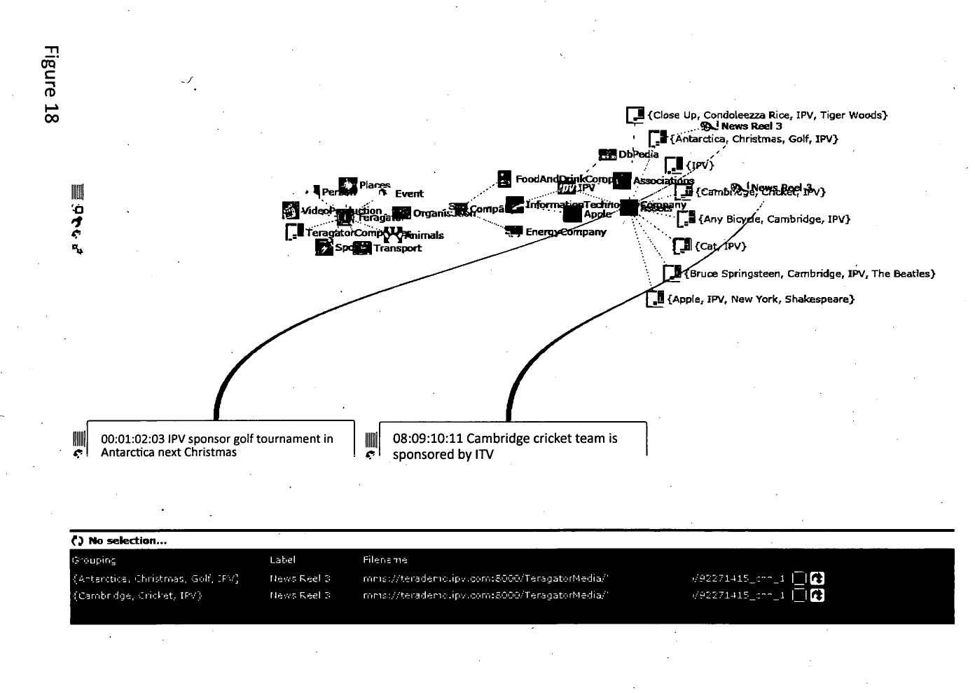

FIG. 18 shows the textual annotations that were mined and which resulted in the two compositions ({Antarctica, Christmas, Golf, IPV} and {Cambridge, Cricket, IPV}) which were the result of the query.

### Focused Queries

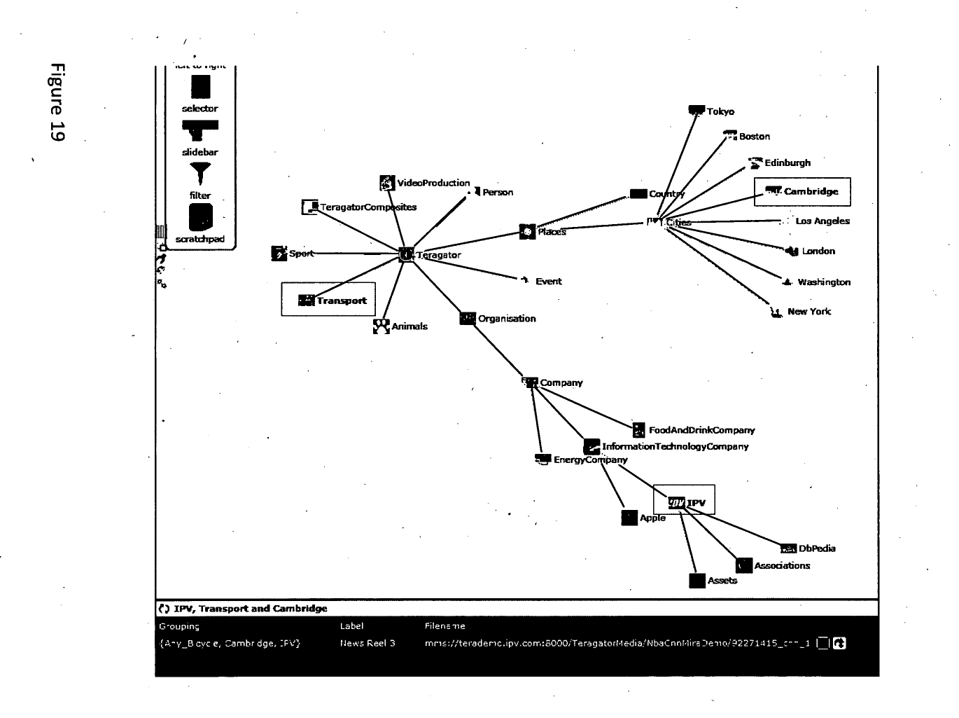

As with free-text searches, the more focused the query, the more precise is the result. FIG. 19 shows a query involving the precise name of two individuals in the ontology (IPV and Cambridge) coupled with a broad search term (Transport), resulting in the single result {Any_Bicycle, Cambridge, IPV}.

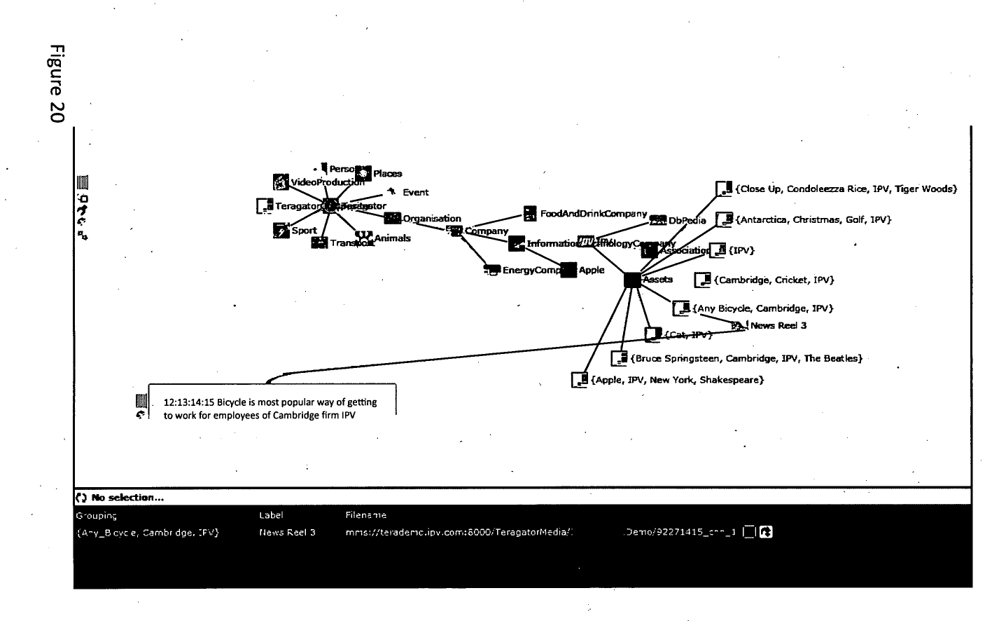

FIG. 20 shows the textual annotation that was mined to result in the composition {Any_Bicycle, Cambridge, IPV} which was the result of the query.

### Appendix 1 References

[1] Resource Description Framework (RDF): Concepts and Abstract Syntax, Klyne G., Carroll J. (Editors), W3C Recommendation, 10 Feb. 2004.
[2] http://www.w3.org/TR/PR-rdf-syntax/ “Resource Description Framework (RDF) Model and Syntax Specification”
[3] OWL 2 Web Ontology Language: Quick Reference Guide Jie Bao, Elisa F. Kendall, Deborah L. McGuinness, Peter F. Patel-Schneider, eds. W3C Recommendation, 27 Oct. 2009, http://www.w3.org/TR/2009/REC-owl2-quick-reference-20091027/

### Appendix 2—Ontology Based Resource Mining and Display

This Appendix 2 describes the method used by Teragator to discover resources in a dataset. The methods are based on the use of a world-model in the form of an ontology that describes the resources that are required to be found.

### Method—Ontology Construction and Publishing

<!--

http://ipv.com/teragator/development/ontologies/MediaAssetSingleton/
ontology.owl#Places -->

<owl:Class rdf:about=“#Places”>

<rdfs:subClassOf rdf:resource=“#MediaConcept”/>

</owl:Class>
<!--

http://ipv.com/teragator/development/ontologies/MediaAssetSingleton/
ontology.owl#Country -->

<owl:Class rdf:about=“#Country”>

<rdfs:subClassOf rdf:resource=“#Places”/>

</owl:Class>
<!--

http://ipv.com/teragator/development/ontologies/MediaAssetSingleton/
ontology.owl#Cities -->

<owl:Class rdf:about=“#Cities”>

<rdfs:subClassOf rdf:resource=“#Places”/>

</owl:Class>
<!--

http://ipv.com/teragator/development/ontologies/MediaAssetSingleton/
ontology.owl#New_York -->

<owl:Thing rdf:about=“#New_York”>

<rdf:type rdf:resource=“#Cities”/>
<hasAlias>The Big Apple</hasAlias>
<hasAlias>New York</hasAlias>

</owl:Thing>

Teragator defines an ontology for each way in which a dataset can be mined in order to discover resources from metadata. For example the same dataset could be mined using a ‘basketball’ ontology which would discover players, coaches, teams, etc, and from a ‘popular music’ ontology which would find musicians, orchestras, genres, etc. The ontology builds in the idea that a single resource may be referred to in many ways which would be impossible to resolve without the use of a dictionary, or similar pre-existing model (unlike spelling mistakes for which algorithms exist to determine the intended text). An example, shown in the above snippet of OWL0 ontology code describes ‘New York’ as belonging to the class of ‘Cities’, which is a subclass of ‘Places’, which is a subclass of the parent ‘MediaConcept’ class. ‘New York’ has an alias of ‘The Big Apple’ which means that the mining process can correctly discover a ‘New York’ resource even if it is referred to as ‘The Big Apple’.

### Dataset Processing

Use the ‘hasAlias’ data property and regular expressions to mine resources.

<owl:Thing rdf:about=“#New_York”>

```
  <rdf:type rdf:resource=“#Cities”/>
  <hasAlias>The Big Apple</hasAlias>
  <hasAlias>New York</hasAlias>
```

</owl:Thing
//------------------------------------------------------------------------------
private static List<string> mineIndividualsFromTextUsingRegex(string
textForMining,

Dictionary<string, List<string>>

ontologyElementNameToAliasesMap)
{

List<string> individualOntologyElementNames = new
List<string>( );
foreach (KeyValuePair<string, List<string>> kv in

ontologyElementNameToAliasesMap)

{

foreach (string alias in kv.Value)
{

if (!TheAliasToRegexMap.ContainsKey(alias))
{

TheAliasToRegexMap.Add(alias,
getPluralRegexs(alias));

}

if
(TheAliasToRegexMap[alias].IsMatch(textForMining))
{
individualOntologyElementNames.Add(kv.Key);
}

}

}
return individualOntologyElementNames;

}

The above code illustrates the use of the ‘hasAlias’ data property. All the aliases for the active ontology are pre-loaded into a list and regexs of them computed. A text item is processed by finding matches with all such regexs and storing the corresponding alias in a list.

### Use a Dictionary to Disambiguate Word Sense and Find the Correct Ontology.

//------------------------------------------------------------------------------
private static OntologyFramework FindOntology(List<string>
individualOntologyElementNames)
{

Dictionary<string, List<string>> TheWordToGlosslistMap

= new Dictionary<string, List<string>>( );

Dictionary<string, OntologyFramework> TheGlossToOntologyMap

= new Dictionary<string, OntologyFramework>( );

Dictionary<string, int> TheGlossToCountMap

= new Dictionary<string, int>( );

foreach(string individualOntologyElementName in

individualOntologyElementNames)

{

List<string> glosses =

TheWordToGlosslistMap[individualOntologyElementName];

foreach(string gloss in glosses)
{

TheGlossToCountMap[gloss]++;

}

}
string bestGlossMatch

= TheGlossToCountMap
.OrderByDescending(kv => kv.Value)
.Select(kv => kv.Key).First( );

return TheGlossToOntologyMap[bestGlossMatch];

}

The alias ‘The Big Apple’ could refer to New York or to an impressively-proportioned fruit so we need to determine the correct sense of the alias. This is done by using the concept of a gloss which is a particular definition of a sense of a word. ‘The Big Apple’ has two glosses—‘Proper name of a place’ and ‘Noun phrase involving the proper name of a Fruit’. The alias is assigned the sense whose gloss shares the largest number of words in common with the glosses of other words in the text being processed. When the correct gloss is found the correct ontology can then be looked up.

Use the Disambiguated ‘hasAlias’ Value to Find the Correct Ontology Element.

//------------------------------------------------------------------------------
public static OntologyElement GetOntologyElementFromAlias(string alias)
{

foreach (OntologyFramework activeOntologyFramework in

TheActiveOntologyFrameworks.Values)

{

if (activeOntologyFramework
.TheIndividualAliasToOntologyElementMap
.ContainsKey(alias))
{

return

activeOntologyFramework.TheIndividualAliasToOntologyElementMap
[alias];

}

}
return null;

}

The previous step finds the ontology into which the discovered text item is most likely to fit. Once we know this text item, or alias, is likely to refer to the ontology which we are using to mine the data (for example, a ‘places’ ontology rather than a ‘foods’ ontology) the final step is just to determine the ontology element (the ‘Individual’ in OWL) that the alias refers to, and this is done by a simple lookup operation in a dictionary of alias-to-ontology elements.

### Resource Linkage and Storage.

//------------------------------------------------------------------------------
public static RdfsClass LinkNewWithKnownResource(SchemaGraph
graph,

RdfsClass rdfResource1,
string predicate12,
string resourceUri2,
string className2,
string label2,
UriRef superclass2)

{

```
RdfsClass rdfResource2;
UriRef resource2;
if (TheONameToNQuirerMap.ContainsKey(resourceUri2))
{
// link resource 2 to resource 1
SchemaGraph lookupGraph =
TheONameToNQuirerMap[resourceUri2];
  rdfResource2 = lookupGraph.TheLinkNodes[resourceUri2];
  resource2 = rdfResource2.TheRdfSubject;
  if (!graph.TheLinkNodes.ContainsKey(resourceUri2))
  {
graph.TheLinkNodes.Add(resourceUri2, rdfResource2);
}
}
else
{
// create resource2 and liink to resource 1
rdfResource2
= (RdfsClass)graph.CreateRdfsNodeFromClassNameAndUri
(className2, resourceUri2, superclass2);
rdfResource2.SetPropertyDistinctLiteralValue
((UriRef)(TeragatorNames.TheRdfslabelPredicate),
```

(Literal)label2);

graph.TheLinkNodes.Add(resourceUri2, rdfResource2);
resource2 = rdfResource2.TheRdfSubject;
// update the aggregation map
TheONameToNQuirerMap.Add(resourceUri2, graph);
}
if ((null != rdfResource1) && (null != predicate12))
{
RdfResource1.SetPropertyDistinctUriRefValue((UriRef)

predicate12, resource2);

}
return rdfResource2;

}

As resources are discovered they are linked to their parent resources which are created if they do not already exist. So, for example, if no ‘Places’ have been found prior to ‘The Big Apple’ being discovered then a ‘Places’ resource is created. Other examples of ‘Places’ such as ‘Cambridge’ and ‘London’ are linked to this resource as they are found.

### Resource Instantiation.

private RdfsClass linkParentToChild

(SchemaGraph graph, OntologyElement parent, OntologyElement child)

{

RdfsClass node

= ResourceAggregator.LinkNewWithKnownResource

| | |
|---|---|
| (graph, | // SchemaGraph |

| | |
|---|---|
| null, | // rdfsNode |
| null, | // predicate |
| parent.TheOName, | // oname |
| parent.TheClass.TheOName, | // className |
| CoolUri.GetLocalName(parent.TheOName), | // label |
| null); | // (UriRef) |

superclass

if (null != child)
{

ResourceAggregator.LinkNewWithKnownResource

| | |
|---|---|
| (graph, | // SchemaGraph |

| | |
|---|---|
| node, | // rdfsNode |

TeragatorNames.TheHasMemberPredicate.TheStringRepresentation, // predicate

| | |
|---|---|
| child.TheOName, | // oname |
| child.TheClass.TheOName, | // className |
| CoolUri.GetLocalName(child.TheOName), | // label |
| null); | // (UriRef) |

superclass

}
return node;

}
public void InstantiateOntologyBranch(SchemaGraph graph, OntologyElement child)
{

RdfsClass thisNode = linkParentToChild(graph, this, child);
if (this.IsInstantiated == false)
{

this.IsInstantiated = true;
if(this.TheClass.TheOName

!=

OntologyNamespaces.MediaAssetSingletonNamespace.NamespaceName + “Root”)

{

this.TheClass.InstantiateOntologyBranch(graph, this );

}
else
{

RdfsClass teragator

= ResourceAggregator.GetResourceFromOname

(TeragatorNames.TheTeragatorResource.TheStringRepresentation);

teragator.SetPropertyDistinctUriRefValue

(TeragatorNames.TheHasMemberPredicate,

thisNode.TheRdfSubject);

}

}

}

A Branch of ontology is not shown in the visualisation until resources that are related to that branch is discovered. So, for example, the Places→Cities resource nodes are not seen until a terminal such as ‘New York’ is found.

### Composite Resources

During the metadata mining process a graph is built in the triplestore that represents the straightforward ontology that underpins Teragator, for example, the place ‘New York’ is inserted into the ontology as:
Teragator→Places→Cities→New York’.

During the metadata mining process, as ontology elements (IPV and Shakespeare and New York) are discovered in a semantic relationship for the first time (they are connected in some way in the metadata, for example a text string contains all three terms in the same context), a new resource is created that represents the fact that IPV and Shakespeare and New York are in some way linked, and are present in an asset.

In the visualisation this composite resource is called a composition and has the following properties:
Each composition links to one or more assets.
Each composition links to the participants (the resource nodes in the ontology that represent the individuals).

As more assets are found that have the same composition {IPV, Shakespeare, New York} they are added to the

{IPV, Shakespeare, New York} composite resource.

Every node in the ontology graph connects both to subcategories in the ontology, as described, and to all the compositions that relate to this ontology node. So, for example, the ‘Places’ node in the ontology links to all the Places-related clips, including {IPV, Shakespeare, New York}, which in turn link to the physical assets, as will the ‘InformationTechnologyCompany’ node, and the nodes for IPV and New York themselves. Thus, at any node, we can navigate to the next level in a top-down or bottom-up fashion, by following subcategories or clips.

The assets need to be linked to the compositions that describe them. In the current example the composition, {IPV, Shakespeare, New York} is derived from an asset “News Reel 4”. The asset has timecode-delimited chunks of textual metadata as follows: —
00:01:02:03 A survey found that a cat is the most popular pet for IPV employees
00:05:06:07 The Beatles and Bruce Springsteen are most listened-to popular musicians at Cambridge company IPV
08:09:10:11 IPV to promote Shakespeare festival in The Big Apple
12:13:14:15 Laurel and Hardy film is highlight of Cambridge film festival

The resource mining process chunks the text using timecodes (strings of the form aa:bb:cc:dd) and treats each as a separate asset. The asset that is described by the composition {IPV, Shakespeare, New York} is:—
IPV to promote Shakespeare festival in The Big Apple

### The Mining Process, Step-by-Step.

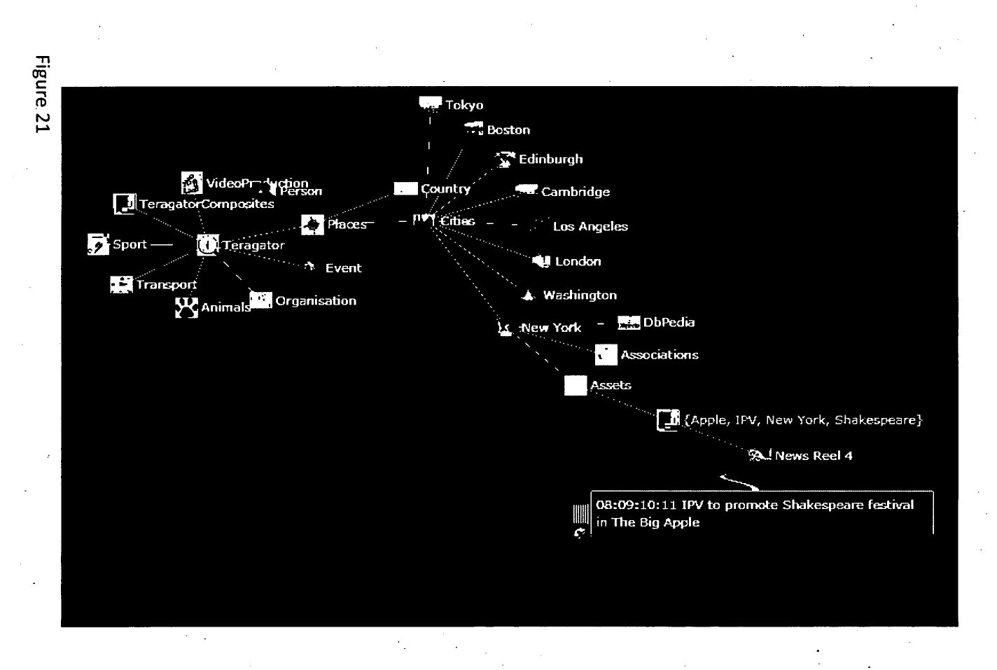

FIG. 21 shows the result of the process described in the preceding sections. Working bottom-up from the text that is associated with the asset ‘News Reel 4’.
1. The timecode-delimited text associated with ‘News Reel 4’ is parsed to find chunks which represent media clips which we treat as the real assets of interest.
2. Within each chunk the text is mined using a particular ontology to see if any aliases of individual ontology elements are present. The aliases ‘IPV’, ‘Shakespeare’, and ‘The Big Apple’ are discovered.
3. The senses of the aliases are analysed to determine if they are likely to belong to the ontology we are using for mining.
4. The analysis shows that ‘IPV’, ‘Shakespeare’, and ‘The Big Apple’ are more likely to refer to the ontology that we are using (news and current affairs) than any other (for example foodstuffs), so processing continues. If the analysis showed that this was not the case then the current results would be discarded, the next item in the data set would be obtained, and we return to step 1.
5. A virtual ‘Composition’ resource is created that represents the linkage of the concepts of ‘IPV’, ‘Shakespeare’, and ‘New York’.
6. The asset ‘08:09:10:11 IPV to promote Shakespeare festival in The Big Apple’ from ‘News Reel 4’ is linked to this composition.
7. The ontology elements ‘IPV’, ‘Shakespeare’, and ‘New York’ are instantiated; this results in the branches to which they belong becoming visible, i.e., Organisation . . . , People . . . and Places.
8. The composition {IPV, Shakespeare, New York} is linked to the resources ‘IPV’, ‘Shakespeare’, and ‘New York’.

### Appendix 2—References.

[1] Resource Description Framework (RDF): Concepts and Abstract Syntax, Klyne G., Carroll J. (Editors), W3C Recommendation, 10 Feb. 2004.
[2] http://www.w3.org/TR/PR-rdf-syntax/ “Resource Description Framework (RDF) Model and Syntax Specification”
[3] OWL 2 Web Ontology Language: Quick Reference Guide Jie Bao, Elisa F. Kendall, Deborah L. McGuinness, Peter F. Patel-Schneider, eds. W3C Recommendation, 27 Oct. 2009, http://www.w3.org/TR/2009/REC-owl2-quick-reference-20091027/

### Appendix 3—Styling RDF

This Appendix 3 is a description of the proposed mechanism for information sharing between Teragator client and servers with the purpose of improving the display of RDF [1], [2] data.

What it does.

It allows the Teragator server to exercise limited control over the display of information transmitted to the Teragator browse client. The main problems the mechanism addresses are:—
Without such a mechanism, the client has no idea of the meaning of the data with which it is presented. It cannot make any decision, based on the data alone, of how to embellish the display of that data without extra ‘meta-metadata’ being provided. It does, however, know about its own capabilities as regards processing and display.
Without such a mechanism, the server has no idea of how to tell the client to embellish data, nor of what kinds of embellishment are possible. It does, however, know to a certain extent what the data means, and in a general way, how it should be rendered.

### How it Works.

The client is regarded as ‘dumb’ with respect to the meaning of the data with which it is presented—it does not try and interpret data to make sense of it in order to put on a better show. Instead, the client informs the server of the kinds of operations of which it is capable, and the server matches the kind of display effect that is required, with the effects that are offered by the client, and issues commands accordingly.

To accomplish this Teragator defines a clientCapability namespace (or RDF schema) that is used to build resources that store information specific to each particular client implementation (there is probably also a minimal ‘vanilla’ resource for clients that we don't know about). The implementer of the client is responsible for providing all the information that is used to build this resource.

The client defines a small set of highly encoded functions (highly encoded in the sense that one function may imply a complex sequence of actions in the client engine) and registers these with the server. This is done just once when a new client is created. Then, for each service call, the server invokes the function that best matches the required result. Considerable flexibility can still be had, however, by using regular expressions to decide where and how the functions are applied, as described later.

Client Registers its Capabilities with Server Using a Client Capability Ontology.

The first step is for a new client to provide a resource that tells the server what it (the client) can do. As is the case with all resources within Teragator it takes the form of RDF. Client capabilities are defined by an ontology represented as an OWL XML file. This file is published by the client as a web resource that can be read by the server, enabling it to understand how to communicate with the client.

```
<!-- Data properties -->
  <owl:DatatypeProperty rdf:about=“#hasCapabilityString”>
    <rdfs:domain rdf:resource=“#ClientCapability”/>
    <rdfs:range rdf:resource=“&xsd;string”/>
  </owl:DatatypeProperty>
  <owl:DatatypeProperty rdf:about=“#hasDescription”>
    <rdfs:domain rdf:resource=“#ClientCapability”/>
    <rdfs:range rdf:resource=“&xsd;string”/>
  </owl:DatatypeProperty>
  <!-- Classes -->
  <owl:Class rdf:about=“#ClientCapability”/>
  <!-- Individuals -->
  <ClientCapability rdf:about=“#canProjectObjectAsDateTime”>
    <rdf:type rdf:resource=“&owl;Thing”/>
    <hasCapabilityString>canProjectObjectAsDateTime
    </hasCapabilityString>
    <hasDescription> This capability applies to an RDF resource which is
rendered on screen as a node in a
      hierarchy. The RDFsubject (the resource node) in the triple that is
selected using the WhereLambda string operating on the predicate, is
projected onto an n-dimensional surface in the visualisation space using
the value of the RDF object in the same triple as a scalar quantity that
defines the projected position of the node. A logical axis is created for
every predicate selected in this way. An actual axis on the surface is only
created if there are visible nodes that are described by this predicate.
The object is a string that represents a date and time. The client is
responsible for parsing the string to determine the format (no hints are
      given).</hasDescription>
  </ClientCapability>
  <owl:Thing rdf:about=“#canProjectObjectAsInteger”>
    <hasCapabilityString>canProjectObjectAsInteger
    </hasCapabilityString>
    <hasDescription>This capability applies to an RDF resource which is
rendered on screen as a node in a hierarchy. The RDFsubject (the resource
node) in the triple that is selected using the WhereLambda string operating
on the predicate, can
      be projected onto an n-dimensional surface in the visualisation
space using the value of the RDF object in the same triple as a scalar
quantity that defines the projected position of the node. A logical axis is
created for every predicate selected in this way. An actual axis on the
surface is only created if there are visible nodes that are described by
this predicate. The object is a string that represents an integer.
</hasDescription>
  </owl:Thing>
  <ClientCapability rdf:about=“#canUseObjectAsNodeDetail”>
    <rdf:type rdf:resource=“&owl;Thing”/>
    <hasDescription>This capability applies to an RDF resource which is
rendered on screen as a node in a hierarchy. The value of the RDF object
in the triple that is selected using the WhereLambda string operating on
the predicate, can be used as additional descriptive text for the node.
</hasDescription>
    <hasCapabilityString>canUseObjectAsNodeDetail
    </hasCapabilityString>
  </ClientCapability>
  <owl:Thing rdf:about=“#canUseObjectAsNodeIcon”>
    <rdf:type rdf:resource=“#ClientCapability”/>
    <hasCapabilityString>canUseObjectAsNodeIcon
    </hasCapabilityString>
    <hasDescription>This capability applies to an RDF resource which is
rendered on screen as a node in a hierarchy. The value of the RDF object
in the triple that is selected using the WhereLambda string operating on
the predicate, can be used as the parameter in the &#39;GetImage&#39;
querystring to the Teragator server. The returned image can be used to
represent the node.</hasDescription>
  </owl:Thing>
  <ClientCapability rdf:about=“#canUseObjectAsNodeLabel”>
    <rdf:type rdf:resource=“&owl;Thing”/>
    <hasCapabilityString>canUseObjectAsNodeLabel
    </hasCapabilityString>
    <hasDescription>This capability applies to an RDF resource which is
rendered on screen as a node in a hierarchy. The value of the RDF object
in the triple that is selected using the WhereLambda string operating on
the predicate, can be used as a textual label for the node.
</hasDescription>
  </ClientCapability>
  <ClientCapability rdf:about=“#canUsePredicateAsFacet”>
    <rdf:type rdf:resource=“&owl;Thing”/>
    <hasCapabilityString>canUsePredicateAsFacet</hasCapabilityString>
    <hasDescription>This capability applies to a set of RDF resources
which are rendered on screen as nodes in a hierarchy. The RDF predicate
in the triple that is selected using the WhereLambda string operating on
the predicate describes nodes that potentially are included in the
visualisation. The client provides means (eg list selection) for the user
to select or de-select predicates which, in turn, cause sub-trees (or
facets) of the mesh to be switched on or off.</hasDescription>
  </ClientCapability>
  <owl:Thing rdf:about=“#objectIsComposition”>
    <rdf:type rdf:resource=“#ClientCapability”/>
    <hasCapabilityString>objectIsComposition</hasCapabilityString>
    <hasDescription>This capability applies to an RDF resource which is
rendered on screen as a node in a hierarchy. The value of the RDF object
in the triple that is selected using the WhereLambda string operating on
the predicate, is a composite which is a list of resources that are linked
to this node.</hasDescription>
  </owl:Thing>
  <owl:Thing rdf:about=“#objectIsPlayableAsset”>
    <hasCapabilityString>objectIsPlayableAsset</hasCapabilityString>
    <hasDescription>This capability applies to an RDF resource which is
rendered on screen as a node in a hierarchy. The value of the RDF object
in the triple that is selected using the WhereLambda string operating on
the predicate, represents video, audio, graphics or some other object that
can be viewed, or played.</hasDescription>
  </owl:Thing>
  <owl:Thing rdf:about=“#objectIsUrlOfPlayableAsset”>
    <hasDescription>This capability applies to an RDF resource which is
rendered on screen as a node in a hierarchy. The value of the RDF object
in the triple that is selected using the WhereLambda string operating on
the predicate, is the Url of a playable asset.</hasDescription>
    <hasCapabilityString>objectIsUrlOfPlayableAsset
    </hasCapabilityString>
  </owl:Thing
```

A typical resource made with this ontology may look like:—
ce:displaySet0 cc:usesCapability acme:canUseObjectAsNodeIcon

Where the namespace cc is:

”http://ipv.com/teragator/development/schemas/callContext# #”, and acme
is ”
“http://ipv.com/teragator/development/ontologies/Client/acme_0.1#”.

This means that whenever the client sees the string “canUseObjectAsNodeIcon” associated with an RDF object it would make sense to use that text to find an icon with which to represent the node. The detail of how this is done is entirely up to the client. The means by which the server finds and uses the client capability ontology is outside the scope of this document.

The client is free to register as many capabilities as it wants. The example ontology shown above demonstrates a minimal set, as follows: —

### Node Rendering Capabilities

These make the rendition of a resource on screen look tidy, attractive and comprehensible.
cc:myClient cc:hasCapability acme: canUseObjectAsNodeIcon
   means “this text is the name of an icon”;
cc:myClient cc:hasCapability acme: canUseObjectAsNodeLabel
   means “this text is a human-friendly name of a resource”;
cc:myClient cc:hasCapability acme: objectIsComposition
   means “this text is descrobes a special type of resource made up of other resources”;
cc:myClient cc:hasCapability acme: canUseObjectAsNodeDetail
   means “this text is a detailed description of the node, and possibly quite long, and typically should be rendered in a separate pane when the resource node is clicked”;

### Graph Presentation Capabilities

These affect entire sub-graphs.

cc:myClient cc:hasCapability acme: canUsePredicateAsFacet

means “this predicate describes a particular view of the information provided in the graph”;

### Asset Preview Capabilities

These apply to resources that describe playable assets, that is, some other application or plug-in can be invoked on the resource (typically media of some sort) to view, or play it.
cc:myClient cc:hasCapability acme: objectIsPlayableAsset
   means “this represents something that can be played”;
cc:myClient cc:hasCapability acme: objectIsUrlOfPlayableAsset
   means “this text is the URL of something that can be played”;

### Projection Capabilities

Resources may contain numerical data such as dates, heights, time spans, etc. These capabilities allow the client to project these quantities onto a geometrical surface in order to visualise the data.
ccr:myClient cc:hasCapability acme:canProjectObjectAsDateTime
   means “this is a date/time quantity”;
cc:myClient cc:hasCapability acme: canProjectObjectAsInteger
   means “this is an integer quantity”;

The next section describes how these capability strings are associated with an RDF component.

### Server Returns a ‘CallContext’ Graph With Each Reply.

Teragator defines a callContext namespace (or RDF schema) that is used to build small, dynamic callContext graphs that are returned with the browse triples in a service request. This graph describes how the server wants particular aspects of the data to be displayed. The precise mechanism for layout and rendering, however, is the responsibility of the client.

The server needs to tell the client which pieces of RDF to operate on, and with which capability. It does this by building a graph using the following schema:—

```
<!-- callContext Class -->
    <rdfs:Class rdf:about=“#callContext”>
        <rdfs:isDefinedBy
rdf:resource=“http://ipv.com/teragator/development/schemas/
callContext”/>
        <rdfs:label>callContext</rdfs:label>
        <rdfs:comment>A dynamic per-call resource that provides
extra information about the returned data</rdfs:comment>
        <rdfs:subClassOf rdf:resource=“http://www.w3.org/2000/01/rdf-
schema#Resource”/>
    </rdfs:Class>
    <!-- callContext properties -->
    <rdf:Property rdf:about=“http://www.w3.org/2000/01/rdf-
    schema#label”>
        <rdfs:isDefinedBy
rdf:resource=“http://ipv.com/teragator/development/schemas/
callContext”/>
        <rdfs:label>Label</rdfs:label>
        <rdfs:comment>Human-friendly textual
        description</rdfs:comment>
        <rdfs:domain rdf:resource=“#callContext”/>
        <rdfs:range rdf:resource=“rdfs:Literal”/>
    </rdf:Property>
    <rdf:Property rdf:about=“#hasDateTime”>
        <rdfs:isDefinedBy
rdf:resource=“http://ipv.com/teragator/development/schemas/
callContext”/>
        <rdfs:label>DateTime</rdfs:label>
        <rdfs:comment>Date and time</rdfs:comment>
        <rdfs:domain rdf:resource=“#callContext”/>
        <rdfs:range rdf:resource=“rdfs:Literal”/>
    </rdf:Property>
    <rdf:Property rdf:about=“#hasCallGuid”>
        <rdfs:isDefinedBy
rdf:resource=“http://ipv.com/teragator/development/schemas/
callContext”/>
        <rdfs:label>CallGuid</rdfs:label>
        <rdfs:comment>CallGuid</rdfs:comment>
        <rdfs:domain rdf:resource=“#callContext”/>
        <rdfs:range rdf:resource=“rdfs:Literal”/>
    </rdf:Property>
    <rdf:Property rdf:about=“#hasChunkMax”>
      <rdfs:isDefinedBy
rdf:resource=“http://ipv.com/teragator/development/schemas/
callContext”/>
      <rdfs:label>ChunkMax</rdfs:label>
      <rdfs:comment>ChunkMax</rdfs:comment>
      <rdfs:domain rdf:resource=“#callContext”/>
      <rdfs:range rdf:resource=“rdfs:Literal”/>
    </rdf:Property>
    <rdf:Property rdf:about=“#hasChunkSequenceNumber”>
      <rdfs:isDefinedBy
rdf:resource=“http://ipv.com/teragator/development/schemas/
callContext”/>
      <rdfs:label>ChunkSequenceNumber</rdfs:label>
      <rdfs:comment>ChunkSequenceNumber</rdfs:comment>
      <rdfs:domain rdf:resource=“#callContext”/>
      <rdfs:range rdf:resource=“rdfs:Literal”/>
    </rdf:Property>
    <rdf:Property rdf:about=“#hasDisplayset”>
        <rdfs:isDefinedBy
rdf:resource=“http://ipv.com/teragator/development/schemas/
callContext”/>
        <rdfs:label>Display Set</rdfs:label>
        <rdfs:comment>A way of associating a capability with a
match</rdfs:comment>
        <rdfs:domain rdf:resource=“#callContext”/>
        <rdfs:range rdf:resource=“rdfs:Resource”/>
    </rdf:Property>
  <rdf:Property rdf:about=“#hasTriplestore”>
    <rdfs:isDefinedBy
rdf:resource=“http://ipv.com/teragator/development/schemas/
callContext”/>
    <rdfs:label>Triplestore</rdfs:label>
    <rdfs:comment>A triplestore that is visible to this
    session</rdfs:comment>
    <rdfs:domain rdf:resource=“#callContext”/>
    <rdfs:range rdf:resource=“rdfs:Resource”/>
  </rdf:Property>
```

And a typical graph under this schema may look like:—

cc:callContext cc:hasallGuid “f3188fd3-61da-4c28-beaf-879ca2357d1a”

| | |
|---|---|
| cc:callContext cc:hasDateTime | “08/04/2010 13:36:11” |
| cc:callContext cc:hasChunkMax | “32” |
| cc:callContext cc:hasChunkSequenceNumber | “15” |
| cc:callContext cc:hasDisplaySet | “displaySet1” |
| cc:callContext cc:hasDisplaySet | “displaySet2” |

Where the namespace cc is “http://ipv.com/teragator/development/schemas/callContext#”

This just means (apart from the obvious housekeeping stuff) “look for resources called displayset1 and displayset2”.

### Use DisplaySets to Select and Process Rdf Data for Display.

The “displaySet” resource is a way of associating a capability with a match: the match selects a set of RDF components and the capability is applied to this set. A displaySet resource is a graph with the following schema:—

```
    <!-- displayset Class -->
    <rdfs:Class rdf:about=“#displayset”>
        <rdfs:isDefinedBy
rdf:resource=“http://ipv.com/teragator/development/schemas/
callContext”/>
        <rdfs:label>displayset</rdfs:label>
        <rdfs:comment>A way associating a capability with a
        match</rdfs:comment>
        <rdfs:subClassOf rdf:resource=“http://www.w3.org/2000/01/rdf-
schema#Resource”/>
    </rdfs:Class>
    <!-- displayset properties -->
    <rdf:Property rdf:about=“#hasLabel”>
        <rdfs:isDefinedBy
rdf:resource=“http://ipv.com/teragator/development/schemas/
callContext”/>
        <rdfs:label>Label</rdfs:label>
        <rdfs:comment>Human-friendly textual
        description</rdfs:comment>
        <rdfs:domain rdf:resource=“#displayset”/>
        <rdfs:range rdf:resource=“rdfs:Literal”/>
    </rdf:Property>
    <rdf:Property rdf:about=“#usesCapability”>
        <rdfs:isDefinedBy
rdf:resource=“http://ipv.com/teragator/development/schemas/
callContext”/>
        <rdfs:label>Capability</rdfs:label>
        <rdfs:comment>The URI of a resource that specifies a client
capability</rdfs:comment>
        <rdfs:domain rdf:resource=“#displayset”/>
        <rdfs:range rdf:resource=“rdfs:Resource”/>
    </rdf:Property>
    <rdf:Property rdf:about=“#usesWhereLambda”>
        <rdfs:isDefinedBy
rdf:resource=“http://ipv.com/teragator/development/schemas/
callContext”/>
        <rdfs:label>WhereLambda</rdfs:label>
        <rdfs:comment>A lambda expression, containing a regular
expession, that matches RDF components</rdfs:comment>
        <rdfs:domain rdf:resource=“#displayset”/>
        <rdfs:range rdf:resource=“rdfs:Literal”/>
    </rdf:Property>
```

And a typical graph under this schema may look like:—

displaySet1 cc:usesCapability “acme:canUseObjectAsNodeLabel”
displaySet1 cc:usesWhereLambda
“(p) => p.regEx(\hat{ }http://www.w3.org/2000/01/rdf-schema#label)”

This means “use the regular expression to select all . . . #label predicates and apply the canUseObjectAsNodeLabel capability to them which applies a human-friendly label to the node. Similarly, displaySet2 could be used to identify icons, as follows:—

displaySet2 cc:usesCapability “acme: canUseObjectAsNodeIcon”
displaySet2 cc:usesWhereLambda
“(p) =>
p.regEx(\hat{ }http://ipv.com/teragator/development/namespaces/
systemProperties#hasIcon)”

The intention is that this mechanism can be extended to cope with any and all requirements for adding “meta-metadata” (data that describes the RDF graph that, in turn, describes the resources we are visualising). A final point to note is that this scheme has the useful property that the callContext graph at no point connects to the actual data graph—there are no common resources—so one callContext graph may be recycled many times for different calls.

### Examples

### Example Dataset

This is a simple RDF graph which is used in the following examples to help explain how the system works.

| | | |
|---|---|---|
| t:cambridgeDoofers | rdf:type | t:team |
| t:cambridgeDoofers | t:hasText | “The Cambridge Doofers” |
| t:cambridgeDoofers | t:hasValue | t:fredBloggs |
| t:cambridgeDoofers | t:hasValue | t:bertSmith |
| t:fredBloggs | rdf:type | t:player |
| t:fredBloggs | t:hasDescription | “Fred Bloggs” |
| t:fredBloggs | t:clip | “c:\temp\clip1.wmv” |
| t:fredBloggs | t:picture | “c:\temp\fb.jpg” |
| t:bertSmith | rdf:type | t:player |
| t:bertSmith | t:hasDescription | “Bert Smith” |
| t:bertSmith | t:clip | “c:\temp\clip2.wmv” |
| t:bertSmith | t:picture | “c:\temp\bs.jpg” |

where xlmns:t=”http://ipv.com/teragator/schemas/test#” // test
vocabulary

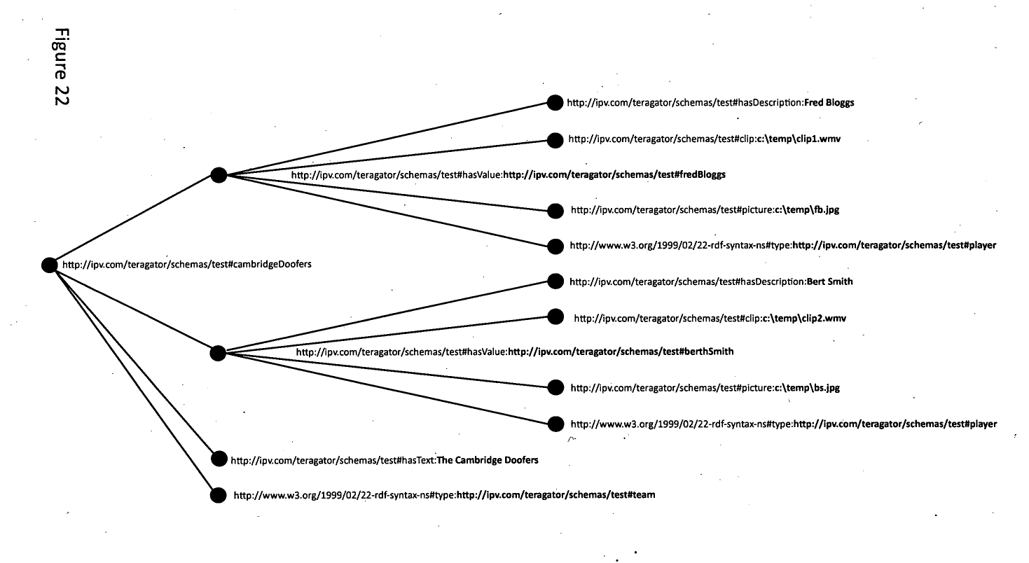

A simple-minded (and not very pretty) way of rendering this graph is shown below in FIG. 22 (the predicates are drawn in lighter text). From this it is clear that some method of styling the RDF for display is needed.

### Simple Example

### Promoting a Literal Text Label

This example shows the result of using the display sets described above to promote text and suppress unwanted system data (the rdf:type statement):—

| | |
|---|---|
| displaySet1 rdf:type | cx:displaySet |
| displaySet1 cx:hasLabel | “displaySet1” |
| displaySet1 cx:usesCapability | “canPromote” |
| displaySet1 cx:usesWhereLambda | “(p) => |
| | p.regEx(\hat{ }http://\S+#hasText)” |
| displaySet2 rdf:type | cx:displaySet |
| displaySet2 cx:hasLabel | “displaySet2” |
| displaySet2 cx:usesCapability | “canIgnore” |
| displaySet2 cx:usesWhereLambda | “(p) => |

p.regEx(\hat{ }http://www.w3.org/1999/02/22-rdf-syntax-ns#type”)”

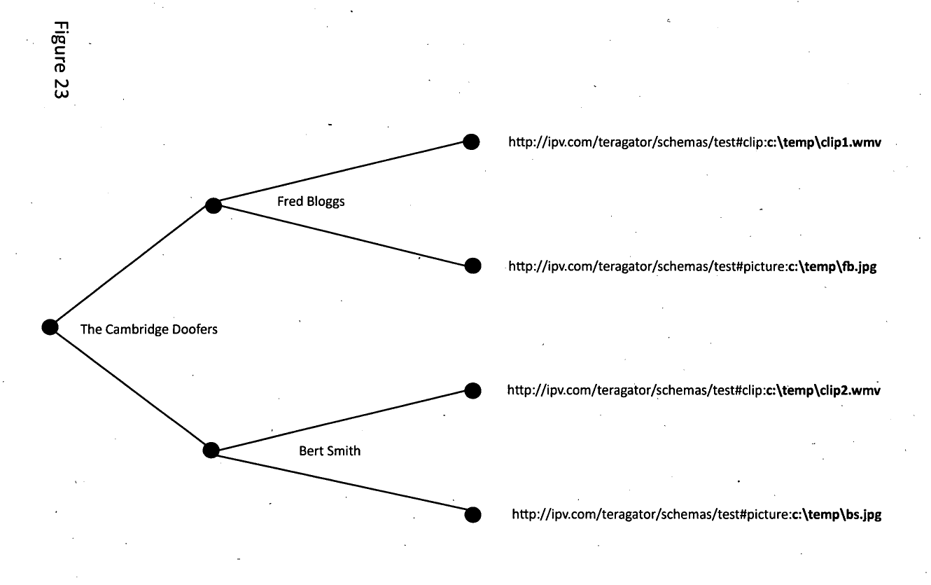

The resulting, much more comprehensible, rendering of the example RDF now looks like FIG. 23.

Using rdf:type Information.

Because the RDF generated by the Teragator server is strongly-typed, is RDF-schema aware (and will eventually support OWL which is based on RDF schemas) there is always an rdf:type predicate associated with an RDF node. Moreover, the literal string which is the value of the rdf:type property typically will be a human-friendly name chosen by an operator during acquisition of the original RDF. It may make sense to use this to aid display comprehension.

This can be done by adding the following displayset:—

| | |
|---|---|
| displaySet3 rdf:type | cx:displaySet |
| displaySet3 cx:hasLabel | “displaySet3” |
| displaySet3 cx:usesCapability | “canUseAsListWrapper” |
| displaySet3 cx:usesWhereLambda | “(p) => |

p.regEx(\hat{ }http://www.w3.org/1999/02/22-rdf-syntax-ns#type”)”

The service context graph now expresses extra information:—
The client can apply the “canUseAsListWrapper” methods to the matched subject nodes ( . . . #fredBloggs, . . . #bertSmith, and . . . #cambridgeDoofers). This has the effect of inserting a labelled ‘list’ node before all the child nodes of a given RDF class.
Note that the “canUseAsListWrapper” capability can use any predicate value (not just rdf:type) depending on the value of the “cx:usesWhereLambda” property value. Using rdf:type will usually make the most sense though.

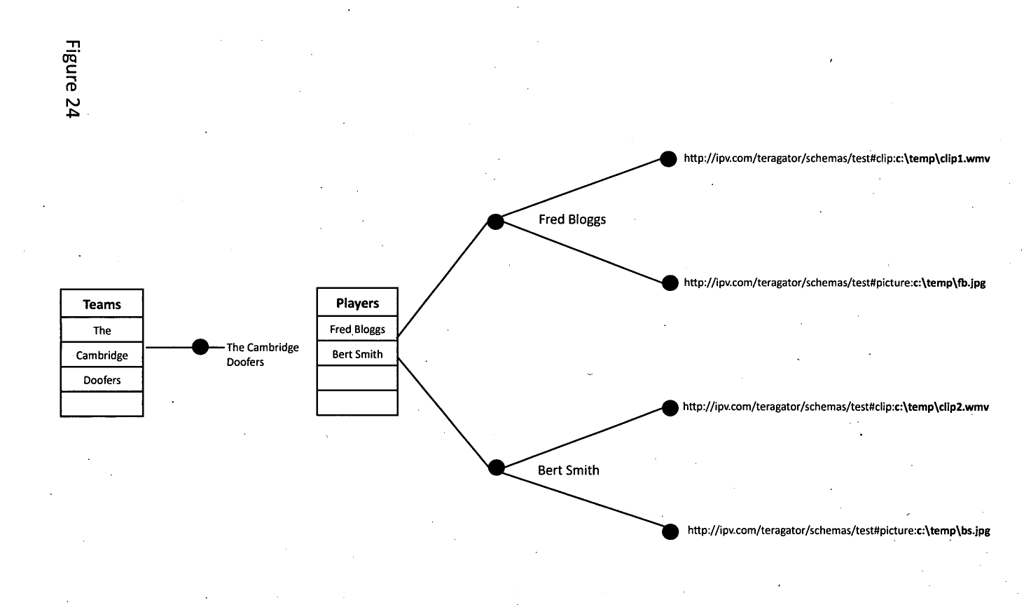

Assuming that the “canUseAsListWrapper” capability is understood to pluralise the class name to form the identifier, and to render whatever text is used as the child node identifier into the list icon, the rendering of the example RDF now looks like FIG. 24.

### Manipulating Images.

The mechanism can be used to control the display of images. The graphs below cause the content of the .jpg and .wmv to be used to embellish the display (assuming that the client knows a way of extracting thumbnails from these media file types):

| | |
|---|---|
| displaySet4 rdf:type | cx:displaySet |
| displaySet4 cx:hasLabel | “displaySet4” |
| displaySet4 cc:usesCapability | “canBeVisual” |
| displaySet4 cx:usesWhereLambda | “(o) => o.regEx(\hat{\hat{ }}“\hat{ }\S+.jpg\|png\| |
| | bmp)” |
| displaySet4 cx:usesWhereLambda | “(o) => o.regEx(\hat{ }“\hat{ }\S+.wmv\|mp4\| |
| | mov)” |

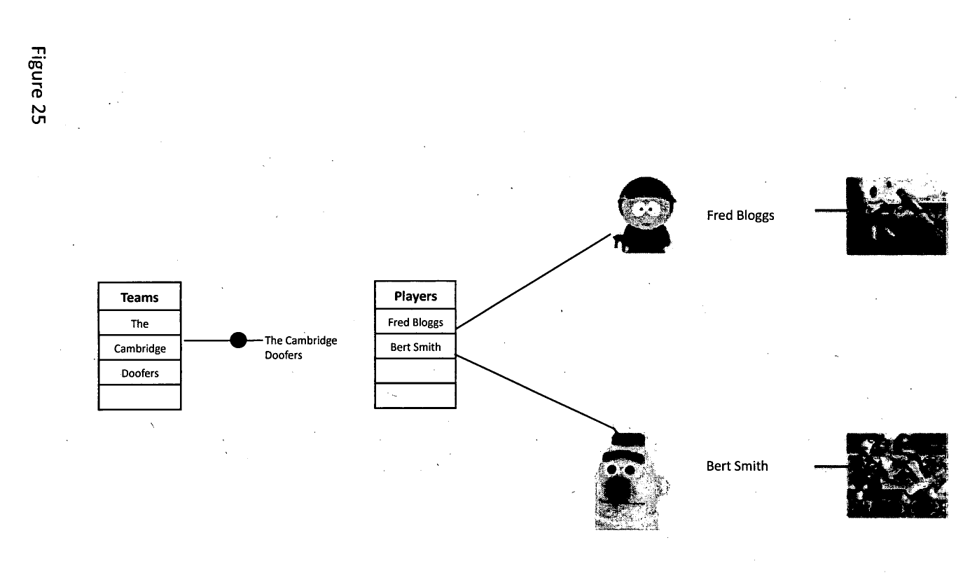

With a rendered result, FIG. 25

Embellishments.

Similarly, we can embellish or highlight other parts of the graph. The graphs below cause any predicate with a value of “<anything>Fred<anything>Bloggs<anything> to be highlighted 3 levels up the graph, starting at that value.

| | |
|---|---|
| displaySet5 rdf:type | cx:displaySet |
| displaySet5 cx:hasLabel | “displaySet5” |
| displaySet5 cc:usesCapability | “canHighlight3” |
| displaySet5 cx:usesWhereLambda | “\hat{ }.*Fred.*Bloggs.*” |

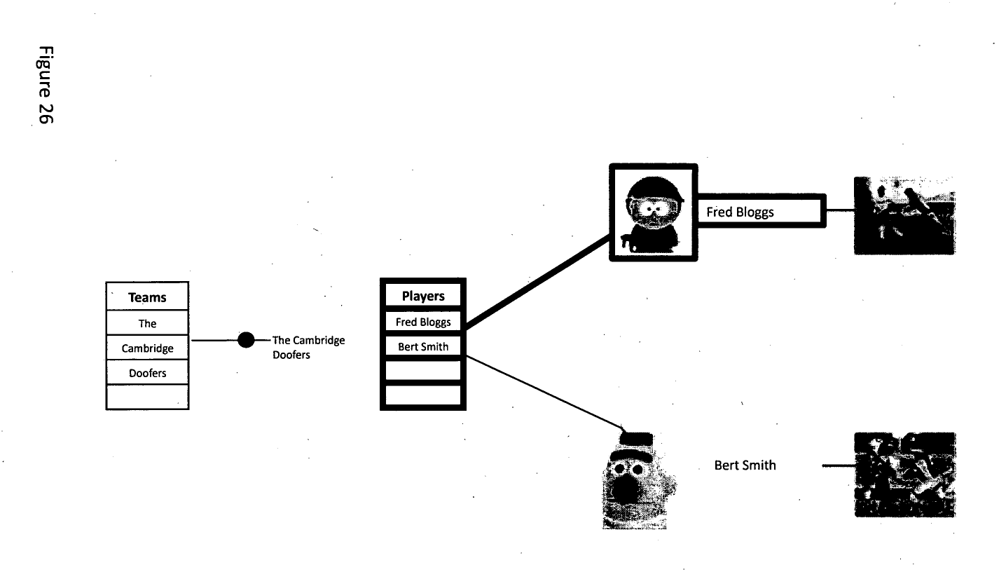

With a rendered result, FIG. 26.

### Appendix 3—Addendum—Server Response Example

The following is the response from a Teragator server to a client request that illustrates how call context is used in practice. To make the response compact the triples are encoded as three integers and a lookup table added to the response.

<?xml version=“1.0” encoding=“utf-8” ?>
- <root format=“full” xmlns:xsi=“http://www.w3.org/2001/XMLSchema-instance”
xmlns:xsd=“http://www.w3.org/2001/XMLSchema”>
- <triples>
<t s=“1” p=“2” o=“3” />
<t s=“1” p=“4” o=“5” />
<t s=“1” p=“4” o=“6” />
<t s=“1” p=“4” o=“7” />
<t s=“1” p=“4” o=“8” />
<t s=“1” p=“4” o=“9” />
<t s=“1” p=“4” o=“10” />
<t s=“1” p=“4” o=“11” />
<t s=“1” p=“12” o=“13” />
<t s=“5” p=“12” o=“14” />
<t s=“5” p=“2” o=“15” />
<t s=“6” p=“12” o=“16” />
<t s=“6” p=“2” o=“17” />
<t s=“7” p=“12” o=“18” />
<t s=“7” p=“2” o=“19” />
<t s=“8” p=“12” o=“20” />
<t s=“8” p=“2” o=“21” />
<t s=“9” p=“12” o=“22” />
<t s=“9” p=“2” o=“23” />
<t s=“10” p=“12” o=“24” />
<t s=“10” p=“2” o=“25” />
<t s=“11” p=“12” o=“26” />
<t s=“11” p=“2” o=“27” />
<t s=“28” p=“29” o=“30” />
<t s=“28” p=“31” o=“32” />
<t s=“28” p=“33” o=“34” />
<t s=“35” p=“29” o=“30” />
<t s=“35” p=“31” o=“36” />
<t s=“35” p=“33” o=“37” />
<t s=“38” p=“29” o=“30” />
<t s=“38” p=“31” o=“36” />
<t s=“38” p=“33” o=“39” />
<t s=“40” p=“29” o=“30” />
<t s=“40” p=“31” o=“41” />
<t s=“40” p=“33” o=“42” />
<t s=“43” p=“29” o=“30” />
<t s=“43” p=“31” o=“44” />
<t s=“43” p=“33” o=“45” />
<t s=“46” p=“29” o=“30” />
<t s=“46” p=“31” o=“47” />
<t s=“46” p=“33” o=“48” />
<t s=“49” p=“29” o=“30” />
<t s=“49” p=“31” o=“50” />
<t s=“49” p=“33” o=“51” />
<t s=“52” p=“29” o=“30” />
<t s=“52” p=“31” o=“50” />
<t s=“52” p=“33” o=“53” />
<t s=“54” p=“29” o=“30” />
<t s=“54” p=“31” o=“50” />
<t s=“54” p=“33” o=“55” />
<t s=“56” p=“29” o=“30” />
<t s=“56” p=“31” o=“57” />
<t s=“56” p=“33” o=“58” />
<t s=“59” p=“29” o=“30” />
<t s=“59” p=“31” o=“57” />
<t s=“59” p=“33” o=“42” />
<t s=“60” p=“29” o=“30” />
<t s=“60” p=“31” o=“57” />
<t s=“60” p=“33” o=“45” />
<t s=“61” p=“29” o=“30” />
<t s=“61” p=“31” o=“57” />
<t s=“61” p=“33” o=“62” />
<t s=“63” p=“29” o=“30” />
<t s=“63” p=“31” o=“57” />
<t s=“63” p=“33” o=“34” />
<t s=“64” p=“29” o=“30” />
<t s=“64” p=“31” o=“57” />
<t s=“64” p=“33” o=“51” />
<t s=“65” p=“29” o=“30” />
<t s=“65” p=“31” o=“66” />
<t s=“65” p=“33” o=“67” />
<t s=“68” p=“29” o=“30” />
<t s=“68” p=“31” o=“69” />
<t s=“68” p=“33” o=“70” />
<t s=“71” p=“29” o=“71” />
<t s=“71” p=“72” o=“73” />
<t s=“71” p=“74” o=“75” />
<t s=“71” p=“76” o=“77” />
<t s=“71” p=“78” o=“79” />
<t s=“71” p=“80” o=“81” />
<t s=“71” p=“80” o=“82” />
<t s=“71” p=“80” o=“83” />
<t s=“71” p=“80” o=“84” />
<t s=“71” p=“80” o=“85” />
<t s=“71” p=“80” o=“86” />
<t s=“71” p=“80” o=“87” />
<t s=“71” p=“80” o=“88” />
<t s=“71” p=“80” o=“89” />
<t s=“71” p=“80” o=“90” />
<t s=“71” p=“91” o=“28” />
<t s=“71” p=“91” o=“35” />
<t s=“71” p=“91” o=“38” />
<t s=“71” p=“91” o=“40” />
<t s=“71” p=“91” o=“43” />
<t s=“71” p=“91” o=“46” />
<t s=“71” p=“91” o=“49” />
<t s=“71” p=“91” o=“52” />
<t s=“71” p=“91” o=“54” />
<t s=“71” p=“91” o=“56” />
<t s=“71” p=“91” o=“59” />
<t s=“71” p=“91” o=“60” />
<t s=“71” p=“91” o=“61” />
<t s=“71” p=“91” o=“63” />
<t s=“71” p=“91” o=“64” />
<t s=“71” p=“91” o=“65” />
<t s=“71” p=“91” o=“68” />
</triples>
- <objects>
<o id=“1”
l=“http://ipv.com/teragator/development/ontologies/MediaAssetSingleton/ontology.owl#Person”
/>
<o id=“2”
l=“http://ipv.com/teragator/development/namespaces/systemProperties#hasIcon” />
<o id=“3” l=“MediaConcept/Person” />
<o id=“4”
l=“http://ipv.com/teragator/development/namespaces/systemProperties#hasMember” />
<o id=“5”
l=“http://ipv.com/teragator/development/ontologies/MediaAssetSingleton/ontology.owl#SportsPlayer”
/>
<o id=“6”
l=“http://ipv.com/teragator/development/ontologies/MediaAssetSingleton/ontology.owl#Musician”
/>
<o id=“7”
l=“http://ipv.com/teragator/development/ontologies/MediaAssetSingleton/ontology.owl#Actor”
/>
<o id=“8”
l=“http://ipv.com/teragator/development/ontologies/MediaAssetSingleton/ontology.owl#Politician”
/>
<o id=“9”
l=“http://ipv.com/teragator/development/ontologies/MediaAssetSingleton/ontology.owl#Model”
/>
<o id=“10”
l=“http://ipv.com/teragator/development/ontologies/MediaAssetSingleton/ontology.owl#RoyalFamily”
/>
<o id=“11”
l=“http://ipv.com/teragator/development/ontologies/MediaAssetSingleton/ontology.owl#HistoricFigures”
/>
<o id=“12” l=“http://www.w3.org/2000/01/rdf-schema#label” />
<o id=“13” l=“Person” />
<o id=“14” l=“SportsPlayer” />
<o id=“15” l=“MediaConcept/Person/SportsPlayer” />
<o id=“16” l=“Musician” />
<o id=“17” l=“MediaConcept/Person/Musician” />
<o id=“18” l=“Actor” />
<o id=“19” l=“MediaConcept/Person/Actor” />
<o id=“20” l=“Politician” />
<o id=“21” l=“MediaConcept/Person/Politician” />
<o id=“22” l=“Model” />
<o id=“23” l=“MediaConcept/Person/Model” />
<o id=“24” l=“RoyalFamily” />
<o id=“25” l=“MediaConcept/Person/RoyalFamily” />
<o id=“26” l=“HistoricFigures” />
<o id=“27” l=“MediaConcept/Person/HistoricFigures” />
<o id=“28” l=“http://ipv.com/teragator/development/schemas/callContext#displaySet0”
/>
<o id=“29” l=“http://www.w3.org/1999/02/22-rdf-syntax-ns#type” />
<o id=“30” l=“http://ipv.com/teragator/development/schemas/callContext#displayset”
/>
<o id=“31”
l=“http://ipv.com/teragator/development/schemas/callContext#usesCapability” />
<o id=“32”
l=“http://ipv.com/teragator/development/ontologies/Client/Silverripples_0.2#canUseObjectAsNodeIcon”
/>
<o id=“33”
l=“http://ipv.com/teragator/development/schemas/callContext#usesWhereLambda” />
<o id=“34” l=“(p) =>
p.regEx(\hat{ }http://ipv.com/teragator/development/namespaces/systemProperties#hasIcon)” />
<o id=“35” l=“http://ipv.com/teragator/development/schemas/callContext#displaySet1”
/>
<o id=“36”
l=“http://ipv.com/teragator/development/ontologies/Client/Silverripples_0.2#canUseObjectAsNodeLabel”
/>
<o id=“37” l=“(p) => p.regEx(\hat{ }http://www.w3.org/2000/01/rdf-schema#label” />
<o id=“38” l=“http://ipv.com/teragator/development/schemas/callContext#displaySet2”
/>
<o id=“39” l=“(p) => p.regEx(\hat{ }http://langware.ibm.com/property/docTitle” />
<o id=“40” l=“http://ipv.com/teragator/development/schemas/callContext#displaySet3”
/>
<o id=“41”
l=“http://ipv.com/teragator/development/ontologies/Client/Silverripples_0.2#objectIsComposition”
/>
<o id=“42” l=“(p) =>
p.regEx(\hat{ }http://ipv.com/teragator/development/namespaces/systemProperties#hasComposition)”
/>
<o id=“43” l=“http://ipv.com/teragator/development/schemas/callContext#displaySet4”
/>
<o id=“44”
l=“http://ipv.com/teragator/development/ontologies/Client/Silverripples_0.2#objectIsPlayableAsset”
/>
<o id=“45” l=“(p) =>
p.regEx(\hat{ }http://ipv.com/teragator/development/namespaces/systemProperties#hasAsset)”
/>
<o id=“46” l=“http://ipv.com/teragator/development/schemas/callContext#displaySet5”
/>
<o id=“47”
l=“http://ipv.com/teragator/development/ontologies/Client/Silverripples_0.2#objectIsUrlOfPlayableAsset”
/>
<o id=“48” l=“(p) =>
p.regEx(\hat{ }http://ipv.com/teragator/development/namespaces/systemProperties#hasPlayableUrl)”
/>
<o id=“49” l=“http://ipv.com/teragator/development/schemas/callContext#displaySet6”
/>
<o id=“50”
l=“http://ipv.com/teragator/development/ontologies/Client/Silverripples_0.2#canUseObjectAsNodeDetail”
/>
<o id=“51” l=“(p) =>
p.regEx(\hat{ }http://ipv.com/teragator/development/namespaces/systemProperties#hasDescriptiveText)”
/>
<o id=“52” l=“http://ipv.com/teragator/development/schemas/callContext#displaySet7”
/>
<o id=“53” l=“(p) =>
p.regEx(\hat{ }http://ipv.com/teragator/development/namespaces/systemProperties#hasSystemInformation)”
/>
<o id=“54” l=“http://ipv.com/teragator/development/schemas/callContext#displaySet8”
/>
<o id=“55” l=“(p) => p.regEx(\hat{ }http://www.w3.org/2000/01/rdf-schema#comment)” />
<o id=“56” l=“http://ipv.com/teragator/development/schemas/callContext#displaySet9”
/>
<o id=“57”
l=“http://ipv.com/teragator/development/ontologies/Client/Silverripples_0.2#canUsePredicateAsFacet”
/>
<o id=“58” l=“(p) =>
p.regEx(\hat{ }http://ipv.com/teragator/development/namespaces/systemProperties#hasMember)”
/>
<o id=“59” l=“http://ipv.com/teragator/development/schemas/callContext#displaySet10”
/>
<o id=“60” l=“http://ipv.com/teragator/development/schemas/callContext#displaySet11”
/>
<o id=“61” l=“http://ipv.com/teragator/development/schemas/callContext#displaySet12”
/>
<o id=“62” l=“(p) => p.regEx(\hat{ }http://www.w3.org/2000/01/rdf-schema#label)” />
<o id=“63” l=“http://ipv.com/teragator/development/schemas/callContext#displaySet13”
/>
<o id=“64” l=“http://ipv.com/teragator/development/schemas/callContext#displaySet14”
/>
<o id=“65” l=“http://ipv.com/teragator/development/schemas/callContext#displaySet15”
/>
<o id=“66”
l=“http://ipv.com/teragator/development/ontologies/Client/Silverripples_0.2#canProject
ObjectAsInteger” />
<o id=“67” l=“(p) => p.regEx(\hat{ }.+#hasValue)” />
<o id=“68” l=“http://ipv.com/teragator/development/schemas/callContext#displaySet16”
/>
<o id=“69”
l=“http://ipv.com/teragator/development/ontologies/Client/Silverripples_0.2#canProject
ObjectAsDateTime” />
<o id=“70” l=“(p) => p.regEx(\hat{ }.+#hasDateTime)” />
<o id=“71” l=“http://ipv.com/teragator/development/schemas/callContext#callContext”
/>
<o id=“72” l=“http://ipv.com/teragator/development/schemas/callContext#hasDateTime”
/>
<o id=“73” l=“12/04/2010 12:09:45” />
<o id=“74” l=“http://ipv.com/teragator/development/schemas/callContext#hasCallGuid”
/>
<o id=“75” l=“6bade444-06d5-414a-9622-6047b36f9047” />
<o id=“76” l=“http://ipv.com/teragator/development/schemas/callContext#hasChunkMax”
/>
<o id=“77” l=“1” />
<o id=“78”
l=“http://ipv.com/teragator/development/schemas/callContext#hasChunkSequenceNumber” />
<o id=“79” l=“0” />
<o id=“80”
l=“http://ipv.com/teragator/development/schemas/callContext#hasTriplestore” />
<o id=“81” l=“Default” />
<o id=“82” l=“DemoMedia” />
<o id=“83” l=“Promos” />
<o id=“84” l=“Curator-Sports-2” />
<o id=“85” l=“ITunes” />
<o id=“86” l=“News” />
<o id=“87” l=“Sports-1” />
<o id=“88” l=“Virtual-Sports-land2” />
<o id=“89” l=“Science” />
<o id=“90” l=“Clinical” />
<o id=“91”
l=“http://ipv.com/teragator/development/schemas/callContext#hasDisplayset” />
</objects>
</root>

### Appendix 3—References.

[1] Resource Description Framework (RDF): Concepts and Abstract Syntax, Klyne G., Carroll J. (Editors), W3C Recommendation, 10 Feb. 2004.
[2] http://www.w3.org/TR/PR-rdf-syntax/ “Resource Description Framework (RDF) Model and Syntax Specific

### Appendix 4—Teragator Applications

This Appendix 4 describes some Teragator application areas.

### Browsing Relational Databases

### IPV Curator.

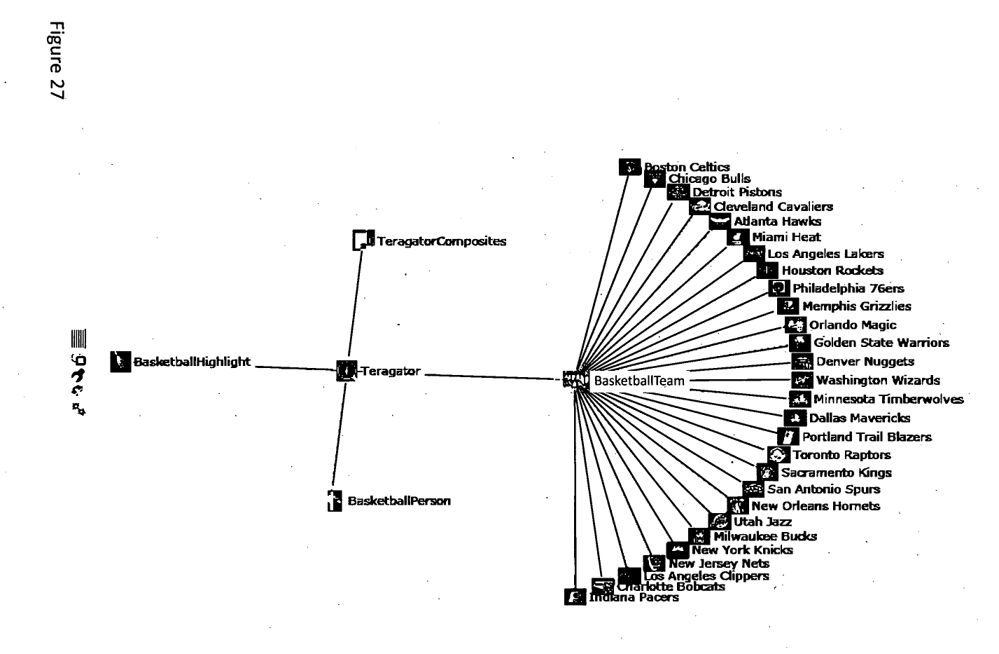

IPV's Curator is an asset management system that uses a MySql database as a physical storage medium. The assets that are held are media-related and one example of this is a system for search, retrieval and annotation of basketball highlights. FIG. 27 shows a Teragator visualisation of the basketball database. The assets can be browsed from the point of view of ‘Basketball Person’, ‘Basketball Highlight’, ‘Basketball Team’, or ‘Composites (a hierarchy of connections between resources).

### Browsing XML Databases.

iTunes.

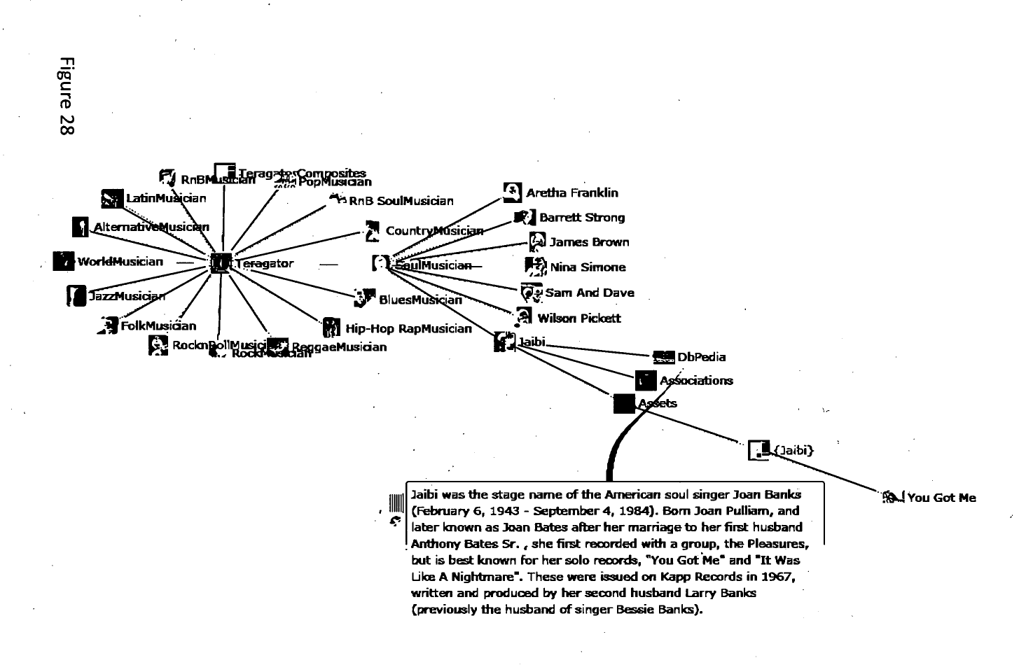

iTunes uses an XML file to store its data about media items which includes name, genre, artist, rating, and so on. Teragator is able to visualise this information as shown in FIG. 28. As well as using an ontology to categorise the artist additional tools, such as a DbPedia web service tool, can be used to obtain and aggregate additional information as shown.

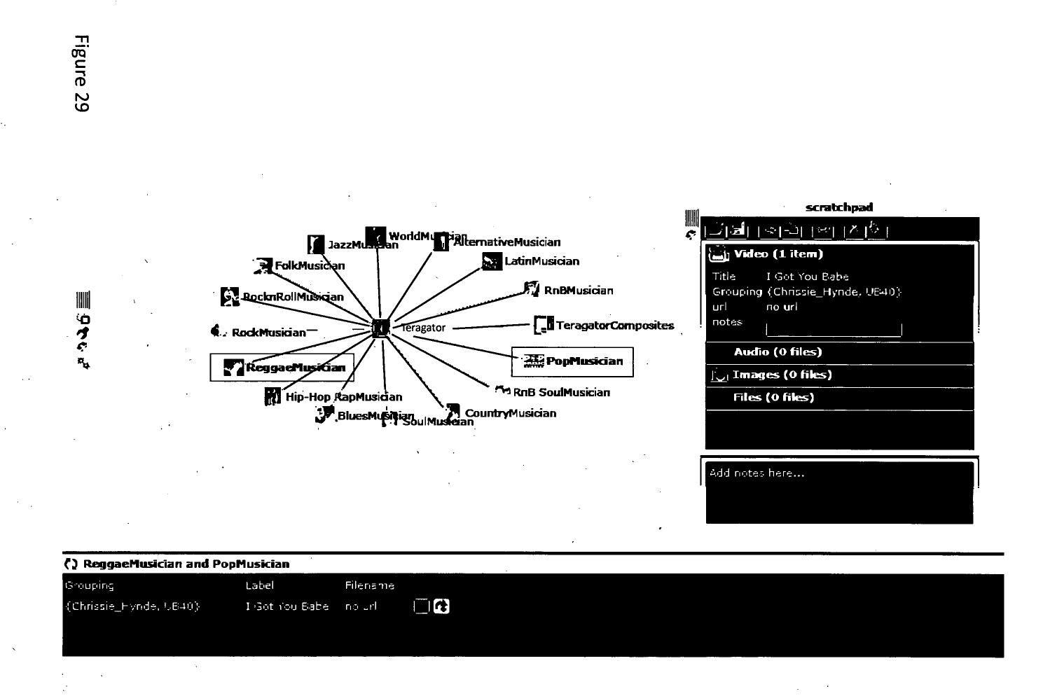

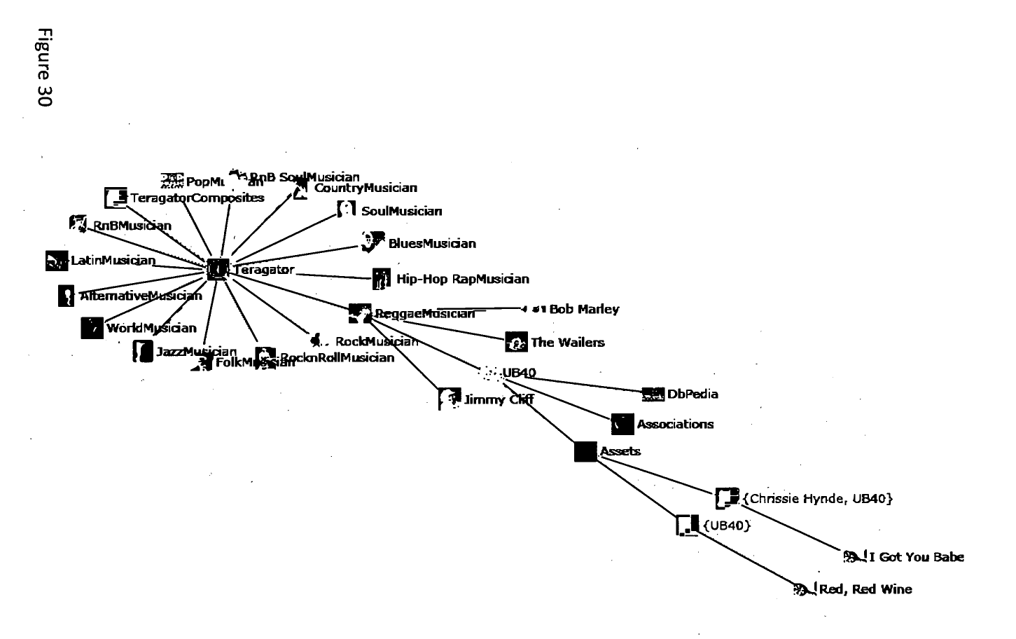

FIGS. 29 and 30 illustrate other Teragator capabilities that may enhance a music application. For example, the user may want to find the song that has a pop singer collaborating with a reggae band, but may not be able to remember any more detailed information. Selecting the terms ‘ReggaeMusician’ and TopMusician' and activating the Teragate query results in ‘I Got You Babe’ with Chrissie Hynde and UB0 being returned. The result can be confirmed by browsing to the appropriate place, as shown in the second figure. Also, as the first figure illustrates, the results of searches can be added to the media scratchpad, subsequently to be exported as a playlist.

### Browsing Web Services.

### DbPedia.

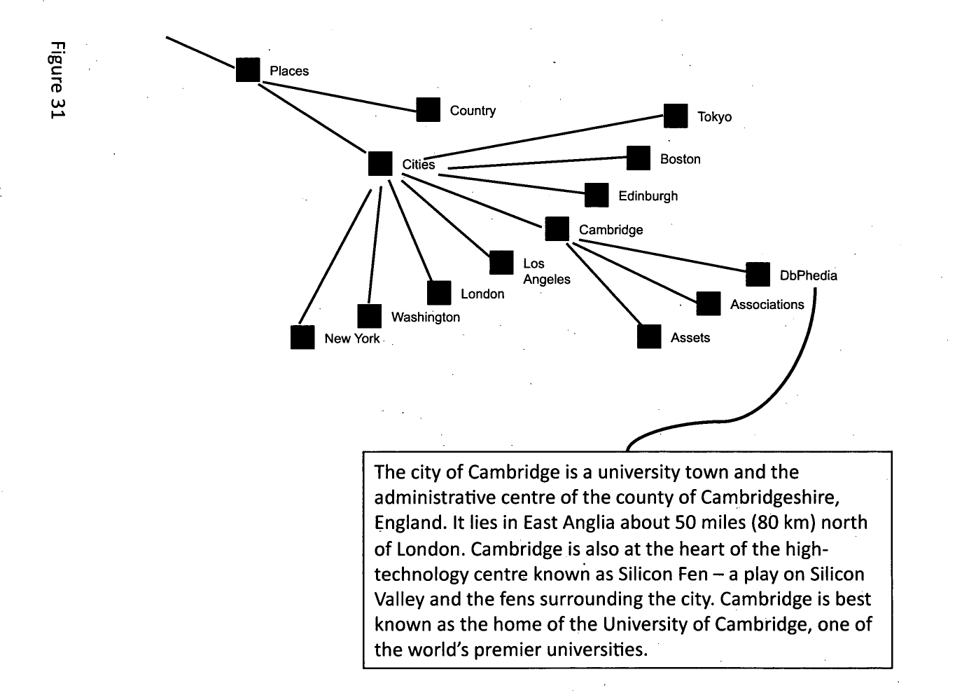

Although not a separate application in its own right, the ability to browse and aggregate data from web services such as DbPedia is added by default to all Teragator applications, as shown in FIG. 31. Wherever an individual in the ontology (a resource that has an identifiable and well-known physical counterpart) is encountered it is possible to query a web service for any data that it has on that individual.

### Browsing Consumer Media Services.

### DLNA [Digital Living Network Alliance]

### Choosing What to Digitise

Many media content owners have archives that are not readily accessible or require significant cost of processing to retrieve and use. Finding a viable commercial model i.e. an adequate return on the investment, to digitise and bring on-line all the archive material is unlikely. Indeed, these potentially valuable media assets are often simply left languishing in vaults or in low cost storage environments. Generally where any investment is made, resources are prioritised along the lines of a policy of balanced digitization choices such as;

1. the level of deterioration of the original copies;
2. where it is physically residing,
3. if the business requires the space in a particular area;
4. for editorial reasons based on its content and event driven demand or anticipated demand due to an upcoming related event.

Teragator can bring considerable benefit by providing all users simple and cost effective access to the underlying metadata pertaining to the assets, thereby allowing informed choices.

Database technology has existed in some form for many years while assets were still being retained on tape or even film. Often there is more descriptive data available and frequently stored in legacy databases or digital sources. Consider the scenario where Jane is looking for background editorial to a piece she is researching on deadly sea creatures. It maybe this is being driven by some tragic event and she really needs to access the archive quickly and effectively or for an up and coming documentary. Using Teragator, this allows her to intelligently choose and research material as well as prioritising any necessary retrieval from archive or digitisation. Exploring the data available with a higher level view based on categorisation or an ontology based view is likely to yield results where search alone would not work or be tedious and time consuming at best. Providing the data and assets exists then in this example Jane would likely find footage for Killer Whales, sharks, lion fish etc and related stories of fatalities she may have not considered.

### Steering What to Offer

Consider a media content aggregator who has a supplier community who can upload media content and add commentary to the content at will. Using natural language processing the content can be mined for meaningful relational data and be presented to users in a more informative way using Teragator. Additionally, when browsing the available media assets the content owners can bid on semantic meaning and ontology's that offer better preferences and options to users as well as more intelligent filter choices. Consider the scenario where a provider is offering shots of wildlife and through a selected ontology the end user is immediately offered books on sponsored subjects such as twitching (bird watching), or binoculars and lens cleaning products. Unlike traditional methods of using statistics to offer like options, based on previous history and trends alone, Teragator can use semantics and related ontology to uplift the quality of choices offered.

For example, using bid-based PPC (Pay Per Click) for bidding on an ontology that ‘groups’ birds of prey together and links through to optics; when Tom starts to browse for wildlife shots relating to eagles he is offered choices of birds or prey material, spotter lenses, binoculars and related products that better suit his interest, regardless of any previous history of users browsing for these items although this can obviously be used to help weight the results.

### Social Networking

With the advent of multiple sources for social networking and the plethora of related social media or “small talk”; it is becoming increasingly difficult to keep up with the stories and events of friends and interest groups. Teragator can allow users to keep up to date with posts to multiple sources or pull together related posts. Teragator does this automatically by monitoring these sources and using natural language processing to explore semantically, what is going on. For example, Jane has posted to her Facebook a few recent photographs of her trip to Rome and her friend Tom is then alerted by Teragator that he might like to take a look or contact her for his up and coming trip to Italy. Teragator recognises that new data is available and offers this data under the category of countries visited and aligns the relevance from the match with his own data on up and coming trips. One can imagine how difficult and time consuming it would have been to search all his friends' sites and data to look for this connection. The fact that Teragator can identify the city against the country through its hierarchical ontology maps allows these matches and relevance to be identified easily. Using pure search alone, Tom would be faced with guessing all the likely cities in Italy to see if any of his friends had made relevant visits, assuming he could remember them! Appendix 5 discusses Social Networking in more detail.

### Exploring Email

There are many different search engines and plug-ins for email packages that look to offer easier find and retrieval of email. Using more advanced plug-ins it is possible to gather statistical data and look for specific structural links that make it easier to navigate historical data as well as explore contacts and their detail. These tools also use simple methods of offering filter options to focus in on specific topics or options that help prioritise the results of searches, such as items with or without attachments. Teragator brings a new dimension to this capability by adding semantic data mining to look for relationships in meaning and greatly improve the options for filtering of email based on more informed relevance. Additionally, users are now able to explore the email from a structural perspective, being presented with the options available and the context of email traffic. The Teragator approach is also a great memory jogger as it is often the case that when searching for something specific, the quality and accuracy of the search is wholly reliant upon the users' memory and perspective of the subject matter. Teragator draws on the semantic meaning of the email subject line, embodiment and other related data fields, as well as having the capability to explore the attachments and link context. Additionally Teragator helps draw out keywords and context from the data and therefore offer the user selection results with greater precision and clarity.

For example, Tom is looking for some email that was sent to him previously and related to an application for capturing graphics. Tom is struggling to remember unique key words to narrow his search or from whom it was sent and when. Teragator allows Tom to browse through the choices of related topics and identifies that the options “Screen” and “Print” are related and available from the mined data. Selection and query based on these topics quickly offers email and Tom finds that the application and email traffic does not refer to graphical capture but instead print screen.

### Browsing Web Sites.

Standard ‘Web Crawler’ techniques can be used to examine and collect web site resources, which can then be converted to RDF and browsed using Teragator.

Applying Value to the Semantic Content of Search Terms.

It is often the case that the terms that are entered into a search engine, when used in isolation, do not adequately represent what the user is trying to find, and in some cases quite the opposite. For instance, entering the following

“insurance but not interested in cars”
into a search engine will return many hits relating to car insurance. The meaning is only extracted by parsing the search terms to extract any possible semantic content, i.e., “insurance for everything except cars”. The Teragator data mining process attempts to infer semantic relations between the resources it finds: this is captured in the concept of a special type of resource called a ‘Composition” which captures a relation between two or more resources.

So, taking the current example further, a Teragator data mining operation may have identified the occurrence of ‘insurance’ in the context of house insurance, pet insurance, car insurance, holiday insurance, motorbike insurance etc, and created the composite resources {Insurance, House}, {Insurance, Pet},{Insurance, Holiday}, {Insurance, Car}, {Insurance, Motorbike}. A Teragate query of the form {Insurance, NOT car} would return all the compositions except {Insurance, Car}. The fact that these resources are elements in an ontology could further be exploited since the query {Insurance, NOT vehicle} would also exclude {Insurance, Motorbike} since both cars and motorbikes are subclasses of ‘Vehicle’.

This information may have a monetary value since it would allow a search engine more precisely to match searches with potential hits, and to offer the companies that are the potential ‘hits’ the opportunity to buy a preferential position in the returned hits for a given search. This amounts in effect to the search engine not just allowing potential advertisers to bid for advertising words (e.g. the Google AdWords programme), but instead to bid for meaning; this is potentially much more targeted and hence valuable.

### Other Applications

Rapid editing of sports highlights and other time-critical media applications where the data becomes stale very quickly.

Commentators research tool for dynamically exploring background, links, common occurrences and historical data which may help inform or promote the programming.

Exploring a library and media by interacting with the metadata and expanding the potential use of the media for creating new editorial views or programming

Exploring the media library for relationships where media can be used for ad placement or greater marketing campaigns.

### Appendix 4—References.

[1] Resource Description Framework (RDF): Concepts and Abstract Syntax, Klyne G., Carroll J. (Editors), W3C Recommendation, 10 Feb. 2004.
[2] http://www.w3.org/TR/PR-rdf-syntax/ “Resource Description Framework (RDF) Model and Syntax Specification”
[3] OWL 2 Web Ontology Language: Quick Reference Guide Jie Bao, Elisa F. Kendall, Deborah L. McGuinness, Peter F. Patel-Schneider, eds. W3C Recommendation, 27 Oct. 2009, http://www.w3.org/TR/2009/REC-owl2-quick-reference-20091027/
[4] DLNA for HD Video Streaming in Home Networking, http://www.dlna.org/about us/about/DLNA Whitepaper.pdf

### Appendix 5—Using Teragator for Social Networking.

This Appendix 5 describes the application of Teragator to social networking. Aimed typically at a person in their teens, this allows them to construct a linked set of resources which reflect their own interests, and which is presented in their own way. These resources may include:
Music
Photos
Websites
Web text-based services and feeds
Miscellaneous electronic documents—homework, clips from websites.
Email
Friends resources
Local Media channels (for example DLNA [4])
Web media channels

Social networking sites tend to impose a standard presentation on the user; typically something like a photo album, a message board, links to external web resources, and so on. Since Teragator is built on top of schema-free semantic web technology (in contrast to the relational databases currently used in social networking sites) the content can be highly specialised for a particular individual, giving that person an enhanced involvement with, and sense of ownership of, that content.

### Example

### Ellie's World

User Interface Metaphor.

The overriding requirement of the UI is to help the user orient them self at all stages of the exploration process. This is because the concept of navigation through an abstract space of linked data is extremely complex and hard to grasp for the average user, and the amount of data, and the degree of linkage potentially is enormous. The main UI metaphor that is enforced by Teragator is:—
Up (Constellation View)=navigation, orientation and abstraction;
Forward (Terrain View)=work area, local movement and exploration;
Down (Detail View)=detail and everything that has been found.

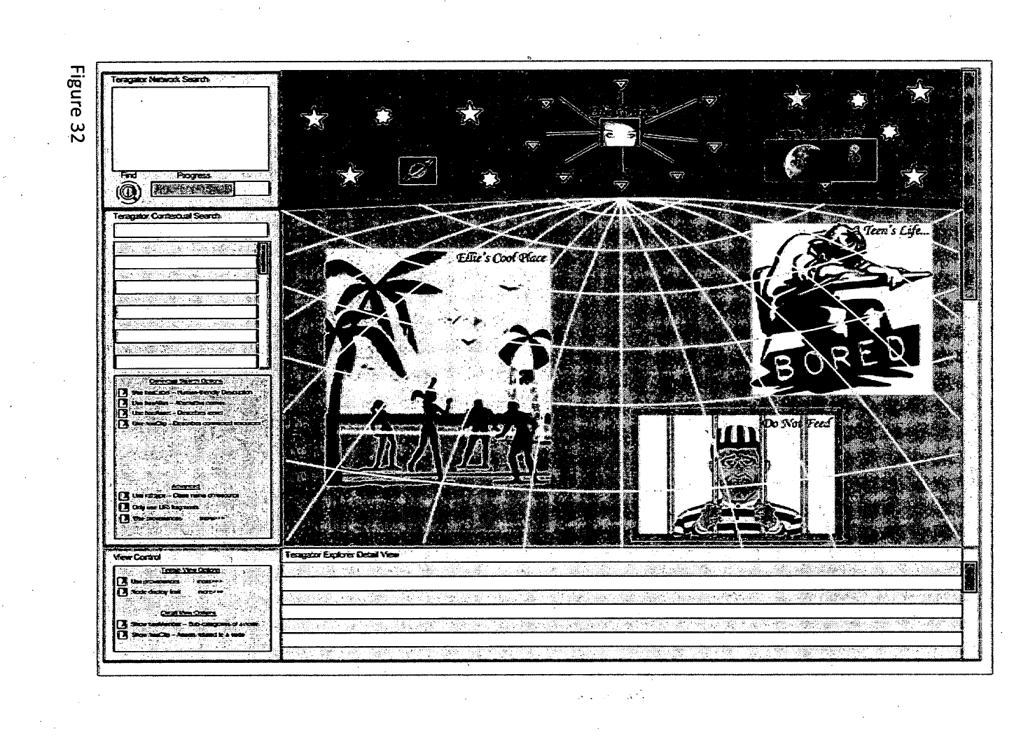

A large part of visible part of the UI, shown at FIG. 32, consists of the main pane which is the area devoted to unstructured, exploratory actions. The main pane displays the constellation and terrain views on which all the graphical elements are rendered. The results of text searches are displayed in the detail view beneath the main pane. The constellation and terrain views are “skinned”—the user constructs the background graphics to suit their taste using photo, graphics, scanned-in material, and so on. In this example the skin suggests sky/earth/ground and reinforces the up/forward/down; navigate/explore/detail metaphor.

Another aspect is that the pane is sectioned into zones which reflect particular interests or attitudes of the user. The size, location and graphics associated with these are completely under the control of the user. In the figure the ones shown are:
Ellie's cool place—for resources associated with friends and relaxation, etc;
A teens life—for resources associated with school, homework, hobbies, etc;
Do Not Feed—for resources that currently are out of favour.

The controls that are used to manipulate the resources are shown to the left of the main pane. These, again, can be “skinned”; in this example they are shown as straightforward UI elements—drop-down and combo boxes, buttons, tick boxes, etc.

The constellation view in the upper part of the main pane contains the active “Ellie's World” resource with links to sub-resources—clothes, photos, music, school stuff, home stuff, stuff (resources that defy categorisation), mates, telly. This view also contains links to other similar “worlds” belonging to other users that the user is authorised to explore; in this case “Christie's World”. Selecting the “Christie's World” resource causes the RDF dataset that represents this to be made active and allows Ellie to explore all the resources (that she is authorised to see) in “Christie's World”.

From the point of view of the RDF0 on which the visualisation is based, the ability to explore different datasets, representing different ‘Worlds’, is accomplished by a straightforward aggregation of the triplestores that hold the data for these worlds.

### Manipulating Resources 1—Exploring “Ellie's World

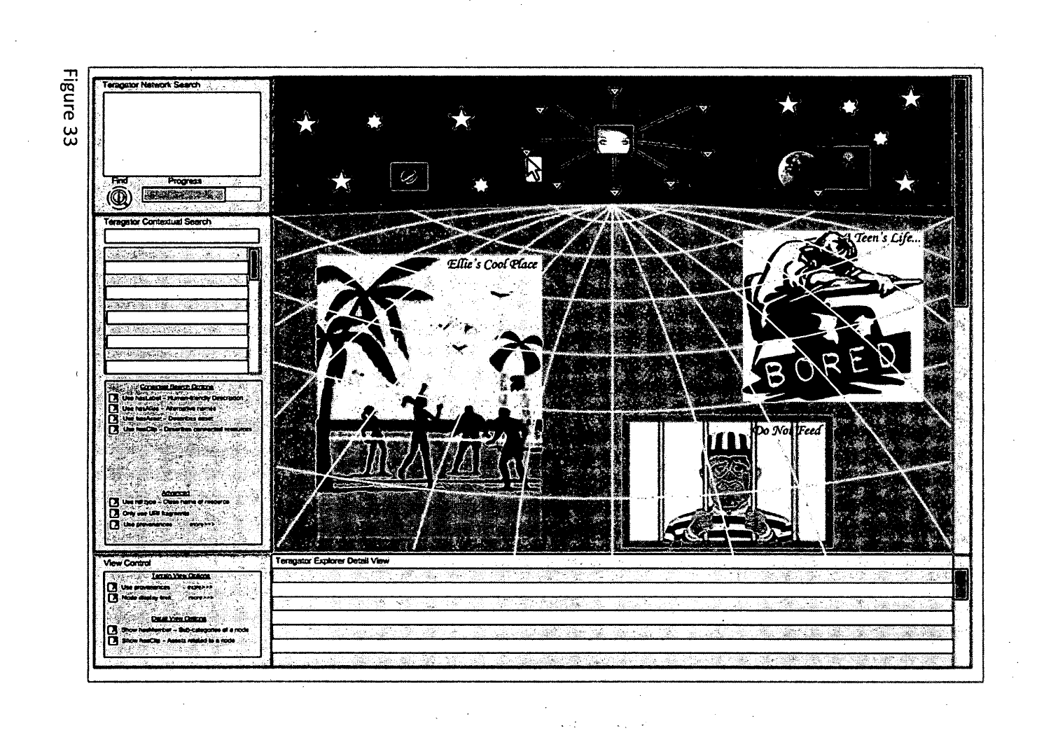

We'll assume that Ellie just wants to browse some of her stuff, to reorganise things a bit, and find out what her friends are doing. She clicks on the ‘Mates’ icon in the Constellation view to expand the ‘Mates’ node, as shown in FIG. 33.

### Manipulating Resources 2—Exploring “Mates”.

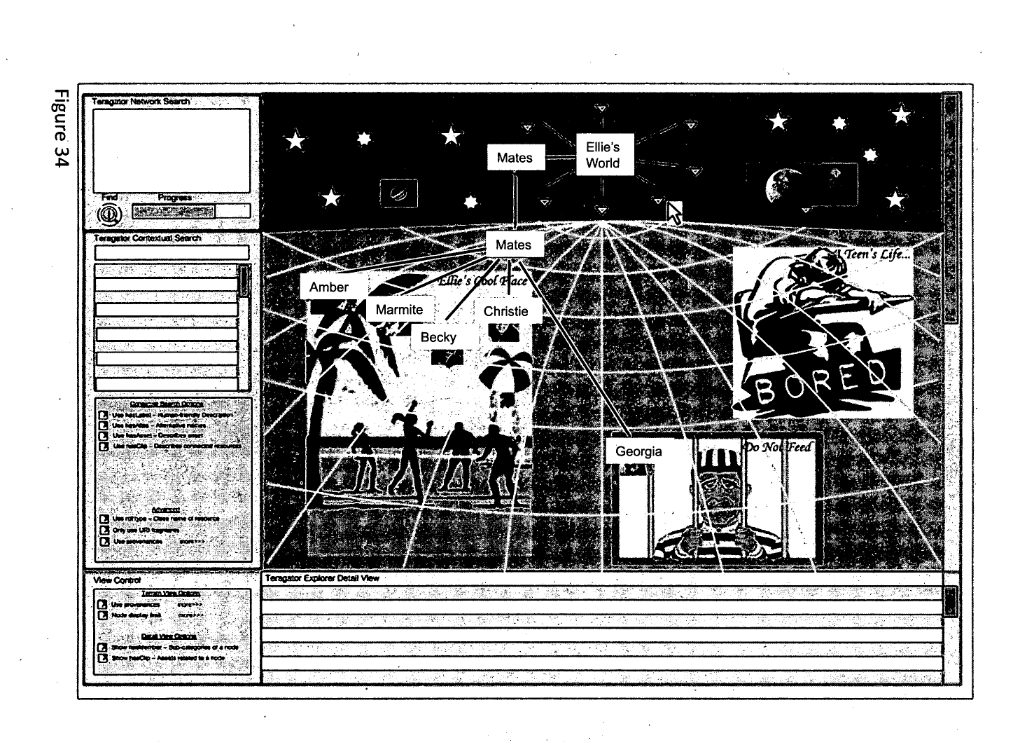

Ellie's ‘Mates’ are expanded, as shown in FIG. 34, and are projected into zones within the Terrain view that correspond to how in or out of favour those mates are. From the point of view of the underlying data, this is achieved by attaching an RDF statement to the collection of statements that define the resource for a particular ‘Mate’, that describes their current standing. In this example all Ellie's mates are in favour and are projected into the ‘Ellie's Cool Place zone, bar one, who is projected into the ‘Do Not Feed’ zone.

Because of the schema-free nature of the RDF dataset, Ellie is free to attach as many attributes s she likes to the resources and control how they are projected, or otherwise displayed. For example, she may want to class some mates as ‘Best Mates’, or have a ‘Guys I fancy’ category (although the author sincerely hopes that this isn't the case at present).

### Manipulating Resources 3—Exploring “Music”.

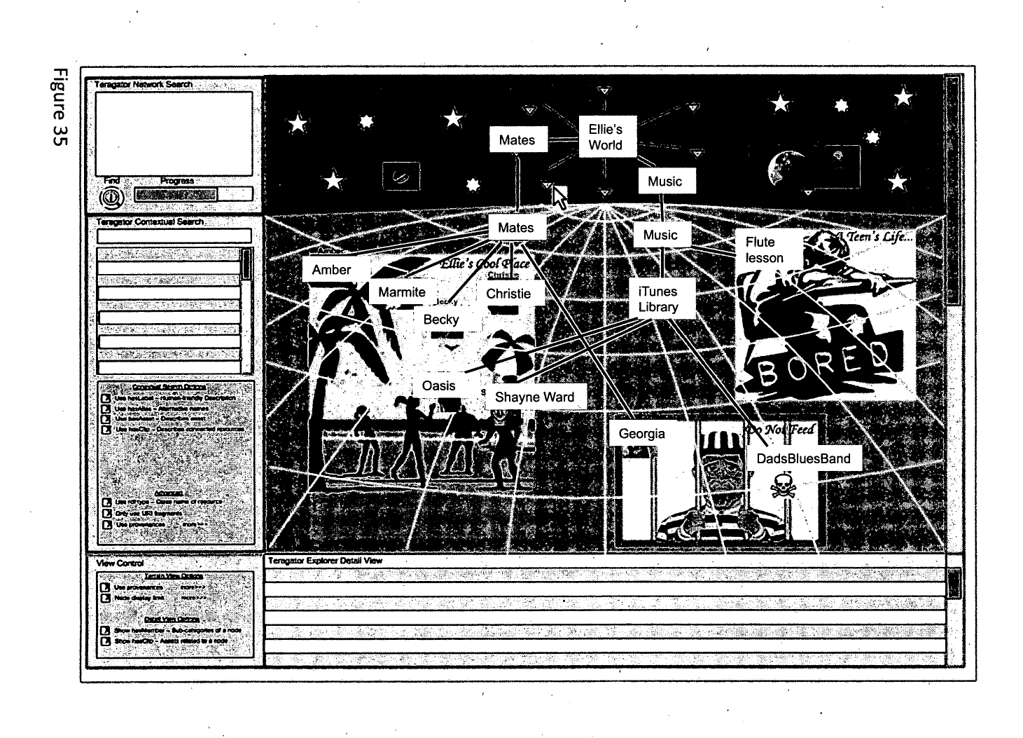

In a similar vein to the previous example, exploring ‘Music’ results in resources with different attributes being projected into different zones: various pop groups go into ‘Ellie's Cool Place’, a flute lessons timetable into ‘A Teen's Life’ and ‘Dads Blues Band’ into ‘Do Not Feed’, as shown in FIG. 35.

### Manipulating Resources 4—Exploring “Stuff”.

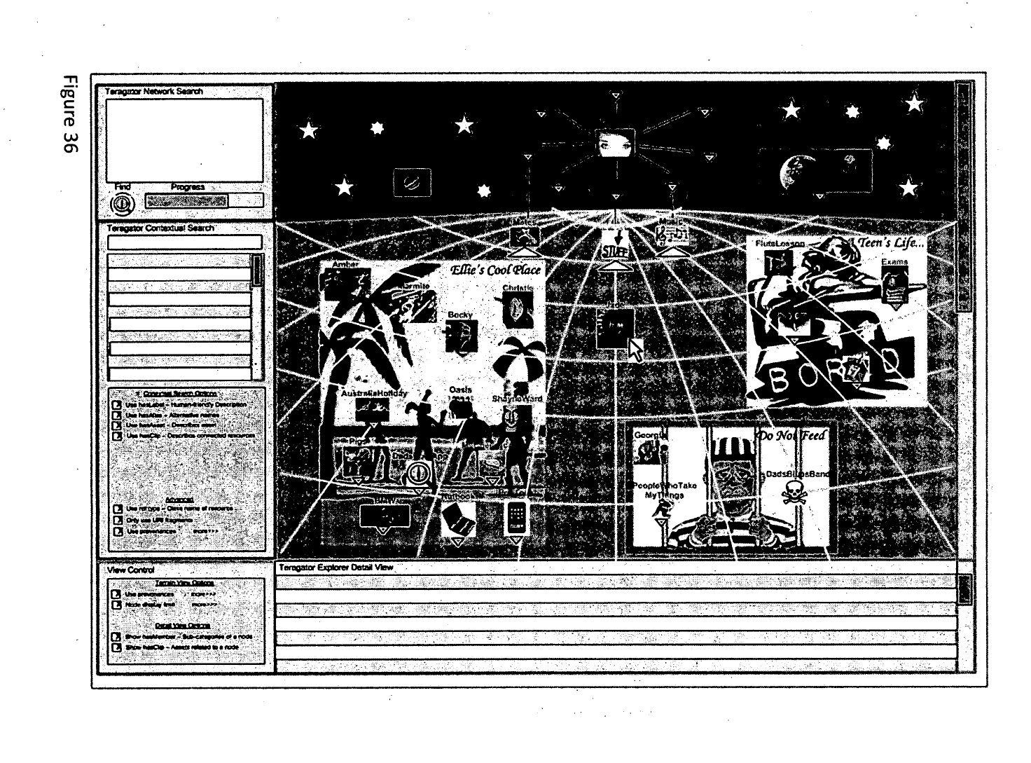

The ‘Stuff’ resource is explored and the various bits and pieces projected into the appropriate zones. Stuff’ is also a good place to put items that are awaiting categorisation. Ellie has just linked in with a new friend ‘Jade’ whose resource as been placed in the ‘Stuff’ parent resource, as shown in FIG. 36. The RDF statement that determines the zone into which the resource is projected is missing since ‘Jade’ has not yet been categorised. This is not an error since there is no schema that dictates that there has to be such an attribute. A default behaviour is invoked in this case which projects the ‘Jade’ resource onto a ‘neutral’ zone.

### Manipulating Resources 4—Moving Resources

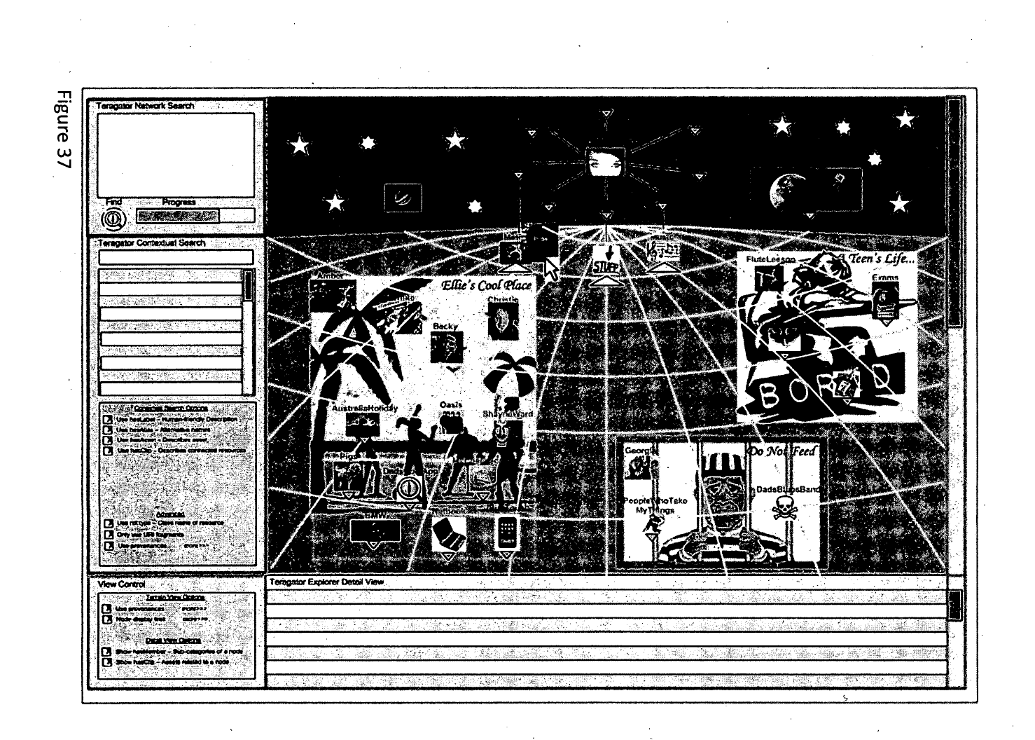

Ellie wants to add Jade to her mates so she drags the icon onto the ‘Mates’ icon, shown in FIG. 37.

### Manipulating Resources 5—Adding New Attributes to Resources

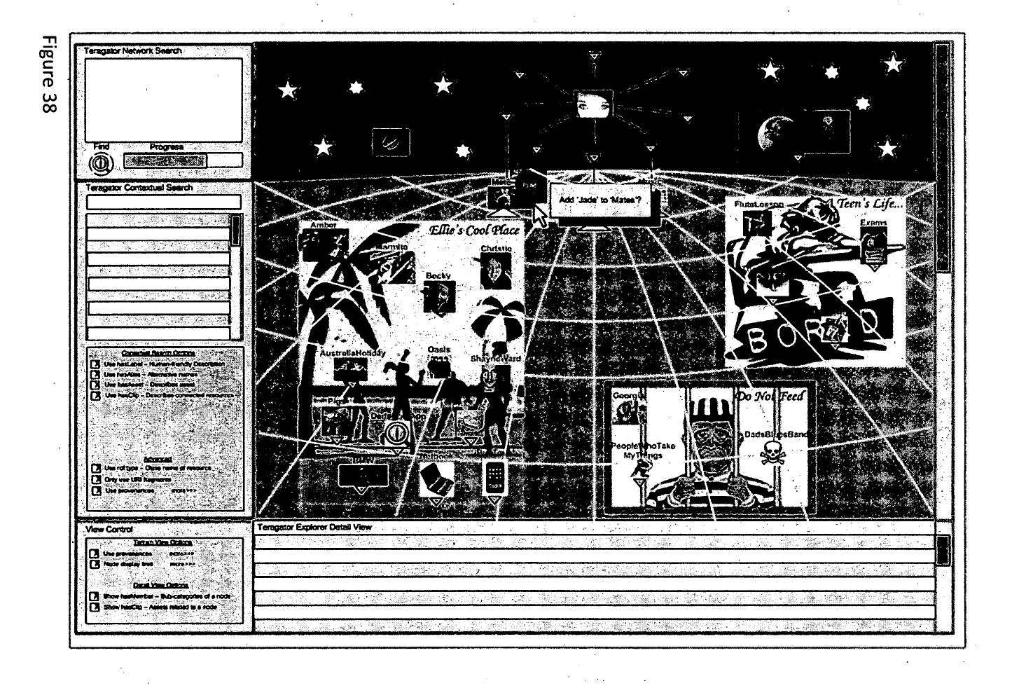

The action of adding Jade to ‘Mates’ necessitates a modification of the RDF dataset so that an extra RDF statement is added to the ‘Jade’ resource to the effect that she is a ‘mate’, shown in FIG. 38. The server requests for confirmation before this processing continues.

### Manipulating Resources 6—Moving Resources

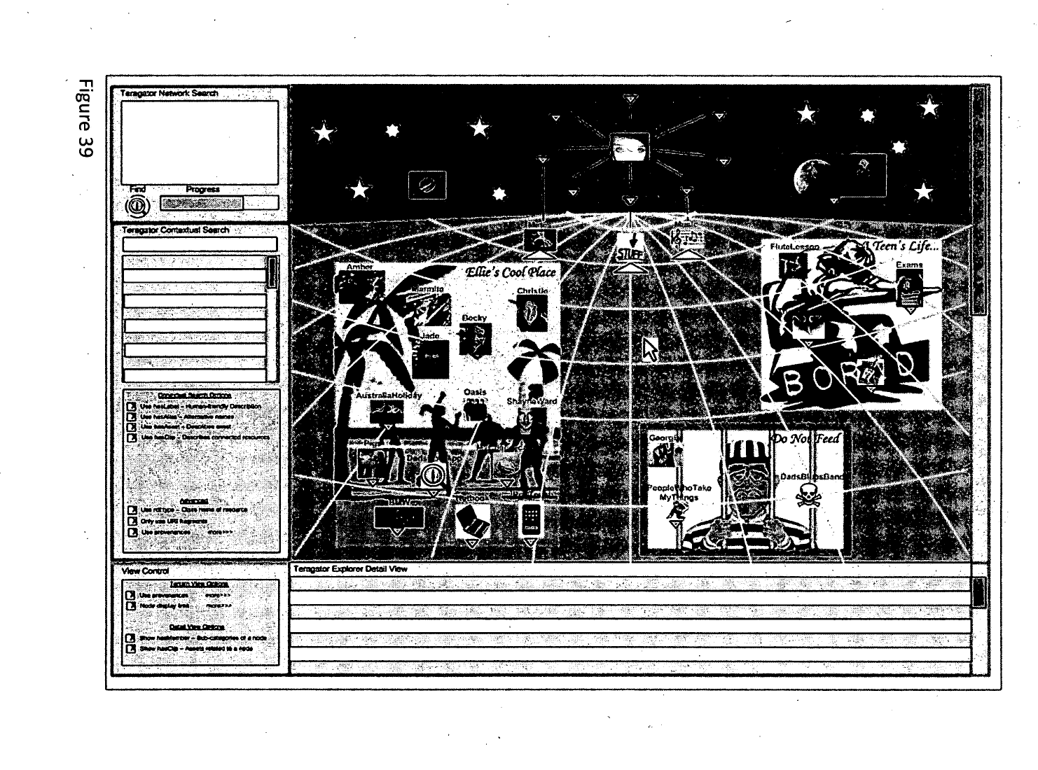

Once Ellie confirms the addition the RDF dataset is modified and Jade is classed as a ‘Mate, shown in FIG. 39.

### Appendix 5—References.

[1] Resource Description Framework (RDF): Concepts and Abstract Syntax, Klyne G., Carroll J. (Editors), W3C Recommendation, 10 Feb. 2004.
[2] http://www.w3.org/TR/PR-rdf-syntax/ “Resource Description Framework (RDF) Model and Syntax Specification”
[3] OWL 2 Web Ontology Language: Quick Reference Guide Jie Bao, Elisa F. Kendall, Deborah L. McGuinness, Peter F. Patel-Schneider, eds. W3C Recommendation, 27 Oct. 2009, http://www.w3.org/TR/2009/REC-owl2-quick-reference-20091027/
[4] DLNA for HD Video Streaming in Home Networking, http://www.dlna.org/about us/about/DLNA Whitepaper.pdf

### Appendix 6—Teragator Triplestore Design

This Appendix 6 describes the design of the Teragator triplestore for a relational database. The design defines an access layer and schema that uses any relational database for physical storage; MySQL is the database used in the following description.

### Design Principles.

The design of triplestores is a research topic. Many approaches are being investigated; a common one is property tables [4] as used in the HP Jena RDF Server. The property table approach groups together sets of triples having the same predicate into separate tables. This is one example of the use of a quite complex schema to obtain good performance.

The Teragator triplestore design, in contrast, goes for simplicity; defining a single triplestore with extra tables that exploit some aspects of the common structure of triples, in order to gain performance. The main features of the Teragator triplestore are as follows:
1. The triplestore comprises three tables—Statement, Prefix and Literal (the schema is therefore called SPLit).
   2. Triples make heavy use of URIs (such as http://ipv.com/teragator/development/schemas/service#fred). The prefix table stores the left part of the URI (everything to the left of the fragment starting with ‘#’) which results in much less data stored since one prefix typically is common to very many triples. A particular prefix is encoded using a hash value.
3. The number of prefixes in a typical data set typically is small enough that the table can be loaded into memory at run time gaining a further speed advantage, since prefixes can be expanded using a look up of an in-memory table rather than a database query.
4. The RDF object component of a triple is either a URI (in which case it is efficiently encoded using the prefix table) or a string literal. The string literal potentially can be very long; so above a certain size string literals are stored in the Literal table and encoded using a hash value.
5. The statement table stores the actual triples in three columns. Prefixes are stored as hashes into the Prefix Table and long literals are stored as hashes into the Literal Table. Otherwise, the triple information stored just comprises fragments of URIs and short literals. A fourth column stores a short signature which indicates how each of the subject, predicate and object parts of the triple are encoded. A fifth column stores the provenance of the triple (a URI which is outside the RDF standard but which is commonly included as a fourth part of a ‘triple’) and a sixth column stores the Id which is the primary key of the record.

### Schema.

Prefix Table.

PrefixHash
VARCHAR(64)
Prefix VARCHAR(255)

Statement table.

Subj VARCHAR(255)
Pred VARCHAR(255)
Obj VARCHAR(255)
Prov VARCHAR(255)
Signature TINYINT(3)
Id BIGINT(20)

Indexing is performed on the following pairs of columns:—

### Subj, Pred;

### Pred, Obj;

### Obj, Subj.

The ‘Signature’ is a value that is stored alongside the triple that defines how the triple is represented, as follows:
enum SignatureOfTriple: byte

```
{
    SubjIsUri_ObjIsUri,
    SubjIsUri_ObjIsBNode,
    SubjIsUri_ObjIsShortLiteral,
    SubjIsUri_ObjIsLongLiteral,
    SubjIsBNode_ObjIsUri,
    SubjIsBNode_ObjIsBNode,
    SubjIsBNode_ObjIsShortLiteral,
    SubjIsBNode_ObjIsLongLiteral,
}
```

Literal table.

ObjHash
VARCHAR(255)
Literal LONGTEXT
Lang VARCHAR(255)
Datatype
VARCHAR(255)
Prov VARCHAR(255)

### Example

This example shows how the following RDF triple is stored:

Subject = http://ipv.com/teragator/development/schemas/
service#!18174dfe-eb56-4abd-a3e5-86f4be8b9ecd
Predicate =
http://ipv.com/teragator/development/namespaces/
systemProperties#hasDescriptiveText
Object = ‘12:13:14:15 Bicycle is most popular way of getting to work for
employees of Cambridge firm IPV’

The Prefix table stores the left parts of the prefixes used in the triple:

| PrefixHash | Prefix |
|---|---|
| ‘-1174325513’ | ‘http://ipv.com/teragator/development/schemas/service#’ |
| ‘2142458200’ | ‘http://ipv.com/teragator/development/namespaces/ |
| | systemProperties#’ |

The Literal table stores the long string literal:

| ObjHash | Literal | Lang | Datatype | Prov |
|---|---|---|---|---|
| ‘-978263262’ | ‘12:13:14:15 | ‘lang’ | ‘datatype’ | ‘-1174325513_’ |
| | Bicycle is most | | | |
| | popular way of | | | |
| | getting to work | | | |
| | for employees of | | | |
| | cambridge | | | |
| | firm IPV’ | | | |

The Statement table stores the actual triple, using hash encodings into the Prefix and Literal tables, of the prefixes and of the literal:

| Subj | Pred | Obj | Prov | Sig | Id |
|---|---|---|---|---|---|
| ‘-1174325513_!18174dfe- | ‘2142458200_hasDescriptiveText’ | ‘-978263262’ | ‘-1174325513_’ | 3 | 213809 |
| eb56-4abd-a3e5- | | | | | |
| 86f4be8b9ecd’ | | | | | |

### Appendix 6—References.

[1] Resource Description Framework (RDF): Concepts and Abstract Syntax, Klyne G., Carroll J. (Editors), W3C Recommendation, 10 Feb. 2004.
[2] http://www.w3.org/TR/PR-rdf-syntax/ “Resource Description Framework (RDF) Model and Syntax Specification”
[3] OWL 2 Web Ontology Language: Quick Reference Guide Jie Bao, Elisa F. Kendall, Deborah L. McGuinness, Peter F. Patel-Schneider, eds. W3C Recommendation, 27 Oct. 2009, http:/www.w3.org/TR/2009/REC-owl2-quick-reference-20091027/
[4] Workshop on Semantic Web and Databases, Berlin, Germany, 2003. Kevin Wilkinson, Craig Sayers, Harumi Kuno, Dave Reynolds

### Appendix 7—Teragator User Interface.

This Appendix 7 describes the Teragator user interface.

### User Interface Metaphor.

The overriding requirement of the UI is to help the user orient them self at all stages of the exploration process. This is because the concept of navigation through an abstract space of linked data is extremely complex and hard to grasp for the average user, and the amount of data, and the degree of linkage potentially is enormous. The main UI metaphor that is enforced by Teragator is:—
Click the icon representing a resource to explore linked resources.
Drag down on the icon representing a resource to obtain tools that perform actions on the resource.
Resources are either categories in an ontology or—
Representations of a physical or electronic resource or—
Services that provide additional information about resources or—
Software resources that operate on a resource, for example, a media player that plays a video resource.

### Ontology View.

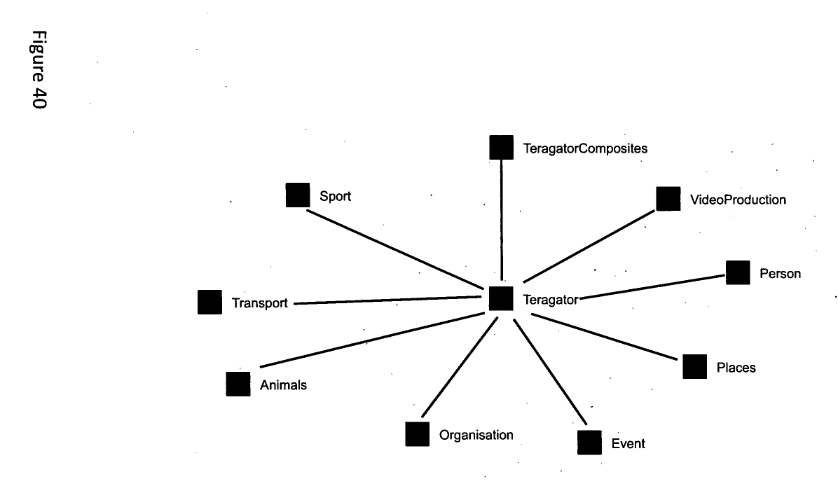

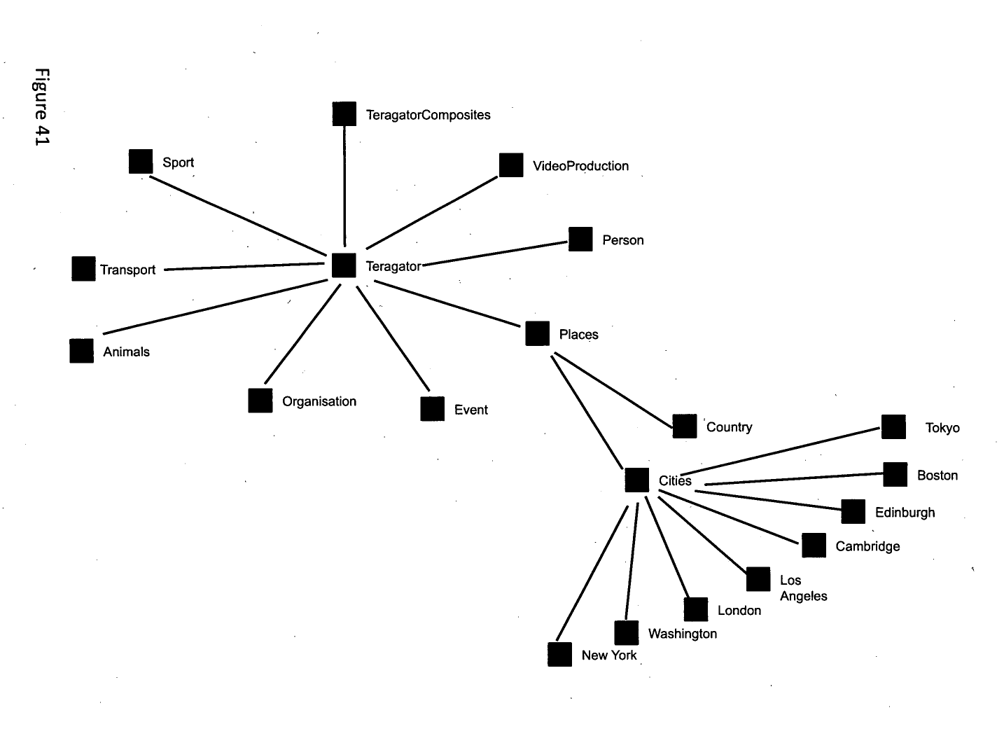

The initial, default view for a Teragator visualisation is the ontology view as shown in the two FIGS. 40 and 41. This shows the top-level categories into which resources are put, and allows the user to start the exploration process.

### Individual Resources View.

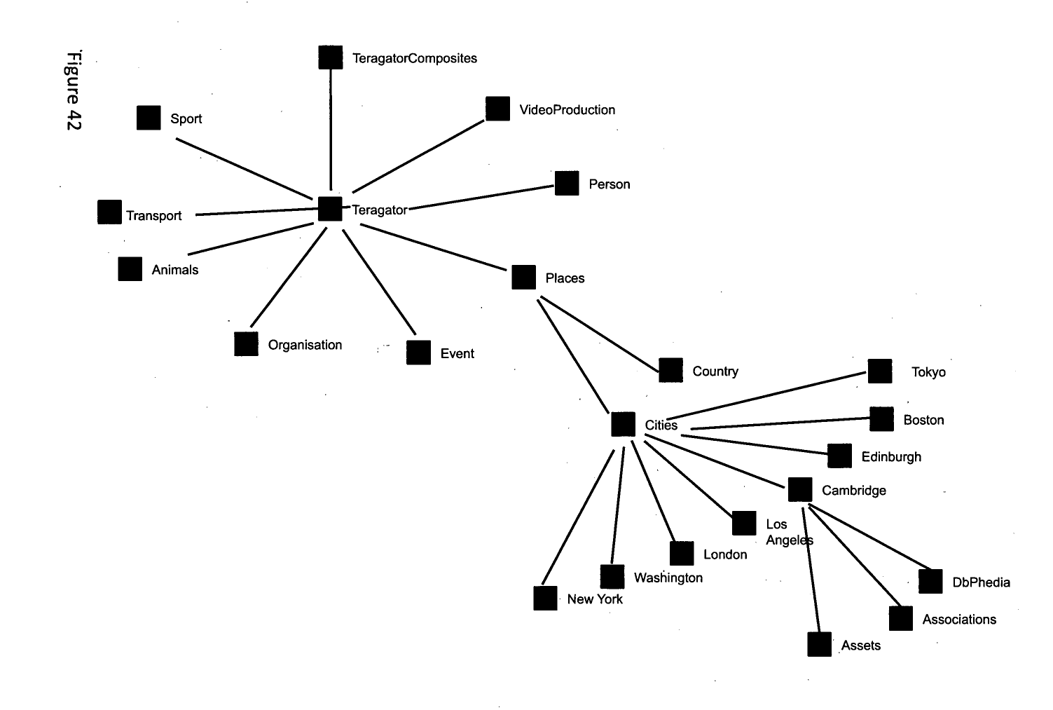

At the point where the user has found an ontology individual (a representation of a physical or electronic resource), a new type of resource is seen. In the example shown in FIG. 42 the individual is ‘Cambridge’ and the new resources are DbPedia', ‘Associations’, ‘Assets’, ‘Web Page Detail’ (not shown in the example) and ‘Resource Detail (not shown in the example). These resources represent the point at which the abstract model (the ontology) meets the real world (resources that are mined from data that describes events in the real world).

These resources are described in the following sections.

### Web Page Detail

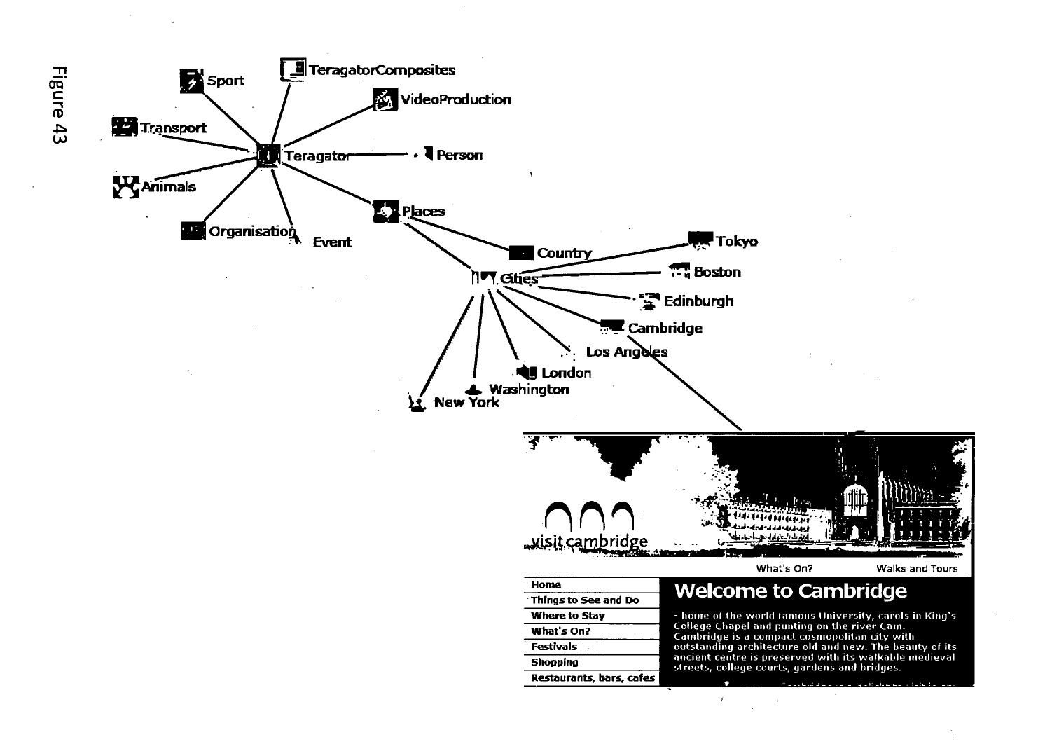

Many real-world resources such as people, places, organisations, etc, have a web presence. Teragator provides a quick way to explore the default web site for that individual by clicking the ‘Web Page Detail’ icon, per FIG. 43.

### HTML Resource Detail.

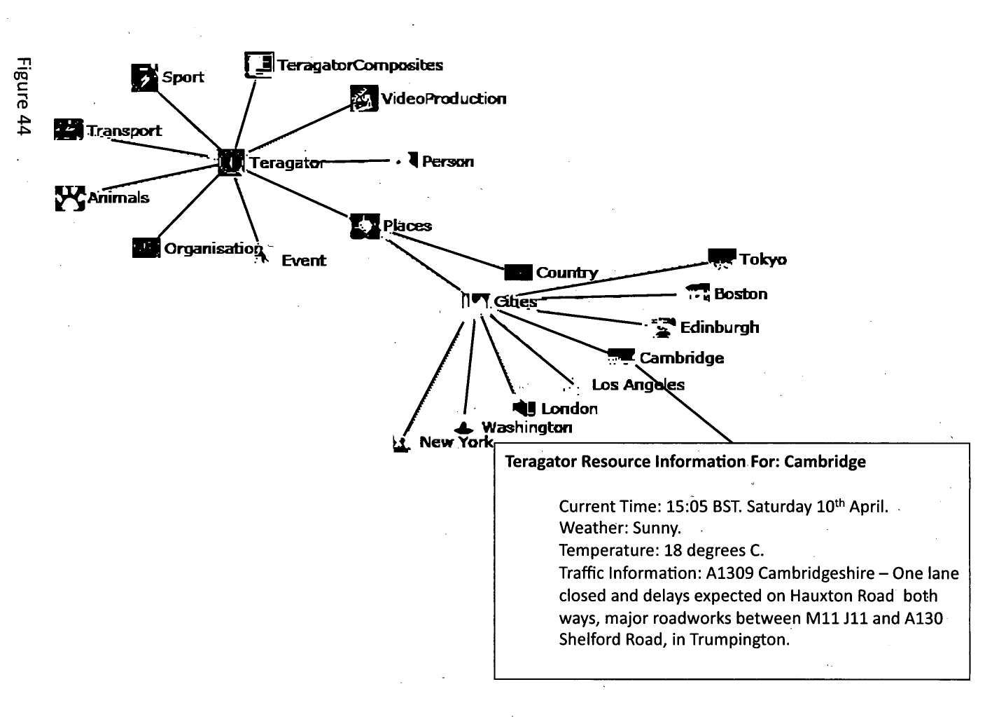

Teragator is able to aggregate information from various sources and construct a private HTML resource which is rendered by the client when the user clicks the ‘Resource Detail’ icon, see FIG. 44. This is useful where a large amount of data has been mined for a particular resource but there is no obvious place to display this information in the visualisation.

### Web Service Resource Example—DbPedia.

Web services can also provide extra information about a resource. One such is DbPedia (a subset of Wikipedia done as a web-service), see FIG. 31.

### Linked Resources Example—Associations.

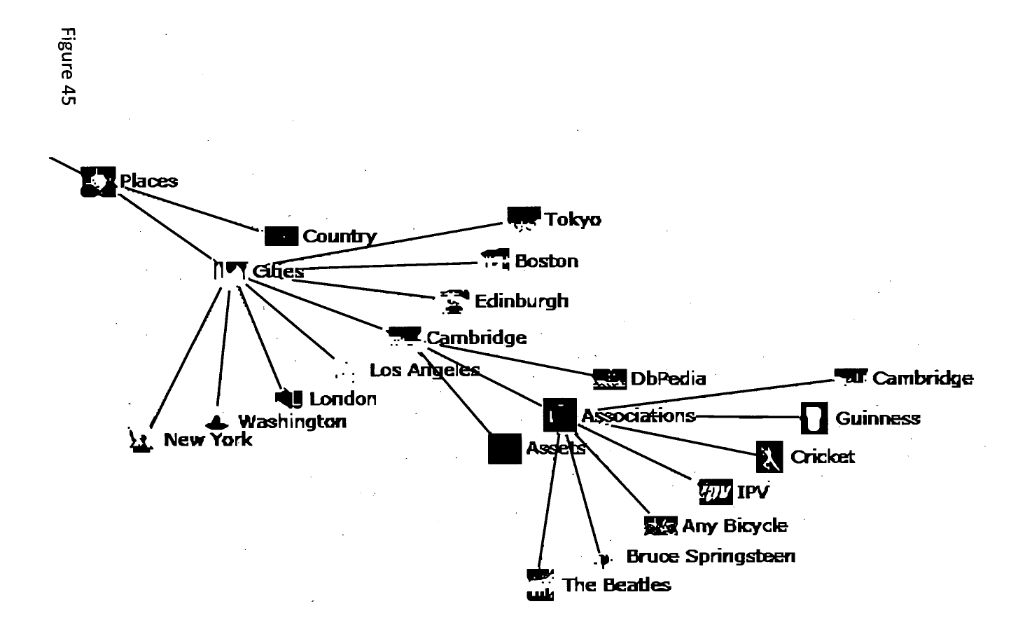

The associations resource allows the user to continue to explore the individuals that are linked to a resource, rather than its assets, as shown in FIG. 45.

### Assets View.

### Node Detail.

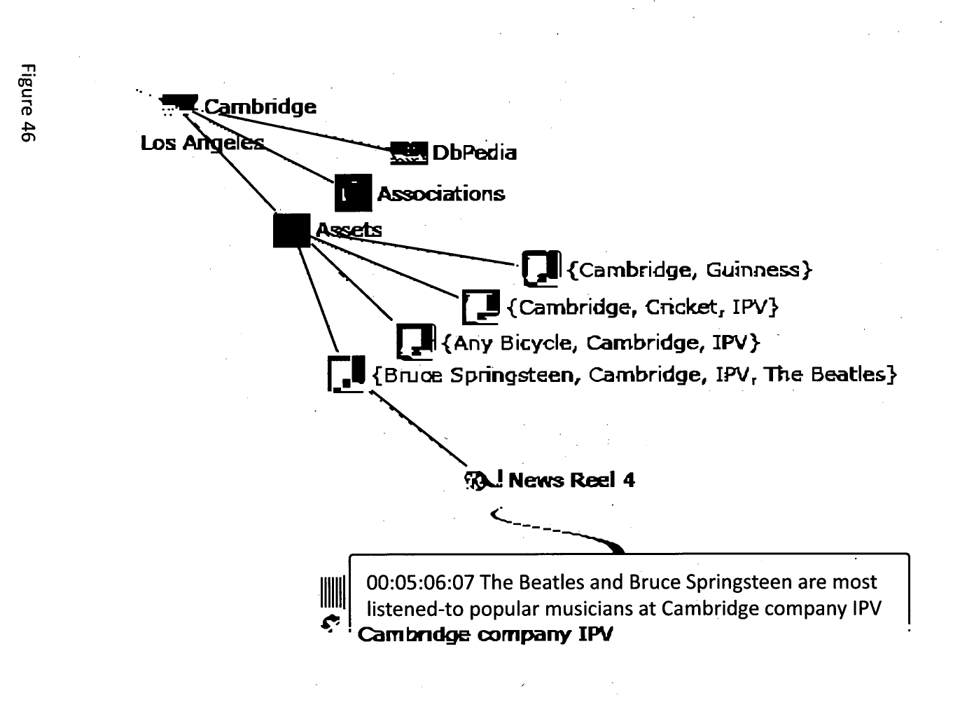

The assets view allows the user to explore the physical assets (primarily media files) associated with an individual. The first layer of data that ‘Assets’ links to consists of ‘Compositions’ which are sets of related resources. A composition is linked to one or more resources that represent the physical item of interest. In the example in FIG. 46 this is an item called ‘News Reel 4’. Further detail can be obtained from the node by clicking it; in this case the text annotation that was mined in order to find the composite resource is displayed.

### Asset Player.

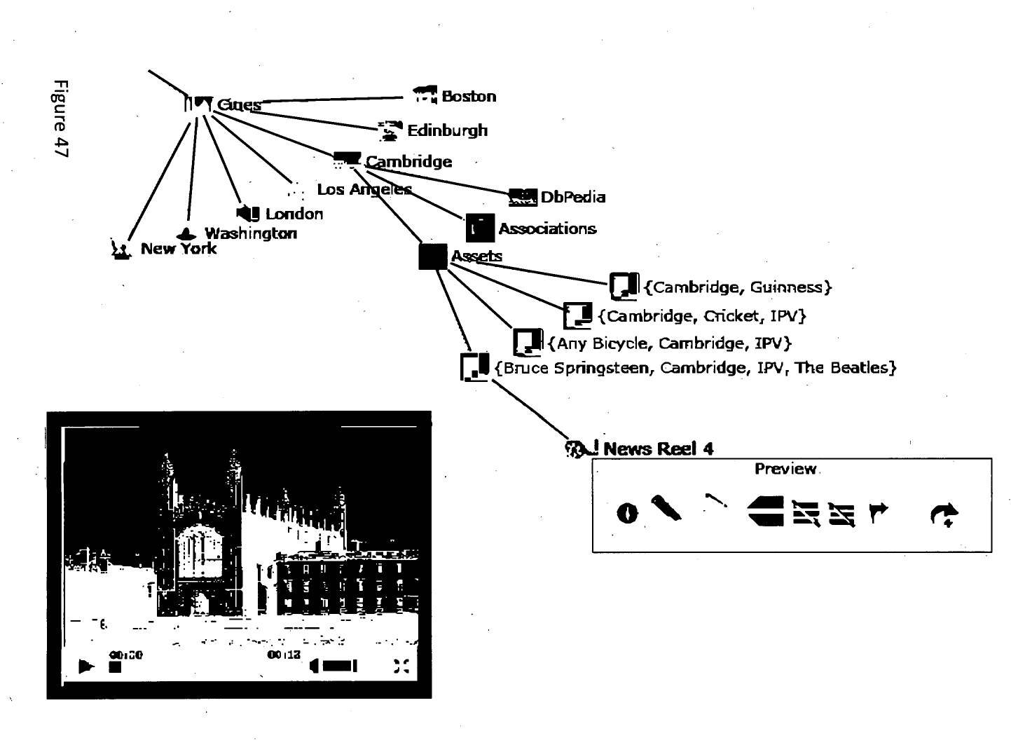

Dragging down on the asset icon brings up a pane with a set of point-tools that can be applied to this asset. The ‘Preview’ button plays the media; see FIG. 47.

### Tools.

### Radial.

The radial tool displays resources as if mapped onto a sphere, see FIG. 40.

### Left-To-Right.

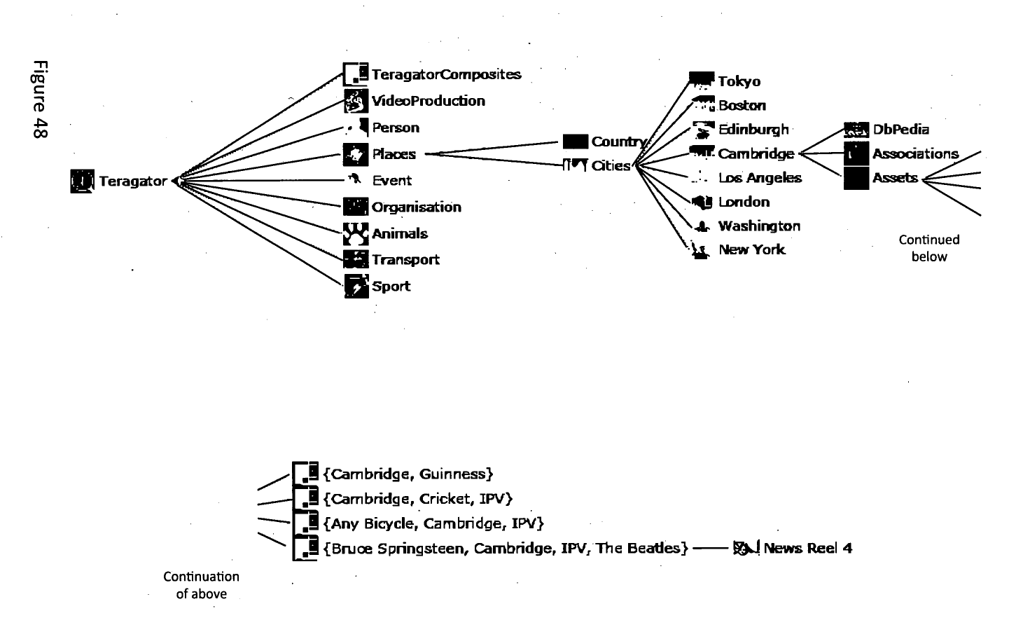

The radial tool displays resources as a horizontal tree, see FIG. 48.

### Selector.

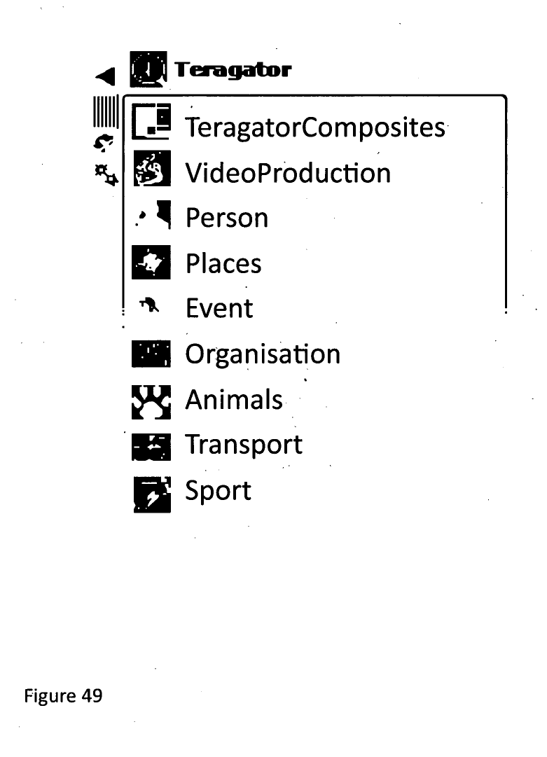

The selector displays resources at a particular level and allows the user to drill down through the levels, see FIG. 49.

### Slide Bar

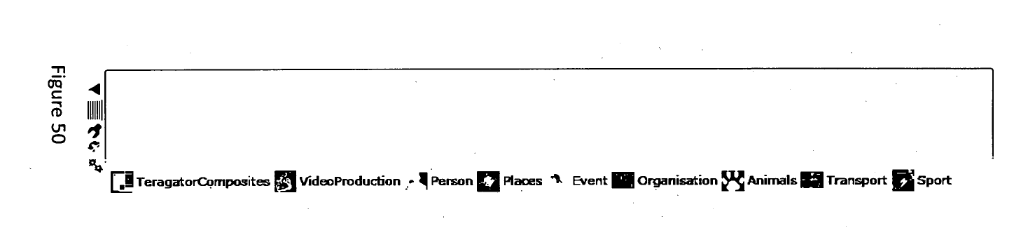

The slide bar displays resources in a linear fashion and allows the user to shift left and right, see FIG. 50.

### Facet Filter.

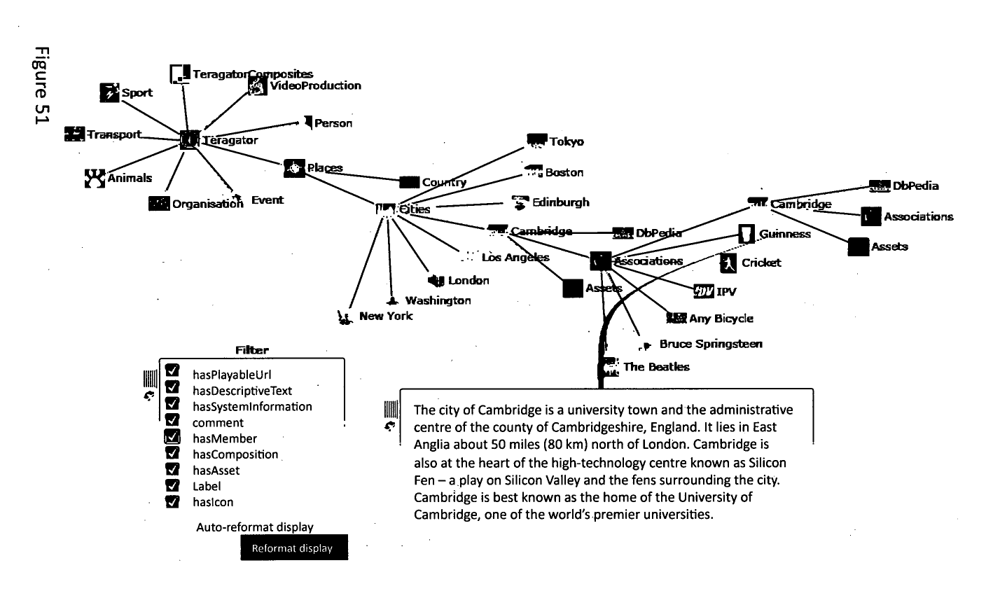

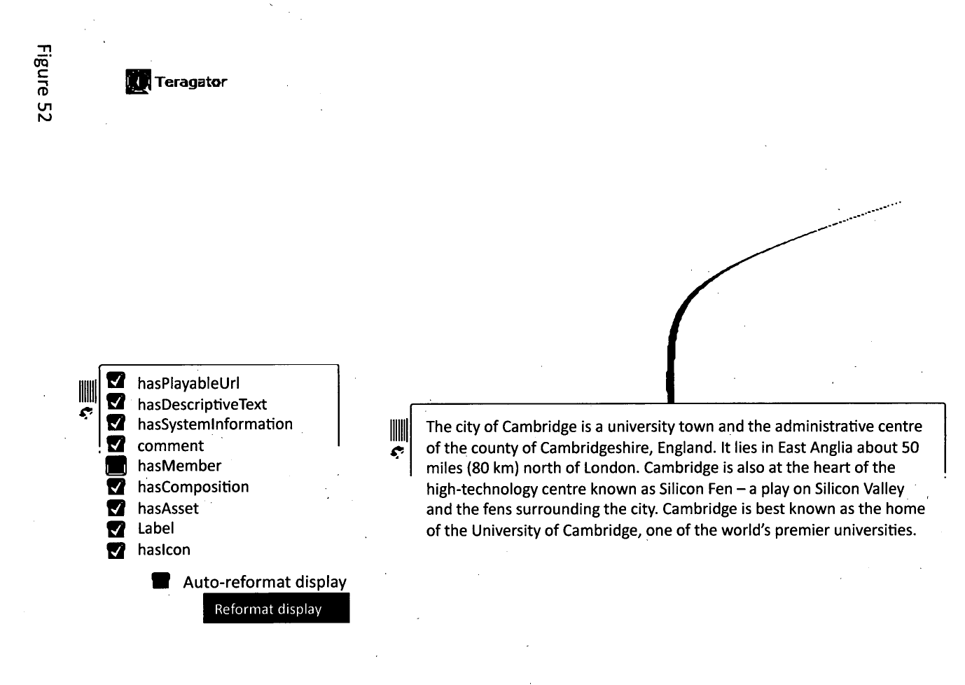

The facet filter allows the user to switch subsets of the graph on and off, see FIGS. 51 and 52.

### Scratchpad

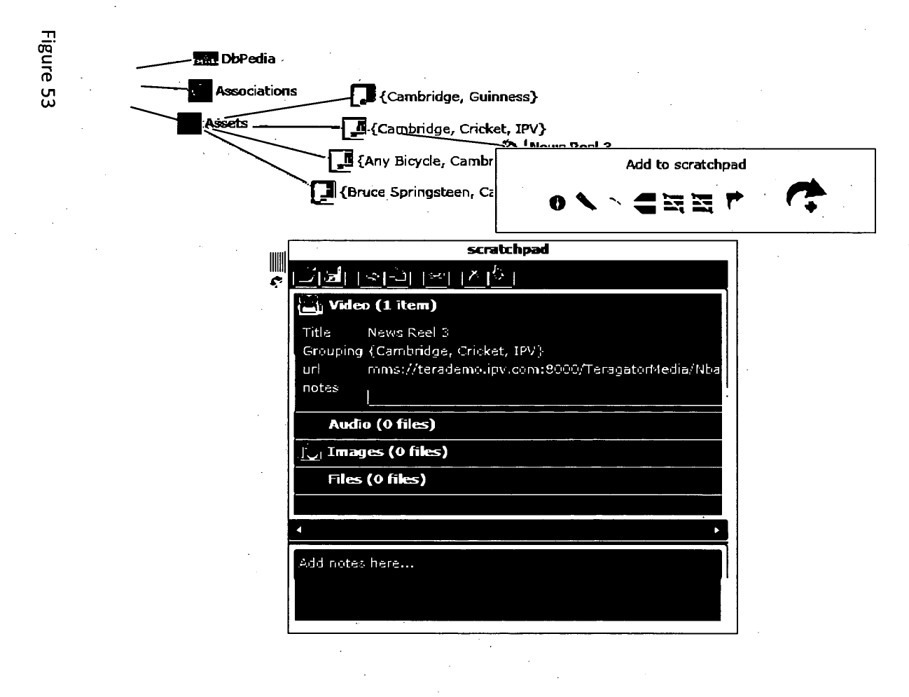

The scratchpad allows the user to copy references to items they come across and save them for future use, FIG. 53.

### Layout.

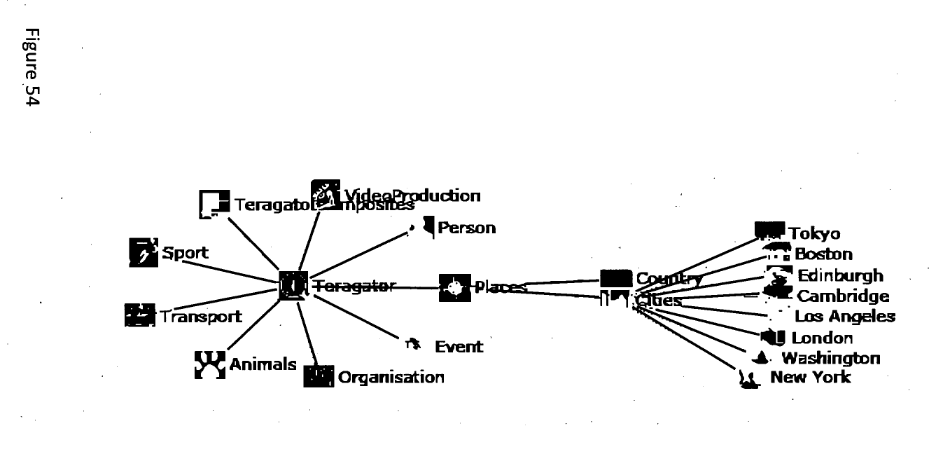

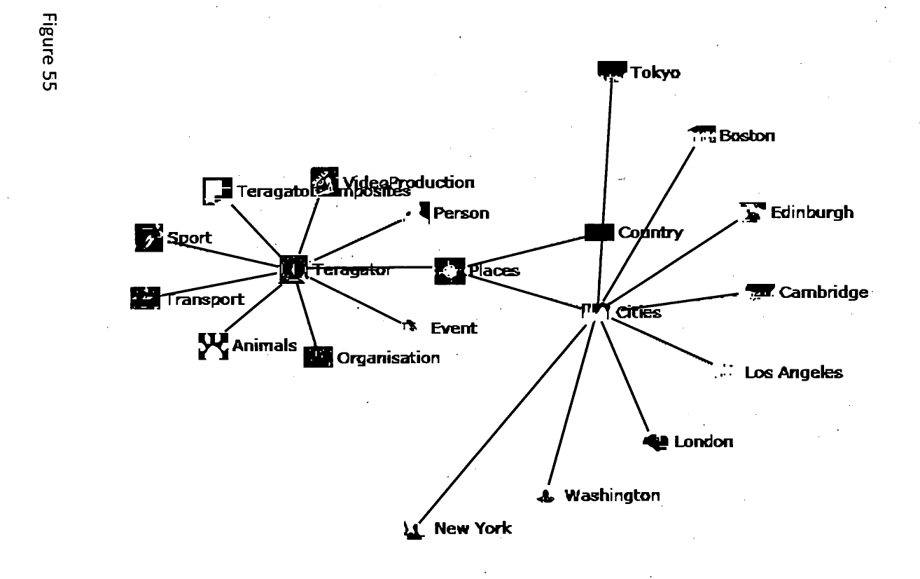

The branches of display can be opened out and closed up by use of the mouse—FIGS. 54 and 55.

### Appendix 7—References.

[1] Resource Description Framework (RDF): Concepts and Abstract Syntax, Klyne G., Carroll J. (Editors), W3C Recommendation, 10 Feb. 2004.
[2] http://www.w3.org/TR/PR-rdf-syntax/ “Resource Description Framework (RDF) Model and Syntax Specification”
[3] OWL 2 Web Ontology Language: Quick Reference Guide Jie Bao, Elisa F. Kendall, Deborah L. McGuinness, Peter F. Patel-Schneider, eds. W3C Recommendation, 27 Oct. 2009, http://www.w3.org/TR/2009/REC-owl2-quick-reference-20091027/
[4] DLNA for HD Video Streaming in Home Networking, http://www.dlna.org/about us/about/DLNA Whitepaper.pdf

1. A method of browsing metadata derived from one or more datasets, in which a client device displays a graphical map including metadata resources and links between at least some of those resources, and a user can explore or browse that map by selecting a resource to initiate the querying of metadata to generate a revised map, including new metadata resources.

2. The method of claim 1 in which the metadata is RDF format and styling information is sent together with the RDF data, the styling information enabling the client device to generate the graphical map.

3. The method of claim 1, implemented by a digital processing system to process and display data, said method comprising a means of storing metadata in a database, wherein said metadata describes nodes or resources and the relationships between said nodes or resources, and wherein said metadata is obtained by digital processing of datasets in multiple formats, with multiple schemas into a single format of said metadata, and wherein said metadata is passed to a display client in conjunction with styling information, and wherein said styling information is not a part of said metadata but operates on it in such a way as to produce a rendition of said metadata in accordance with the requirements of the server, and wherein said styling information specifies that particular capabilities of the display client be applied to particular portions of said metadata, and wherein said capabilities are transmitted by said display client and obtained and used by the server in the construction of said styling information, and wherein said styling information is used by said display client to present to a human user a comprehensible, useful and visually attractive view of said metadata.

4. The method of claim 1 where said metadata is obtained from an adaptor, said adaptor comprising a computer program which is specialised to convert data from one of a multiplicity of source forms into a standard metadata format.

5. The method of claim 4 where multiple adaptors are used to produce said metadata, wherein the computer program used in said multiple adaptors is specialised using multiple configuration files in a standard format.

6. The method of claim 4 where the configuration files are produced by a tool suitable for use by a human operator who has no detailed knowledge of the operation of the system.

7. The method of claim 4 where the adaptors connect across a communication medium to a multiplicity of datasets.

8. The method of claim 1 where the datasets originate in one or more of the following: a relational database; a mail server; a connection to a Digital Living Network Alliance (DLNA) media network; a source of live or stored media; an XML file located on a local disc; an XML file located on the internet; a RSS feed; a photo library; a music library; a multiplicity of databases on the internet; the HTML code used to implement websites; a source of metadata from a media analysis system.

9. The method of claim 1 where the resources comprise information relating to friends, friendship groups and social network information.

10. The method of claim 1 where the datasets originate in a source of metadata from a media analysis system and the media analysis system is an Automatic Speech Recognition system.

11. The method of claim 1 where the datasets originate in a source of metadata from a media analysis system and the media analysis system is an Automatic Video Processing system.

12. The method of claim 1 where a digital feature extraction system uses characteristics of the data structure, used to store the metadata in a standard format, to extract features.

13. The method of claim 1 where a display client uses a representation of data items within a virtual three-dimensional space to convey meaning to a human user about the data being browsed and the relationships between said data.

14. The method of claim 13 where the display client stores information about the users' patterns of traversal of the graph.

15. The method of claim 14 where a graph is created from the users' patterns of traversal, that overlays the metadata derived from one or more datasets.

16. The method of claim 15 where, for a given vertex, the graph stores the probability that a given user will take a certain path.

17. The method of claim 16 where the probability information is used to control the information display so as to suggest the most useful paths to a user.

18. The method of claim 13 where the data items that are displayed are projected onto a surface within the virtual three-dimensional space in such a way that patterns in the data are communicated to the user.

19. The method of claim 13 where the data items that are displayed are projected onto zones within the virtual three-dimensional space in such a way that relationships and common properties are communicated to the user.

20. The method of claim 2 and any claim dependent on claim 2 where the numerical and textual values of resources in the RDF data control the positioning of the projection of data items within the virtual three-dimensional space.

21. The method of claim 1 where digital processing of datasets in multiple formats, with multiple schemas into the single format of said metadata, uses ontologies to provide unique names of resources such that that the discovered resources can be described using these unique names in the said single format, even though those resources may be referred to in different ways in the datasets.

22. The method of claim 21 where the said unique names of resource allows straightforward aggregation of data into the said single format.

23. The method of claim 1 wherein the revised map includes both the new metadata resources and links between those new metadata resources.

24. The method of claim 1, when implemented on a computing device that displays the graphical map, including a further step of responding to the querying of the metadata by generating the revised map, and in which that step of responding is performed at the computing device, or on a remote server, or on a combination of the two.

25. A computer-implemented system that enables browsing of metadata derived from one or more datasets, in which the system includes a client device operable to display a graphical map including metadata resources or nodes and links between at least some of those metadata resources or nodes, the client device enabling a user to explore or browse that map by selecting a resource or node to initiate the querying of metadata to generate a revised map, including new metadata resources or nodes and links between those new metadata resources or nodes.

26. The system of claim 1, in which a server receives the query and generates the revised map.
